(19) United States
(12) Patent Application Publication
(10) Pub. No.: US 2021/0315210 A1
(43) Pub. Date: Oct. 14, 2021

(54) ANTIVIRAL FIBERS, FABRICS AND FABRIC-BASED PRODUCTS

(71) Applicant: NOBIO LTD., Kadima (IL)

(72) Inventors: Nathan ZALTSMAN, Hadera (IL); Ervin Itzhak WEISS, Herzliya (IL)

(73) Assignee: NOBIO LTD., Kadima (IL)

(21) Appl. No.: 17/227,326

(22) Filed: Apr. 11, 2021

Related U.S. Application Data
(60) Provisional application No. 63/008,687, filed on Apr. 11, 2020.

(51) Int. Cl. A01N 55/00; A01N 25/10; A01N 25/34; A01N 25/12; C08F 292/00; A41D 13/11

(52) U.S. Cl. CPC A01N 55/00; A01N 25/10; A41D 13/1192; A01N 25/12; C08F 292/00; A01N 25/34

(57) ABSTRACT

A product or a surface is being coated by anti-viral particles, or a product is being loaded with anti-viral particles, thereby possessing anti-viral properties and reducing/preventing viral infection. Specifically, an anti-viral fiber, fabric, or fabric based product is disclosed comprising anti-viral particles for use in reducing and preventing viral infection.

### CROSS REFERENCE TO RELATED APPLICATIONS

This application claims the benefit of U.S. Ser. No. 63/008,687, filed on Apr. 11, 2020, which is incorporated in its entirety herein by reference.

### FIELD OF THE INVENTION

A product or a surface is being coated by anti-viral particles, or a product is being loaded with anti-viral particles, thereby possessing anti-viral properties and reducing/preventing viral infection. Specifically, an anti-viral fiber, fabric, or fabric-based product is disclosed comprising anti-viral particles for use in reducing and preventing viral infection.

### BACKGROUND OF THE INVENTION

In recent years, viral diseases such as SARS (Severe Acute Respiratory Syndrome), Middle East Respiratory Syndrome (MERS), and avian influenza have been rampant worldwide. In particular, new types of influenza viruses have been discovered one after another and have become a threat to mankind. Originally, the host range of viruses is limited, and it is normal that only mammals infect mammals and only birds infect birds. However, since avian influenza virus is a virus with a wide host range that can infect not only birds but also mammals and it may infect humans. At present, COVID-19 virus is prevalent worldwide, with currently more than million people sick. Much has been done to control and prevent epidemics and pandemics, such as having many anti-influenza products (vaccines and treatments) currently on the market. The role of these antivirals in a pandemic may be limited due to the time and cost involved in production and the current limited supply.

The inhalation of air contaminated by harmful virus and/or other micro-organisms is a common route for infection of human beings, particularly health workers and others caused to work with infected humans or animals. Air exhaled by infected patients is a source of contamination.

Anti-viral protective products would be ideal for use as a barrier to prevent species-to-species transmission of the virus.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A-1C depict anti-viral active particle scheme. FIG. 1A: an oligomeric/polymeric backbone per one anti-viral active unit; FIG. 1B: a monomeric backbone per one anti-viral active unit; and FIG. 1C: detailed monomeric unit scheme.

FIG. 2 depicts a representative scheme for the preparation of standard particles according to this invention wherein the anti-viral active group is a tertiary amine or a quaternary ammonium group comprising at least one terpenoid moiety and the anti-viral unit has one monomeric unit (a monomeric backbone, as presented in FIG. 1B); the circles represent the organic or inorganic core; and R¹—Y—R¹ is a C₁-C₄ alkyl and Y is a leaving group such as halogen or sulfonate.

FIG. 3 depicts a representative scheme for the preparation of a standard particle of this invention having cinnamyl groups with a core (represented by a circle) via amino-functional linker wherein the anti-viral unit has one monomeric unit (a monomeric backbone, as presented in FIG. 1B). Conversion of the tertiary amine to the quaternary ammonium group is optional, and involves reaction of the tertiary amine with a group R¹—Y wherein R¹ is a C₁-C₄ alkyl and Y is a leaving group such as halogen or sulfonate.

FIGS. 4A-4C depicts a representative scheme of three pathways for the preparation of quaternary ammonium salts (QAS) functionalized standard particle wherein the anti-viral unit has one monomeric unit (a monomeric backbone, as presented in FIG. 1B); the circles represents organic or inorganic core. FIG. 4A) by reductive amination to achieve tertiary amine, followed by an alkylation reaction; FIG. 4B) by stepwise alkylation reactions; and FIG. 4C): by reacting a linker functionalized with a leaving group (e.g., Cl or other halogen) with tertiary amine. R¹ and R² represent C₁-C₄ alkyls such as methyl, ethyl, propyl or isopropyl. R¹ and R² may be different or the same group. Y represents any leaving group, for example Cl, Br or I, or a sulfonate (e.g., mesyl, tosyl).

FIGS. 5A-5C depicts a representative scheme of three pathways for the preparation of quaternary ammonium salts (QAS) functionalized particle with enhanced thermal stability wherein the anti-viral unit has one monomeric unit (a monomeric backbone, as presented in FIG. 1B); the circles represents organic or inorganic core. FIG. 5A) by alkylation with R₁—Y/R₂—Y to achieve tertiary amine, followed by an benzylation reaction; FIG. 5B) by a similar pathway as in A), done in the reversed order; and FIG. 5C): by reacting a linker functionalized with a leaving group (e.g., Cl or other halogen) with tertiary amine. R₄ and R₅ are independently methyl, CF₃, perhaloalkyl, aryl, benzyl, 2,2-disubstituted C₃-C₂₀ alkyl, 2,2,2-trisubstituted ethyl, —CH₂C(═O)OR, —CH₂C(═O)OC(═O)R, —CH₂C(═S)OR, —CH₂C(═O)SR, —C(═O)OR, —C(═O)OC(═O)R, —C(═S)OR, —C(═O)SR, —CH₂C(═O)R, —CH₂C(═S)R, —CH₂CF₃, —CH₂NO₂, 1-alkenyl, 1-alkynyl, 2-alkenyl, 2-alkynyl or any combination thereof; where R is alkyl, aryl, cycloalkyl, heterocycle or any combination thereof. Y represents any leaving group, for example Cl, Br or I, or a sulfonate (e.g., mesyl, tosyl).

FIG. 6 depicts schemes of solid support and solution methods for the preparation of standard particles of this invention wherein the anti-viral unit has one monomeric unit (a monomeric backbone, as presented in FIG. 1B). The circles represent an organic or inorganic core. Q¹, Q² and Q³ are independently selected from the group consisting of ethoxy, methoxy, methyl, ethyl, hydrogen, sulfonate and halide, wherein at least one of Q¹, Q² and Q³ is a leaving group selected from ethoxy, methoxy, sulfonate (e.g., mesyl, tosyl) and halide. For the sake of clarity the scheme presents a case where Q¹, Q² and Q³ represent leaving groups; Q⁴ represents an anti-viral group; W is selected from the group consisting of NH₂, halide, sulfonate and hydroxyl; and n is an integer between 1 and 16.

FIG. 7 depicts a representative scheme for the preparation of standard particles having di-cinnamyl groups with core particle (represented as a circle) functionalized utilizing a 12-(triethoxysilyl)-dodecan-1-amine linker by both solid support method and solution method, wherein the anti-viral part has one monomeric unit (a monomeric backbone, as presented in FIG. 1B). n is an integer of 1 to 16.

FIG. 8 depicts a representative scheme for the preparation of standard particles by a solid support method, wherein the anti-viral unit has an oligomeric or polymeric backbone (more than one monomeric unit). The circles represent a core. The starting material is a core terminated on the surface with hydroxyl groups; Q⁰¹, Q¹⁰² and Q¹⁰³ and independently alkoxy, alkyl or aryl; LG is Cl, Br, I, mesylate, tosylate or triflate; Hal is Cl, Br or I; q, q¹, q² and q³ are independently an integer between 0-16; R¹ and R² are each independently alkyl, terpenoid, cycloalkyl, aryl, heterocycle, a conjugated alkyl, alkenyl or any combination thereof; and R³ is nothing, hydrogen, alkyl, terpenoid moiety, cycloalkyl, aryl, heterocycle, alkenyl, alkynyl or any combination thereof.

FIG. 9 depicts a representative scheme for the preparation of particles with enhanced thermal stability by a solid support method, wherein the anti-viral unit has an oligomeric or polymeric backbone (more than one monomeric unit). The circles represent a core. The starting material is a core terminated on the surface with hydroxyl groups; Q¹⁰¹, Q¹⁰² and Q¹⁰³ are each independently alkoxy, alkyl or aryl; LG is Cl, Br, I, mesylate, tosylate or triflate; Hal is Cl, Br or I; q, q¹, q² and q³ are each independently an integer between 0-16; R₄ and R₅ are each independently methyl, CF₃, perhaloalkyl, aryl, benzyl, 2,2-disubstituted C₃-C₂₀ alkyl, 2,2,2-trisubstituted ethyl, —CH₂C(═O)OR, —CH₂C(═O)OC(═O)R, —CH₂C(═S)OR, —CH₂C(═O)SR, —C(═O)OR, —C(═O)OC(═O)R, —C(═S)OR, —C(═O)SR, —C(═O)—R, —C(═S)—R, —CH₂C(═O)R, —CH₂C(═S)R, —CH₂CF₃, —CH₂NO₂, 1-alkenyl, 1-alkynyl, 2-alkenyl, 2-alkynyl or any combination thereof; and R₆ is methyl, CF₃, perhaloalkyl, 2,2-disubstituted C₃-C₂₀ alkyl, 2,2,2-trisubstituted ethyl, —CH₂C(═O)OR, —CH₂C(═O)OC(═O)R, —CH₂C(═S)OR, —CH₂C(═O)SR, —C(═O)OR, —C(═O)OC(═O)R, —C(═S)OR, —C(═O)SR, —C(═O)—R, —C(═S)—R, —CH₂C(═O)R, —CH₂C(═S)R, —CH₂CF₃, —CH₂NO₂, terpenoid moiety, cycloalkyl, aryl, phenyl, benzyl, heterocycle, a conjugated alkyl, 1-alkenyl, 1-alkynyl, 2-alkenyl, 2-alkynyl or any combination thereof.

FIGS. 10A-10C depict self-polymerization of trialkoxysilane linker of a standard particle. FIG. 10A: self-polymerization of trialkoxysilane linker via solid support method; FIG. 10B: self-polymerization of trialkoxysilane linker in solution; and FIG. 10C: comparison of polymerization of the silane groups versus simple silanization.

FIGS. 11A-11C depict self-polymerization of trialkoxysilane linker of a particle with enhanced thermal stability. FIG. 11A: self-polymerization of trialkoxysilane linker via solid support method; FIG. 11B: self-polymerization of trialkoxysilane linker in solution; and FIG. 11C: comparison of polymerization of the silane groups versus simple silanization.

FIG. 12 depicts a representative scheme for the preparation of standard particles in a solution method, wherein the anti-viral unit has more than one monomeric unit (i.e has an oligomeric or polymeric backbone). The circles represent a core. The starting material is a core terminated on the surface with hydroxyl groups; Q¹⁰¹, Q¹⁰² and Q¹⁰³ and independently alkoxy, alkyl or aryl; LG is Cl, Br, I, mesylate, tosylate or triflate; Hal is Cl, Br or I; q, q¹, q² and q³ are independently an integer between 0-16; R¹ and R² are each independently alkyl, terpenoid, cycloalkyl, aryl, heterocycle, a conjugated alkyl, alkenyl or any combination thereof; and R³ is nothing, hydrogen, alkyl, terpenoid moiety, cycloalkyl, aryl, heterocycle, alkenyl, alkynyl or any combination thereof.

FIG. 13 depicts a representative scheme for the preparation of particles with enhanced thermal stability in a solution method, wherein the anti-viral unit has more than one monomeric unit (i.e has an oligomeric or polymeric backbone). The circles represent a core. The starting material is a core terminated on the surface with hydroxyl groups; Q¹⁰¹, Q¹⁰² and Q¹⁰³ and independently alkoxy, alkyl or aryl; LG is Cl, Br, I, mesylate, tosylate or triflate; Hal is Cl, Br or I; q, q¹, q² and q³ are independently an integer between 0-16; R₄ and R₅ are each independently methyl, CF₃, perhaloalkyl, aryl, benzyl, 2,2-disubstituted C₃-C₂₀ alkyl, 2,2,2-trisubstituted ethyl, —CH₂C(═O)OR, —CH₂C(═O)OC(═O)R, —CH₂C(═S)OR, —CH₂C(═O)SR, —C(═O)OR, —C(═O)OC(═O)R, —C(═S)OR, —C(═O)SR, —C(═O)—R, —C(═S)—R, —CH₂C(═O)R, —CH₂C(═S)R, —CH₂CF₃, —CH₂NO₂, 1-alkenyl, 1-alkynyl, 2-alkenyl, 2-alkynyl or any combination thereof; and R₆ is methyl, CF₃, perhaloalkyl, 2,2-disubstituted C₃-C₂₀ alkyl, 2,2,2-trisubstituted ethyl, —CH₂C(═O)OR, —CH₂C(═O)OC(═O)R, —CH₂C(═S)OR, —CH₂C(═O)SR, —C(═O)OR, —C(═O)OC(═O)R, —C(═S)OR, —C(═O)SR, —C(═O)—R, —C(═S)—R, —CH₂C(═O)R, —CH₂C(═S)R, —CH₂CF₃, —CH₂NO₂, terpenoid moiety, cycloalkyl, aryl, phenyl, benzyl, heterocycle, a conjugated alkyl, 1-alkenyl, 1-alkynyl, 2-alkenyl, 2-alkynyl or any combination thereof.

FIG. 14 depicts a scheme for the preparation of silica based anti-viral standard particles comprising dimethylethylammonium as the anti-viral active group, in a solid support method, wherein the anti-viral unit has more than one monomeric unit (i.e has an oligomeric or polymeric backbone).

FIG. 15 depicts a scheme for the preparation of silica based anti-viral standard particles comprising dimethylethylammonium as the anti-viral active group, in a solution method, wherein the anti-viral unit has more than one monomeric unit (i.e has an oligomeric or polymeric backbone).

FIG. 16 depicts a scheme for the preparation of silica based anti-viral particles with enhanced thermal stability comprising dimethylbenzylammonium as the anti-viral active group, in a solid support method, wherein the anti-viral unit has more than one monomeric unit (i.e has an oligomeric or polymeric backbone).

FIG. 17 depicts a scheme for the preparation of silica based anti-viral particles with enhanced thermal stability comprising dimethylbenzylammonium as the anti-viral active group, in a solution method, wherein the anti-viral unit has more than one monomeric unit (i.e has an oligomeric or polymeric backbone).

### SUMMARY OF THE INVENTION

In some embodiments, this invention is directed to anti-viral particles for use in reducing and preventing viral infection. In other embodiments, a product or a surface is being coated with anti-viral particles of this invention and thereby possess anti-viral properties and reduces/prevents viral infection. In other embodiment, a product is loaded with the anti-viral particles of this invention in its production process and therefore has anti-viral properties and reduces/prevents viral infection.

In one embodiment, this invention provides an anti-viral fiber, fabric, or fabric-based product comprising anti-viral particles of this invention for use in reducing and preventing viral infection.

### DETAILED DESCRIPTION OF THE PRESENT INVENTION

In the following detailed description, numerous specific details are set forth in order to provide a thorough understanding of the invention. However, it will be understood by those skilled in the art that this invention may be practiced without these specific details. In other instances, well-known methods, procedures, and components have not been described in detail so as not to obscure this invention.

### Anti-Viral Products Comprising Anti-Viral Particles.

In some embodiments, this invention is directed to anti-viral particles for use in reducing and preventing viral infection. In other embodiments, a product or a surface is being coated with the anti-viral particles of disclosed herein and thereby possess anti-viral properties and reduces/prevents viral infection. In other embodiment, a product is loaded with anti-viral particles of this invention in its production process and therefore has anti-viral properties and reduces/prevents viral infection.

In some embodiments, this invention provides anti-viral surfaces, fibers, fabric or fabric based products (such as protective face masks, sheets, protective clothing) comprising anti-viral particles. The anti-viral particles are loaded onto the fibers, fabric or fabric based products by coating onto already made fibers or loaded into the fibers, fabric of fabric-based products by extrusion and/or by co-extrusion during the manufacturing process of the fibers.

The anti-viral particles are coated on surfaces to obtain a surface with anti-viral properties.

In other embodiments, the fabric is woven or non-woven material or a printed material.

In one embodiment, fibers, fabric or fabric-based products are coated by anti-viral particles to obtain anti-viral fibers, fabric or fabric based products. In another embodiment, the fibers are prepared by extrusion or co-extrusion together with anti-viral particles to obtain anti-viral fibers which are further used for the production of an anti-viral fabric and/or an anti-viral fabric based product.

In some embodiments, the anti-viral particles attract the virus and destabilize its' outer shell and thereby inactivate the viruses.

The anti-viral particles bind the virus, damaging its outer surface and thereby inactivate the virus.

In some embodiments, by using such products (fabric-based products such as clothing, sheets, or protective face mask) or coated surfaces, one reduces transmission and prevent infection of the virus.

The anti-viral particles and the coated surfaces, fibers, fabric or fabric-based products are effective in reducing or preventing transmission of a virus; and preventing infection of the virus. The anti-viral particles may be effective for any virus. Non limiting examples of viruses include the Human coronavirus, human influenza virus, SARS, bird flu, herpes simplex Type 1 and Type 2, SRV, CMV, HIV, Lassa virus, Crimean-Congo hemorrhagic fever virus, COVID-19, Human SARS coronavirus, MERS coronavirus, SARS coronavirus 2, Ebola virus, Dengue virus, West Nile virus, Yellow fever virus, Zika virus, Influenza A virus, Human papilloma virus, Polio virus, Human immunodeficiency virus, Human T-lymphotropic virus, Rabies virus. and mutations therefrom.

In some embodiments, the anti-viral fabric-based products of this invention include clothing, bedding, curtains, wallpaper, carpets, mats, sheets, filters, protective face-masks, wipes, towels, protective clothing, protective nets and medical sheets. The anti-viral fibers, fabric, fabric based product of the present invention is effective for inactivating a virus (such as the COVID-19, influenza virus, Human coronavirus, human influenza virus, SARS, bird flu, herpes simplex Type 1 and Type 2, SRV, CMV, HIV, Lassa virus, Crimean-Congo hemorrhagic fever virus, Human SARS coronavirus, MERS coronavirus, SARS coronavirus 2, Ebola virus, Dengue virus, West Nile virus, Yellow fever virus, Zika virus, Influenza A virus, Human papilloma virus, Polio virus, Human immunodeficiency virus, Human T-lymphotropic virus, Rabies virus. and mutations therefrom). The fiber/fabric/products carrying the anti-viral particles is effective for inactivating the virus. Furthermore, the anti-viral fiber of the present invention is processed into a fiber product to constitute the fiber product of the present invention. The anti-viral fiber/fabric/fabric based product, has an inactivating effect on the virus in contact.

In some embodiments, this invention provides a protective anti-viral facemask comprising anti-viral particles. In other embodiments, the protective anti-viral face-mask is loaded by anti-viral particles. In other embodiments, anti-viral facemask is coated by anti-viral particles. In another embodiment, the fabric used for the preparation of the mask is coated by anti-viral particles. In another embodiment, the fibers used for the preparation of the mask are coated by anti-viral particles. In another embodiment, the fibers used for the preparation of the mask are extruded, or co-extruded with anti-viral particles. In other embodiments, the antiviral masks prepared by 3D printing manufacturing methods from materials that include anti-viral particles. In other embodiments, the antiviral masks prepared by 3D printing manufacturing methods, then coated with anti-viral particles.

According to one aspect of this invention there is provided a protective anti-viral mask which is an air-permeable mask of a shape suitable to be placed over a user's mouth and nose and to seal contact the user's face, provided with means to hold the mask in place on the user's face, and comprising optionally, one or more layer of a filter material positioned such that inhaled and/or exhaled air of the user passes through the filter material.

The overall shape of the face mask may be generally conventional in the field of face masks, and the means to hold the mask in place on the user's face may for example comprise one or more elastic strap to be passed behind the user's head.

In some embodiments, this invention provides a protective anti-viral clothing comprising anti-viral particles. In other embodiments, protective anti-viral clothing is loaded by anti-viral particles. In other embodiments, the protective anti-viral clothing is coated by anti-viral particles. In another embodiment, the fabric used for the preparation of the protective anti-viral clothing is coated by anti-viral particles. In another embodiment, the fibers used for the preparation of the protective anti-viral clothing are coated by anti-viral particles. In another embodiment, the fibers used for the preparation of the protective anti-viral clothing are extruded or co-extruded with anti-viral particles.

The anti-viral fabric comprising a fibrous material, which can either be a woven or non-woven material. Examples of woven materials include those natural and synthetic fibers such as cotton, cellulose, wool, silk, polyolefins, polyester, polyamide (e.g. nylon), rayon, polyacrylonitrile, cellulose acetate, polystyrene, polyvinyls and any other synthetic polymers that can be processed into fibers. Examples of non-woven materials include polypropylene, polyethylene, polyester (PET, PETG), nylon, PLA, aramids (Kevlar, Nomex), polyetheretherketone, polyethers, polyamides, acrylic, modacrylic, polyvinyl chloride (Vinyon), polyvinyl alcohol (vinalon), polyphenylene sulfide, polybenzimidazole, acrylonitrile, polystyrene, styrenic elastomers, thermoplastic polyurethane, polyether-polyurea (spandex, lycra, elastane etc.), homopolymers or copolymers of lactic acid, glycolic acid and caproclactone.

In one additional aspect, this invention provides coated fibers, fabric or fabric based product, wherein the coating comprises anti-viral particles.

In some embodiments, the coating comprises only the anti-viral particles.

In some embodiments, the coating comprises the anti-viral particles and a matrix.

In another embodiment, the matrix material is selected from organic (e.g. thermoplastic or thermoset) or inorganic polymers.

In another embodiment, the organic polymers are selected from the following non-limiting list: hydrogels, polyolefins such as polyvinylchloride (PVC), polyacrylonitrile (PAN), polyvinylidene fluoride (PVDF), polyethylene, polystyrene, polyacrylonitrile-butadiene-styrene (ABS), and polypropylene, epoxy resins, acrylate resins such as poly methyl methacrylate, polyurethane or any combination thereof.

In another embodiment, the inorganic polymers are selected from the following non-limiting list: silicone polymers such as polydimethylsiloxane (PDMS), ceramics, metals or any combination thereof. In another embodiment, the hydrogel is poloxamer or alginate. In another embodiment, the commercial poloxamer is used or it is formed by a reaction between a polymer and other reagent. In another embodiment, the polymer is poly(ethylene glycol) (PEG) with reactive end groups (such as epoxides in PEG-diglycidyl ether or diglycidyl ether of bisphenol A (DGEBA)) and the reagent has multiple reactive sites (e.g. diethylenetriamine or polypropylene glycol-polyethylene glycol-polypropylene glycol (PPG-PEG-PPG) diamine). In another embodiment, another polymer material to be used in the context of this invention is resins used in dental, surgical, chirurgical and orthopedic composite materials. In such applications, anti-microbial particles could be first dispersed within the resin part or added simultaneously with filler or any other solid ingredients (if any). Most of these resins are acrylic or epoxy type monomers that undergo polymerization in-vivo. Each possibility represents a separate embodiment of this invention.

In some embodiments, the weight ratio of the particles to the whole coating (comprising matrix and particles) is between 1% and 20%. In another embodiment, the weight ratio is between 1 and 5%. In another embodiment, the weight ratio is between 3 and 10%. In another embodiment, the weight ratio is between 5 and 12%. In another embodiment, the weight ratio is between 8% and 20%. Each possibility represents a separate embodiment of this invention.

In some embodiments, the particles interact weakly or physically (mechanically) with the matrix. In another embodiment, the anti-viral particles are mechanically embedded within the matrix. In another embodiment, these particles are three dimensionally “locked” between the molecular/polymeric/oligomeric chains of the matrix material, preventing them from migrating out from the complex network. In another embodiment, the strong hydrophobic nature of these particles also plays a role in preventing the particles from moving into the hydrophilic surrounds such as in the case of physiological, dental, orthopedic or other medical and veterinarian applications. In another embodiment, the matrix (and material thereof) is inert to the particles and does not react with them. In one embodiment, the particles comprise functional groups, capable of reacting with molecular moieties of the matrix material. In another embodiment, the particles interact chemically with the matrix (and material thereof). Each possibility represents a separate embodiment of this invention.

In some embodiments, the coating further comprises at least one pharmaceutically active ingredient. In another embodiment, non-limiting examples of pharmaceutically active ingredients include Analgesics, Antibiotics, Anticoagulants, Antidepressants, Anticancers, Antiepileptics, Antipsychotics, Antivirals, Sedatives and Antidiabetics. In another embodiment, non-limiting examples of Analgesics include paracetamol, non-steroidal anti-inflammatory drugs (NSAIDs), morphine and oxycodone. In another embodiment, non-limiting examples of Antibiotics include penicillin, cephalosporin, ciprofolxacin and erythromycin. In another embodiment, non-limiting examples of Anticoagulants include warfarin, dabigatran, apixaban and rivaroxaban. In another embodiment, non-limiting examples of Antidepressants include sertraline, fluoxetine, citalopram and paroxetine. In another embodiment, non-limiting examples of Anticancers include Capecitabine, Mitomycin, Etoposide and Pembrolizumab. In another embodiment, non-limiting examples of Antiepileptics include Acetazolamide, Clobazam, Ethosuximide and lacosamide. In another embodiment, non-limiting examples of Antipsychotics include Risperidone, Ziprasidone, Paliperidone and Lurasidone. In another embodiment, non-limiting examples of Antivirals include amantadine, rimantadine, oseltamivir and zanamivir. In another embodiment, non-limiting examples of Sedatives include Alprazolam, Clorazepate, Diazepam and Estazolam. In another embodiment, non-limiting examples of Antidiabetics include glimepiride, gliclazide, glyburide and glipizide. Each possibility represents a separate embodiment of this invention.

In some embodiments, the thickness of the coating ranges between 5 nm and 1000 nm. In another embodiment, the thickness is between 10 and 50 nm. In another embodiment, the thickness is between 10 and 50 nm. In another embodiment, the thickness is between 50 and 100 nm. In another embodiment, the thickness is between 100 and 500 nm. In another embodiment, the thickness is between 500 and 1000 nm. Each possibility represents a separate embodiment of this invention.

In some embodiments, the product, surface or fiber is completely covered with the coating. In one embodiment, the product, surface or fiber is partially covered with the coating. In one embodiment, if the product, surface or fiber has outer and inner surfaces—both surfaces or only one of them are covered with the coating. Each possibility represents a separate embodiment of this invention.

In some embodiments, the product, surface or fiber (before or after coating) is smooth or rough. In one embodiment, the product, surface or fiber has a solid uniform morphology with low porosity or a porous morphology having pore size diameter of between about 1 to about 30 nm. In another embodiment, the product, surface or fiber is pre-treated before coating to afford a specific morphology of the bulk and/or surface. In another embodiment, the product or fiber is pre-treated to afford chemical functionalization (e.g. HO- or H-termination) of the surface thereof. Each possibility represents a separate embodiment of this invention.

### Processes of Coating the Fibers, Fabric or Fabric Based Products

In one further aspect, this invention provides processes of coating fibers, fabric or fabric based product with anti-viral particles.

In one embodiment, the coating comprises anti-viral particles and a matrix as described herein below.

In one embodiment, the coating comprises only anti-viral particles.

In one embodiment, this invention is directed to a process of coating a substrate, wherein the substrate is selected from a fiber, a fabric or a fabric-based product, wherein the coating comprises anti-viral particles and a matrix; and the process comprises:
dispersing anti-viral particles and a matrix material in a solvent to form a dispersion; and
coating the substrate with the dispersion to provide an anti-viral coated substrate.

In another embodiment, the dispersion includes between 1-5% w/w or 1-20% w/w of the anti-viral particles.

In one embodiment, this invention is directed to a process of coating a substrate, wherein the substrate is selected from a fiber, a fabric or a fabric-based product, wherein the coating comprises anti-viral particles and a polar solvent (such as ethanol, methanol, THF, isopropanol or combination thereof) and the process comprises:
dispersing anti-viral particles and a matrix material in a solvent to form a dispersion; and
coating the substrate with the dispersion to provide an anti-viral coated substrate.

In another embodiment, the dispersion includes between 1-5% w/w or 1-20% w/w of the anti-viral particles.

In another embodiment, the coating is performed by:

a. dipping the substrate into the dispersion followed by solvent elimination;
b. spraying the dispersion onto a substrate, followed by solvent elimination;
c. spin coating the substrate with the dispersion, followed by solvent elimination;
d. brushing the substrate with the dispersion, followed by solvent elimination;
e. spreading the dispersion on a substrate, followed by solvent elimination; or
f. by abrasive blasting.

“Abrasive blasting”, (more commonly known as sandblasting) refers herein to the operation of forcibly propelling a stream of abrasive material (the coating of this invention) against a surface under high air (or any gas) pressure (to smooth a rough surface, roughen a smooth surface), shape a surface or remove surface contaminants. Using this method the particles are forced and embedded into the surface and stay there for a long period of time.

In one embodiment, this invention is directed to a process of coating a substrate, wherein the substrate is selected from a fiber, a fabric or a fabric-based product, wherein the coating comprises anti-viral particles and a matrix; and the process comprises:
dispersing anti-viral particles and a monomer, oligomer or a pre-polymerized substance that can undergo polymerization, cross linking and/or vulcanization in a solvent to form a dispersion;
coating the substrate (as described above) with the solution; and
polymerizing, cross linking and/or vulcanizing the substrate coated with the dispersion to provide an anti-viral coated substrate.

In another embodiment, non-limiting examples of monomers, oligomers or a pre-polymerized substances that can undergo polymerization, cross linking and/or vulcanization include: epoxy-amine blend, acrylic/methacrylic resin blend with photo/chemical polymerization initiators and silicone based polymers/monomers/oligomers that undergo curing.

In another embodiment, polymerizing, cross linking and/or vulcanizing is performed via chemical reagents such as initiators, cross-linkers and/or via curing done with lamps or via exposure of the pre-polymerized substance to ambient light and/or air.

In one embodiment, this invention is directed to a process of coating a substrate, wherein the substrate is selected from a fiber, a fabric or a fabric-based product, wherein the coating comprises anti-viral particles and a matrix; and the process comprises:
pouring a dry anti-viral composition onto the substrate;
melting the dry composition by heat; and
cooling the melt to provide an anti-viral coated substrate;
   wherein said dry anti-viral composition comprises anti-viral particles and a matrix.

In another embodiment, melting is done via extrusion or co-extrusion. In another embodiment, the extrusion is a compounding extrusion, i.e. where additives are added to the components to be extruded. In another embodiment, the anti-viral particles are embedded within the matrix.

In another embodiment, co-extrusion in which the fiber is produced by having two components—an internal and an external sheath, and this invention is a compounding extrusion, i.e. where additives are added to the components to be extruded, to the outer sheath

In another embodiment, the products (such as the protective face masks) are prepared by 3D printing and the filament being used in the 3D printing is loaded with anti-viral particles.

In one embodiment, this invention is directed to a process of coating a substrate, wherein the substrate is selected from a fiber, a fabric or a fabric-based product, wherein the coating comprises anti-viral particles and a matrix; and the process comprises:
pouring a dry matrix composition onto a substrate;
melting the poured dry matrix composition by heat;
pouring dry anti-viral particles into the melt to provide a mixture of a melted dry matrix composition and anti-viral particles; and
cooling the mixture to provide an anti-viral coated substrate;
wherein said dry matrix composition comprises a matrix.

In another embodiment, melting is done via extrusion. In another embodiment, the extrusion is a compounding extrusion, i.e. where additives are added to the components to be extruded. In another embodiment, the anti-viral particles are embedded within the matrix of the provided coated substrate.

In another embodiment, melting is done via co-extrusion. In another embodiment, the co-extrusion is a compounding extrusion, i.e. where additives are added to the components to be extruded in the outer sheath. In another embodiment, the anti-viral particles are embedded within the matrix of the provided coated substrate.

In some embodiments, solvent elimination done within the processes of this invention is accomplished via vacuum, heat, removing by another liquid, distillation or any combination thereof. In one embodiment, the solvent is eliminated by vacuum and heat. Each possibility represents a separate embodiment of this invention.

In some embodiments, the anti-viral particles within the processes of this invention are as described hereinbelow; and the matrix material is described hereinabove. Each possibility represents a separate embodiment of this invention.

In another embodiment, the process of coating is being repeated more than once. In another embodiment, the process of coating a substrate is repeated two, three, four, five times or more.

In another embodiment, the fibers are prepared by extrusion with anti-viral particles of this invention. In another embodiment between 1-10% w/w of the viral particles are added to the fiber in the extrusion process to provide an anti-viral fiber.

### Anti-Viral Particles

In one embodiment, this invention make use of anti-viral particles, wherein the particles comprise:
(i) an inorganic or organic core; and
(ii) an antiviral active unit chemically bound to the core;
   wherein the antiviral active unit is connected directly (via a bond) or indirectly (via a third linker) to the core;

wherein the anti-viral active unit comprises a monomeric unit comprising an anti-viral active group; and

wherein the number of the anti-viral active groups per each anti-viral active unit is between 1-200.

In some embodiments, the anti-viral particles comprise (i) an inorganic or organic core; and (ii) an anti-viral active part chemically bound to the core. In one embodiment, the anti-viral active part comprises one monomeric unit. In one embodiment, the anti-viral active part comprises more than one monomeric unit. In another embodiment, the anti-viral active part with the more than one monomeric unit comprises more than one linker. In another embodiment, the anti-viral active unit has between 2-200 monomeric units. In another embodiment, the anti-viral active unit has between 2-5 monomeric units. In another embodiment, the anti-viral active unit has between 5-10 monomeric units. In another embodiment, the anti-viral active unit has between 10-20 monomeric units. In another embodiment, the anti-viral active unit has between 20-50 monomeric units. In another embodiment, the anti-viral active unit has between 50-100 monomeric units. In another embodiment, the anti-viral active unit has between 100-200 monomeric units.

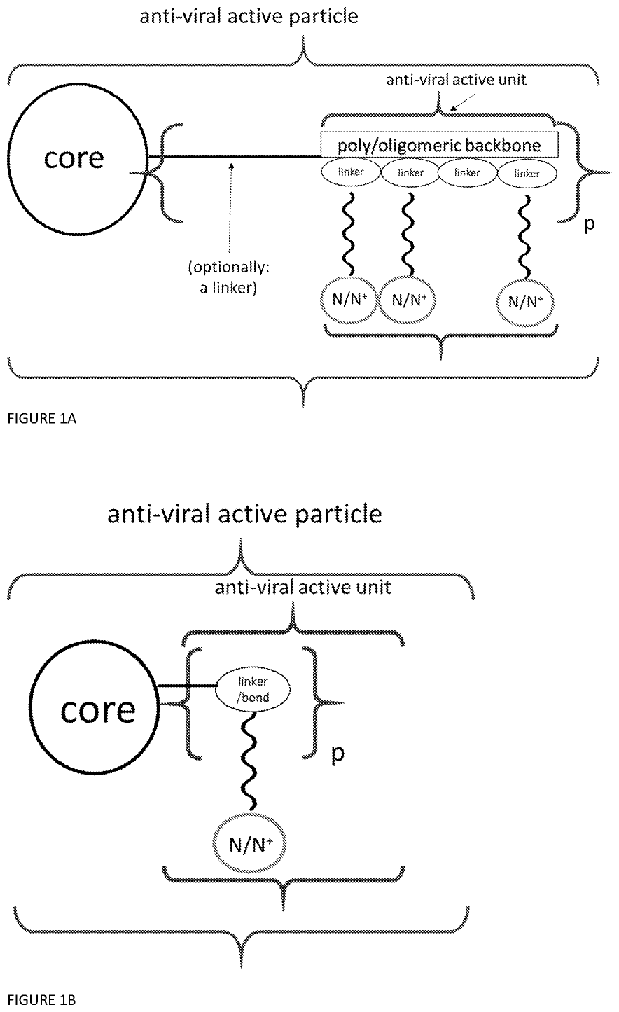

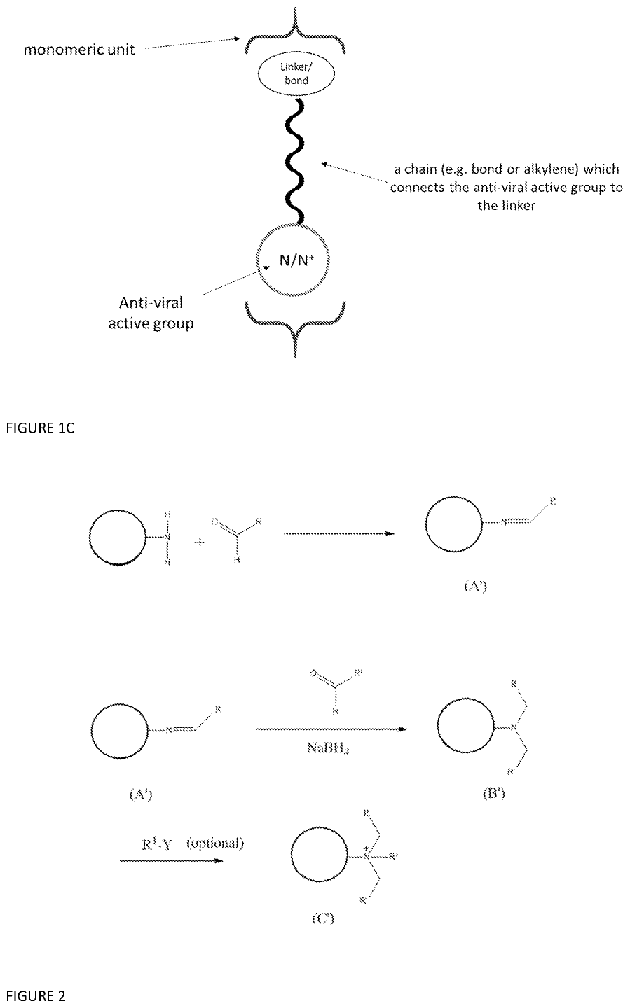

In one embodiment, the anti-viral active unit comprises more than one monomeric unit. In another embodiment, the monomeric units are connected to each other via a first linker, a second linker or both. In another embodiment, each monomeric unit comprises an anti-viral active group. In another embodiment, an anti-viral active unit comprises at least one anti-viral active group. In another embodiment, an anti-viral active unit comprises at least two anti-viral active groups. In another embodiment, FIGS. 1A, 1B and 1C illustrate schematically the anti-viral active particles of this invention (FIG. 1A: more than one monomer; FIG. 1B: one monomeric unit and FIG. 1C: detailed scheme of one monomer).

### Anti-Viral Particles Type I

In some embodiment, the anti-viral particles are presented by structure (1):

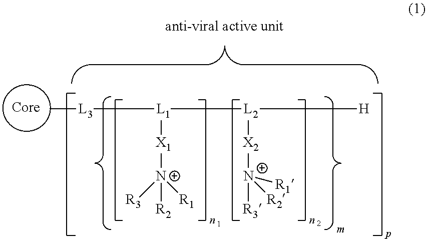

wherein
the core is an organic polymer or an inorganic material;
L₁ is a first linker or a bond;
L₂ is a second linker;
L₃ is a third linker or a bond;
R₁ and R₁′ are each independently alkyl, terpenoid, cycloalkyl, aryl, heterocycle, alkenyl, alkynyl or any combination thereof;
R₂ and R₂′ are each independently alkyl, terpenoid, cycloalkyl, aryl, heterocycle, alkenyl, alkynyl or any combination thereof;
R₃ and R₃′ are each independently nothing, hydrogen, alkyl, terpenoid moiety, cycloalkyl, aryl, heterocycle, a conjugated alkyl, alkenyl, alkynyl or any combination thereof; wherein if R₃ or R₃′ are nothing, the nitrogen is not charged;
X₁ and X₂ is each independently a bond, alkylene, alkenylene, or alkynylene;
p defines the number of anti-viral active units per one sq nm (nm²) of the core surface, wherein said density is of between 0.01-30 anti-viral units per one sq nm (nm²) of the core surface of the particle;
n₁ is each independently an integer between 0 to 200;
n₂ is each independently an integer between 0 to 200;
wherein n₁+n₂≥1; and
m is an integer between 1 to 200 and the repeating unit is the same or different.

In some embodiments, the anti-viral particles are represented by structure (2):

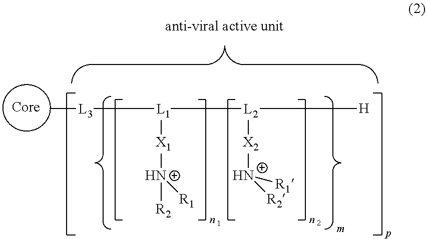

wherein
the core is an organic polymer or an inorganic material;
L₁ is a first linker or a bond;
L₂ is a second linker;
L₃ is a third linker or a bond;
R₁ and R₁′ are each independently alkyl, terpenoid, cycloalkyl, aryl, heterocycle, alkenyl, alkynyl or any combination thereof;
R₂ and R₂′ are each independently alkyl, terpenoid, cycloalkyl, aryl, heterocycle, alkenyl, alkynyl or any combination thereof;
X₁ and X₂ is each independently a bond, alkylene, alkenylene, or alkynylene;
p defines the number of anti-viral active units per one sq nm (nm²) of the core surface, wherein said density is of between 0.01-30 anti-viral units per one sq nm (nm²) of the core surface of the particle;
n₁ is each independently an integer between 0 to 200;
n₂ is each independently an integer between 0 to 200;
wherein n₁+n₂≥1;
m is an integer between 1 to 200 and the repeating unit is the same or different.

In another embodiment, the number of the anti-viral active groups per each anti-viral active part is at least two, i.e. n₁+n₂≥2 and m≥1. In another embodiment, the number of the anti-viral active groups per each anti-viral active part is one, i.e. n₁+n₂=1 and m=1.

In some embodiments, the anti-viral particles are represented by structure (3):

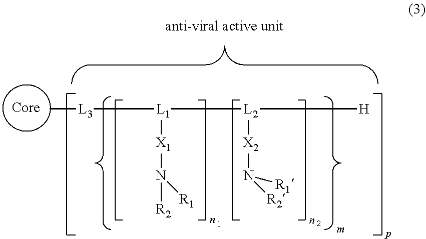

wherein
the core is an organic polymer or an inorganic material;
L₁ is a first linker or a bond;
L₂ is a second linker;
L₃ is a third linker or a bond;
R₁ and R₁′ are each independently alkyl, terpenoid, cycloalkyl, aryl, heterocycle, alkenyl, alkynyl or any combination thereof;
R₂ and R₂′ are each independently alkyl, terpenoid, cycloalkyl, aryl, heterocycle, alkenyl, alkynyl or any combination thereof;
X₁ and X₂ is each independently a bond, alkylene, alkenylene, or alkynylene;
p defines the number of anti-viral active units per one sq nm (nm²) of the core surface, wherein said density is of between 0.01-30 anti-viral units per one sq nm (nm²) of the core surface of the particle;
n₁ is each independently an integer between 0 to 200;
n₂ is each independently an integer between 0 to 200;
wherein n₁+n₂≥1;
m is an integer between 1 to 200 and the repeating unit is the same or different.

In another embodiment, the number of the anti-viral active groups per each anti-viral active part is at least two, i.e. n₁+n₂≥2 and m≥1. In another embodiment, the number of the anti-viral active groups per each anti-viral active part is one, i.e. n₁+n₂=1 and m=1.

In another embodiment, the particles of structures (1) to (3) comprise one monomeric unit per one anti-viral active unit. In another embodiment, the particles of structures (1) to (3) comprise more than one anti-viral active group per one anti-viral active unit.

In some embodiments, the anti-viral particles are represented by structure (4):

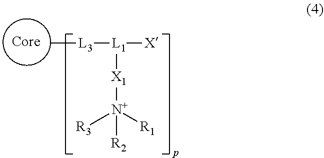

wherein
the core is an organic polymer or an inorganic material;
L₁ is a first linker or a bond;
L₃ is a third linker or a bond;
R₁ is alkyl, terpenoid, cycloalkyl, aryl, heterocycle, alkenyl, alkynyl or any combination thereof;
R₂ is alkyl, terpenoid, cycloalkyl, aryl, heterocycle, alkenyl, alkynyl or any combination thereof;
R₃ is nothing, hydrogen, alkyl, terpenoid moiety, cycloalkyl, aryl, heterocycle, alkenyl, alkynyl or any combination thereof; wherein if R₃ or R₃′ are nothing, the nitrogen is not charged;
X is a bond, alkyl, alkenyl, or alkynyl;
X′ is nothing or hydrogen; and
p defines the number of anti-viral active units per one sq nm (nm²) of the core surface, wherein said density is of between 0.01-30 anti-viral units per one sq nm (nm²) of the core surface of the particle;
wherein if Li and X are bonds, then the nitrogen is part of the core;
wherein at least one of R₁, R₂, R₃ is hydrophobic.

In some embodiments, the anti-viral particles are represented by structure (5):

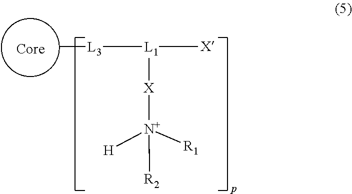

wherein
the core is an organic polymeric material or an inorganic material;
L₁ is a first linker or a bond;
L₃ is a third linker or a bond;
R₁ is alkyl, terpenoid, cycloalkyl, aryl, heterocycle, alkenyl, alkynyl or any combination thereof;
R₂ is alkyl, terpenoid, cycloalkyl, aryl, heterocycle, alkenyl, alkynyl or any combination thereof;
X is a bond, alkyl, alkenyl or alkynyl;
X′ is nothing or hydrogen; and
p defines the number of anti-viral active units per one sq nm (nm²) of the core surface, wherein said density is of between 0.01-30 anti-viral units per one sq nm (nm²) of the core surface of the particle;
wherein if L₁ and X are bonds, then the nitrogen is an integral part of the core;
wherein at least one of R₁, R₂ is hydrophobic.

In some embodiments, the anti-viral particles are represented by structure (6):

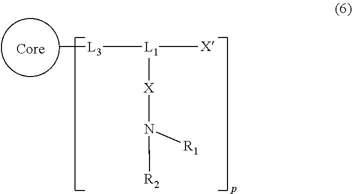

wherein
the core is an organic polymeric material or an inorganic material;
L₁ is a first linker or a bond;
L₃ is a third linker or a bond;
R₁ is alkyl, terpenoid, cycloalkyl, aryl, heterocycle, alkenyl, alkynyl or any combination thereof;
R₂ is alkyl, terpenoid, cycloalkyl, aryl, heterocycle, alkenyl, alkynyl or any combination thereof;
X is a bond, alkyl, alkenyl, or alkynyl;
X′ is nothing or hydrogen; and
p defines the number of anti-viral active units per one sq nm (nm²) of the core surface, wherein said density is of between 0.01-30 anti-viral units per one sq nm (nm²) of the core surface of the particle;
wherein if L₁ and X are bonds, then the nitrogen is an integral part of the core; wherein at least one of R₁, R₂ is hydrophobic.

Specific examples of anti-viral particles of this invention include:

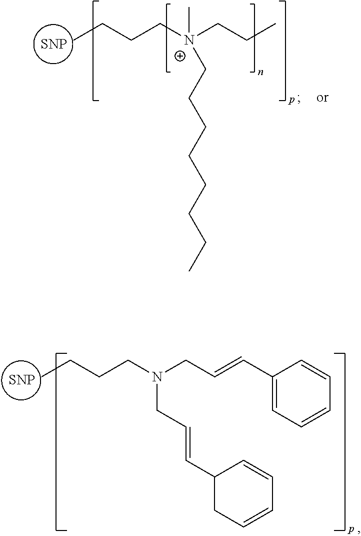

where n=1-200; “SNP” refers to the a silica core of the particles of this invention; and p defines the number of anti-viral active units per one sq nm (nm²) of the core surface, wherein said density is of between 0.01-30 anti-viral units per one sq nm (nm²) of the core surface of the particle. In another embodiment, n=1-3. In another embodiment, n=3-20. In another embodiment, n=20-50. In another embodiment, n=50-100. In another embodiment, n=100-200.

In some embodiments, the term “anti-viral active group” and the term “monomeric anti-viral active group” refer to the same and comprise a protonated tertiary amine, a tertiary amine or a quaternary ammonium, as represented by the following formulas:

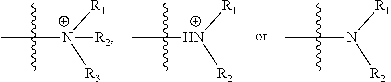

wherein:
R₁ is alkyl, terpenoid, cycloalkyl, aryl, heterocycle, alkenyl, alkynyl or any combination thereof;
R₂ is alkyl, terpenoid, cycloalkyl, aryl, heterocycle, alkenyl, alkynyl or any combination thereof;
R₃ is nothing, hydrogen, alkyl, terpenoid moiety, cycloalkyl, aryl, heterocycle, alkenyl, alkynyl or any combination thereof; wherein if R₃ or R₃′ are nothing, the nitrogen is not charged.

In another embodiment, at least one of R₁, R₂ or R₃ is hydrophobic.

In another embodiment, the number of the anti-viral active groups per each anti-viral active unit is at least two, i.e. n₁+n₂≥2 and m≥1. In another embodiment, the number of the anti-viral active groups per each anti-viral active unit is one, i.e. n₁+n₂=1 and m=1.

In another embodiment, the particles of structures (4) to (6) comprise one monomeric unit per one anti-viral active unit. In another embodiment, the particles of structures (1) to (3) comprise one or more than one anti-viral active group per one anti-viral active unit.

In another embodiment, the particle of structures (1) to (6) has an inorganic core. In another embodiment, the particle of structure (1) to (6) has an organic core. In another embodiment, the organic core is a polymeric organic core. In another embodiment, the core is inert. In one embodiment, the particles of this invention represented by structures (1)-(3) comprise an anti-viral active group of —⁺N(R₁)(R₂)(R₃), —⁺NH(R₁)(R₂), —N(R₁)(R₂)—⁺N(R₁′)(R₂′)(R₃′), —⁺NH(R₁′)(R₂′) or —N(R₁′)(R₂′). In one embodiment R₁ and/or R₁′, R₂ and/or R₂′ and R₃ and/or R₃′ are the same or different and are independently alkyl, terpenoid, cycloalkyl, aryl, heterocycle, alkenyl, alkynyl or any combination thereof. In another embodiment, R₁, R₂ and R₃ are independently an alkyl. In another embodiment, R₁ and/or R₁′, R₂ and/or R₂′ and R₃ and/or R₃′ are independently a terpenoid. In another embodiment, R₁ and/or R₁′, R₂ and/or R₂′ and R₃ and/or R₃′ are independently a cycloalkyl. In another embodiment, R₁ and/or R₁′, R₂ and/or R₂′ and R₃ and/or R₃′ are independently an aryl. In another embodiment, R₁ and/or R₁′, R₂ and/or R₂′ and R₃ and/or R₃′ are independently a heterocycle. In another embodiment, R₁ and/or R₁′, R₂ and/or R₂′ and R₃ and/or R₃′ are independently an alkenyl. In another embodiment, R₁ and/or R₁′, R₂ and/or R₂′ and R₃ and/or R₃′ are independently an alkynyl. In another embodiment, R₃ is nothing. In another embodiment, R₃ and/or R₃′ is hydrogen. In another embodiment at least one of R₁ and/or R₁′, R₂ and/or R₂′ and R₃ and/or R₃′ is hydrophobic alkyl, terpenoid, cycloalkyl, aryl, heterocycle, alkenyl, alkynyl or any combination thereof. Each represents a separate embodiment of this invention.

In another embodiment R₁ and R₁′ are the same. In another embodiment R₂ and R₂′ are the same. In another embodiment R₃ and R₃′ are the same. In another embodiment R₁ and R₁′ are different. In another embodiment R₂ and R₂′ are different. In another embodiment R₃ and R₃′ are different.

In one embodiment, at least one of R₁, R₂ and R₃ and/or at least one of R₁′, R₂′ and R₃′ of structure (1) is hydrophobic. In one embodiment, at least one of R₁ and R₂ and/or at least one of R₁′ and R₂′ of structures (2) and (3) is hydrophobic.

The term “hydrophobic” refers to an alkyl, alkenyl or alkynyl having at least four carbons, or the term hydrophobic refers to terpenoid, to cycloalkyl, aryl or heterocycle having at least six carbons. Each possibility represents a separate embodiment of this invention

In one embodiment, at least one of R₁, R₂ and R₃ and/or at least one of R₁′, R₂′ and R₃′ of structure (1) is a C₄-C₂₄ alkyl, C₄-C₂₄ alkenyl, C₄-C₂₄ alkynyl or a terpenoid. In one embodiment, at least one of R₁ and R₂ and/or at least one of R₁′ and R₂′ of structures (2) and (3) is a C₄-C₂₄ alkyl, C₄-C₂₄ alkenyl, C₄-C₂₄ alkynyl or a terpenoid. Each possibility represents a separate embodiment of this invention.

In one embodiment, at least one of R₁, R₂ and R₃ and/or at least one of R₁′, R₂′ and R₃′ of structure (1) is a C₄-C₈ alkyl, C₄-C₈ alkenyl, C₄-C₈ alkynyl or a terpenoid. In one embodiment, at least one of R₁ and R₂ and/or at least one of R₁′ and R₂′ of structures (2) and (3) is a C₄-C₈ alkyl, C₄-C₈ alkenyl, C₄-C₈ alkynyl or a terpenoid. Each possibility represents a separate embodiment of this invention.

In one embodiment, R₁ and/or R₁′ of structures (1) to (6) is a terpenoid. In another embodiment, R₁ and/or R₁′ is a terpenoid and R₂ and/or R₂′ is a C₁-C₄ alkyl. In another embodiment, the core is an organic polymeric core, R₃ and/or R₃′ is nothing and R₁ and/or R₁′ is a terpenoid. In another embodiment, the core is an organic polymeric core, R₃ and/or R₃′ is a hydrogen and R₁ and/or R₁′ is a terpenoid. In another embodiment, the core is an inorganic core, R₃ and/or R₃′ is nothing and R₁ and/or R₁′ is a terpenoid. In another embodiment, the core is an inorganic core, R₃ and/or R₃′ is a hydrogen and R₁ and/or R₁′ is a terpenoid. In another embodiment, the core is an inorganic core, R₃ and/or R₃′ is a C₁-C₂₄ alkyl, terpenoid, cycloalkyl, aryl, heterocycle, a conjugated C₁-C₂₄ alkyl, C₁-C₂₄ alkenyl, C₁-C₂₄ alkynyl or any combination thereof and R₁ and/or R₁′ is a terpenoid.

In one embodiment, the particles of this invention comprise an anti-viral active unit and an inert core, wherein the anti-viral active unit and the core are linked indirectly.

In some embodiments L₁, L₂ or L₃ is each independently the same or a different linker. In some embodiments, L₁, L₂ and L₃ are connected to each other, in any possible way. In some embodiment, L₃ is nothing and L₁ or L₂ is connected to the core covalently. In another embodiment, L₃ is connected to the core covalently and L₁ or L₂ is connected to L₃. In another embodiment, Li is connected to X, X′ and L₃ or core. In another embodiment, a “linker” comprises any possible chemical moiety capable of connecting at least two other chemical moieties which are adjacent to such linker. In another embodiment, the monomeric unit of the anti-viral active unit comprises a first and/or second linker/s (L₁ or L₂) and an anti-viral group. In another embodiment, L₁ and/or L₂ are/is the backbone of the anti-viral active unit. In some embodiments, the linker comprises a functional group. In another embodiment, the linker comprises two (same or different) functional groups. In another embodiment, the functional group comprises phosphate, phosphonate, siloxane, silane, ether acetal, amide, amine, anhydride, ester, ketone, or aromatic ring or rings functionalized with any of the preceding moieties. Each possibility represents a separate embodiment of this invention.

In another embodiment, L₁ or L₂ is a C1 to C18 alkylene, alkenylene, alkynylene or aryl substituted with at least one carboxyl moiety, wherein the carboxyl end is attached to the core. This linker may be derived from a C1 to C18 alkylene substituted with at least one carboxyl moiety and having an amino end which is modified to anti-microbial active group [—⁺N(R₁)(R₂)(R₃), —⁺NH(R₁)(R₂), —N(R₁)(R₂)—⁺N(R₁′)(R₂′)(R₃′), —⁺NH(R₁′)(R₂′) or —N(R₁′)(R₂′) (defined in structures (1) to (6))]. This linker may be derived from an amino acid of natural or synthetic source having a chain length of between 2 and 18 carbon atoms (polypeptide), or an acyl halide of said amino acid. Non-limiting examples for such amino acids are 18-amino octadecanoic acid and 18-amino stearic acid. In another embodiment, L₁ or L₂ is a C1 to C18 alkylene substituted with at least one amine or amide moiety.

In another embodiment, L₁, L₂, L₃ or any combination thereof is a C1 to C18 alkylene, alkenylene, alkynylene or aryl. This linker may be derived from a di-halo alkylene, which is functionalized at each end with the core and anti-viral active group, respectively, by replacement of the halogen moiety to a functional group that binds to the core and replacement of the halogen moiety to obtain [—⁺N(R₁)(R₂)(R₃), —⁺NH(R₁)(R₂), —N(R₁)(R₂)—⁺N(R₁′)(R₂′)(R₃′), —⁺NH(R₁′)(R₂′) or —N(R₁′)(R₂′) (defined in structures (1) to (6))]

In another embodiment, L₁, L₂, L₃ or any combination thereof is an aromatic group derived from non-limiting examples of 4,4-biphenol, dibenzoic acid, dibenzoic halides, dibenzoic sulphonates, terephthalic acid, tetrphthalic halides, and terephthalic sulphonates. This linker is functionalized with the core and anti-viral active group, respectively, through the functional group thereof (i.e., hydroxyl, carboxy or sulfonate). In another embodiment, this linker is directly attached to the core at one end or indirectly, via a third linker (L₃) and is modified at the other end to anti-viral active group [—⁺N(R₁)(R₂)(R₃), —⁺NH(R₁)(R₂), —N(R₁)(R₂)—⁺N(R₁′)(R₂′)(R₃′), —⁺NH(R₁′)(R₂′) or —N(R₁′)(R₂′) (defined in structures (1) to (6))].

In another embodiment, L₁, L₂, L₃ or any combination thereof, is a siloxane or silane group derived and/or selected from non-limiting examples of trialkoxyalkylsilane, trialkoxyarylsilane, trihaloalkylsilane, trihaloarylsilane, 3-aminopropyltriethoxysilane (APTES) and N-2-aminoethyl-3-aminopropyl trimethoxysilane. This linker is functionalized with the core and anti-viral active group, respectively, through the functional group thereof (i.e., hydroxyl, siloxane, carboxy, amide or sulfonate). In another embodiment, this linker is directly attached to the core at one end directly or indirectly, via a third linker (L3) and is modified at the other end to anti-viral active group [—⁺N(R₁)(R₂)(R₃), —⁺NH(R₁)(R₂), —N(R₁)(R₂)—⁺N(R₁′)(R₂′)(R₃′), —⁺NH(R₁′)(R₂′) or —N(R₁′)(R₂′) (defined in structures (1) to (6))].

In one embodiment, the anti-viral active group of this invention may be selected from: (a) a tertiary amine (i.e. R₃ and/or R₃′ is nothing) or tertiary ammonium (i.e. R₃ and/or R₃′ is hydrogen) comprising at least one terpenoid moiety (b) a quaternary ammonium group comprising at least one terpenoid moiety (c) a quaternary ammonium group, comprising at least one alkyl group having from 4 to 24 carbon atoms; and (d) a tertiary amine (i.e. R₃ and/or R₃′ is nothing) or tertiary ammonium (i.e. R₃ and/or R₃′ is hydrogen) comprising at least one alkyl group having from 4 to 24 carbon atoms. Each possibility represents a separate embodiment of this invention.

This linker is functionalized with the core and anti-viral active group, respectively, through the functional group thereof (i.e., hydroxyl, siloxane, carboxy, amide or sulfonate). In another embodiment, this linker is directly attached to the core at one end or indirectly, via a third linker (L3) and is modified at the other end to anti-viral active group [—⁺N(R₁)(R₂)(R₃), —⁺NH(R₁)(R₂), —N(R₁)(R₂)—⁺N(R₁′)(R₂′)(R₃′), —⁺NH(R₁′)(R₂′) or —N(R₁′)(R₂′) (defined in structures (1) to (6))].

In another embodiment, a monomeric unit (as described in e.g. FIGS. 1B-1C and formulas 1-6) within the anti-viral active unit of this invention is represented by the structure of formula IA:

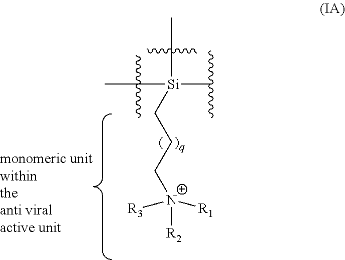

wherein
R₁ and R₂ are independently linear or branched alkyl, terpenoid, cycloalkyl, aryl, heteroaryl, alkenyl, alkynyl or any combination thereof; and
R₃ is nothing, linear or branched alkyl, terpenoid, cycloalkyl, aryl, heteroaryl, alkenyl, alkynyl or any combination thereof; wherein if R₃ is nothing, the nitrogen is not charged
q is an integer between 0 and 16;
wherein said monomeric unit is chemically bound to the surface of an inorganic core directly or via a third linker (L3).

In another embodiment, a monomeric unit (as described in e.g. FIGS. 1B-1C and formulas 1-6) within the anti-viral active unit of this invention is represented by the structure of formula IB:

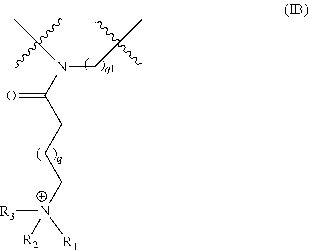

wherein
R₁ and R₂ are independently linear or branched alkyl, terpenoid, cycloalkyl, aryl, heteroarylalkenyl, alkynyl or any combination thereof; and
R₃ is nothing, linear or branched alkyl, terpenoid, cycloalkyl, aryl, heteroaryl, alkenyl, alkynyl or any combination thereof; wherein if R₃ in nothing, the nitrogen is not charged
q and q¹ are independently an integer between 0 and 16;
wherein said monomeric unit is chemically bound to the surface of an inorganic core directly or via a third linker (L3).

In another embodiment, a linker molecule which may be used in the processes of preparing the anti-viral particles of this invention is represented by the structure of formula IC:

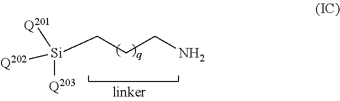

wherein
Q²⁰¹, Q²⁰² and Q²⁰³ are independently selected from the group consisting of alkoxy, methyl, ethyl, hydrogen, sulfonate and halide, wherein at least one of Q²⁰¹, Q²⁰² and Q²⁰³ is selected from ethoxy, methoxy, sulfonate (e.g., mesyl, tosyl) and halide; and
q is an integer between 0 and 16;
the linker molecule is capable of being chemically bound to the surface of the inorganic core through the silicon atom; and
the anti-viral active group is introduced by functionalizing the primary amine to obtain an anti-viral active tertiary amine or quaternary ammonium group containing at least one terpenoid group, as described above.

In another embodiment, a linker molecule which may be used in the processes of preparing the anti-viral particles of this invention is represented by the structure of formula ID:

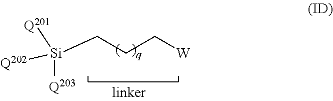

wherein
Q²⁰¹, Q²⁰² and Q²⁰³ are independently selected from the group consisting of alkoxy, methyl, ethyl, hydrogen, sulfonate and halide, wherein at least one of Q²⁰¹, Q²⁰² and Q²⁰³ is selected from ethoxy, methoxy, sulfonate (e.g., mesyl, tosyl) and halide;
W is selected from the group consisting of NH₂, halide, sulfonate and hydroxyl; and
q is an integer between 0 and 16;
said linker is capable of being chemically bound to the surface of said inorganic core through the silicon atom; and
the anti-viral active group is introduced by substituting the group W with an anti-viral active group, or converting the group W to an anti-viral active group.

The particles of this invention demonstrate an enhanced anti-viral activity. Without being bound by any theory or mechanism, it can be postulated that such activity originates from the presence of closely packed anti-viral groups on a given core's surface, as well as high density of particles packed on the surface of a host material. This density increases as each anti-viral active unit in the particles of this invention comprise increasing number of anti-viral active groups and it yields a high local concentration of active functional groups, which results in high effective concentration of the anti-viral active groups and enables the use of a relatively small amount of particles to achieve effective viral annihilation. The close packing of the anti-viral groups is due to, inter alia, numerous anti-viral active units protruding from each particle surface. Accordingly, the anti-viral groups cover large fraction of the particle's available surface area (width dimension covering the surface). The surface density of the anti-viral group results in high effective concentration promoting anti-viral inhibitory effect. According to the principles of this invention, high surface density dictates high anti-viral efficiency.

### Anti-Viral Active Groups Comprising One Long Alkyl Group.

In accordance with another embodiment, the anti-viral active group of this invention [—⁺N(R₁)(R₂)(R₃), —⁺NH(R₁)(R₂), —N(R₁)(R₂)—⁺N(R₁′)(R₂′)(R₃′), —⁺NH(R₁′)(R₂′) or —N(R₁′)(R₂′) (defined in structures (1) to (6))] is a quaternary ammonium group, a tertiary amine or a tertiary ammonium, the nitrogen atom of each amine/ammonium group having at least one bond X₁ or X₂, at least one bond to an alkyl group having from 4 to 24 carbon atoms (R₁ and/or R₁′). In another embodiment, the nitrogen atom of each amine/ammonium group having one bond to the core, one bond to an alkyl group having from 4 to 24 carbon atoms (R₁ and/or R₁′).

Since an ammonium group is positively charged, its charge should be balanced with an anion. Any of the counter-ions described above may be used to counter-balance the quaternary ammonium group.

In some embodiments, the nitrogen atom of each quaternary ammonium or tertiary ammonium group has (i) at least one bond to X₁ or X₂; and (ii) at least one bond to the alkyl group having from 4 to 24 carbon atoms.

In some embodiments, the anti-viral active group of formula (1) to (6) is selected from: (a) a tertiary amine (R₃ and/or R₃′ is nothing) or tertiary ammonium (R₃ and/or R₃′ is H), wherein the nitrogen atom of each tertiary amine/ammonium having at least one bond to X₁ or X₂ and one bond to the alkyl group having from 4 to 24 carbon atoms; (b) a tertiary amine (R₃ and/or R₃′ is nothing), or tertiary ammonium (R₃ and/or R₃′ is H), wherein the nitrogen atom of each tertiary amine/ammonium having one bond to X₁ or X₂ and two bonds to alkyl groups having from 4 to 24 carbon atoms which may be the same or different from each other, or a salt of said tertiary amine; (c) a quaternary ammonium group wherein the nitrogen atom of each quaternary ammonium group having at least one bond to X₁ or X₂ and one or two bonds to the alkyl groups having from 4 to 24 carbon atoms which may be the same or different from each other. Each possibility represents a separate embodiment of this invention.

The term “quaternary ammonium group” refers to a group of atoms consisting of a nitrogen atom with four substituents (different than hydrogen) attached thereto. In another embodiment, a “quaternary ammonium group” refers to a group of atoms consisting of a nitrogen atom with four groups wherein each of the group is attached to the nitrogen through a carbon atom. The term “long alkyl group” or chain refers to such an alkyl group or chain which is substituted on the nitrogen atom of the quaternary ammonium group and which has between 4 and 24 carbon atoms. In some currently preferred embodiments, the alkyl group is an alkyl group having 4 to 18 carbon atoms. In some currently preferred embodiments, the alkyl group is an alkyl group having 4 to 8 carbon atoms. In some currently preferred embodiments, the alkyl group is an alkyl group having 4 to 10 carbon atoms. In other currently preferred embodiments, the alkyl group is an alkyl group having 6, 7, or 8 carbon atoms, with each possibility representing a separate embodiment of this invention.

Anti-Viral Particles with an Enhanced Thermal Stability

In one embodiment, the anti-viral particle is represented by structure (I):

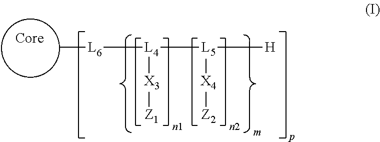

wherein
the core is an organic polymer or an inorganic material;
L₄ is a first linker or a bond;
L₅ is a second linker;
L₆ is a third linker or a bond;

### Z₁ is

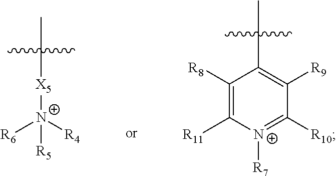

### Z₂ is

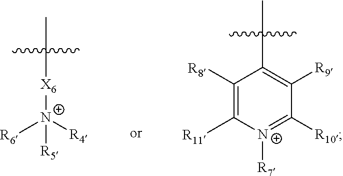

R₄ₐ and R₄′ are each independently methyl, CF₃, perhaloalkyl, aryl, benzyl, 2,2-disubstituted C₃-C₂₀alkyl, 2,2,2-trisubstituted ethyl, —CH₂C(═O)OR, —CH₂C(═O)OC(═O)R, —CH₂C(═S)OR, —CH₂C(═O)SR, —C(═O)OR, —C(═O)OC(═O)R, —C(═S)OR, —C(═O)SR, —C(═O)—R, —C(═S)—R, —CH₂C(═O)R, —CH₂C(═S)R, —CH₂CF₃, —CH₂NO₂, 1-alkenyl, 1-alkynyl, 2-alkenyl, 2-alkynyl or any combination thereof;
R₅ and R₅′ are each independently methyl, CF₃, perhaloalkyl, aryl, benzyl, 2,2-disubstituted C₃-C₂₀alkyl, 2,2,2-trisubstituted ethyl, —CH₂C(═O)OR, —CH₂C(═O)OC(═O)R, —CH₂C(═S)OR, —CH₂C(═O)SR, —C(═O)OR, —C(═O)OC(═O)R, —C(═S)OR, —C(═O)SR, —C(═O)—R, —C(═S)—R, —CH₂C(═O)R, —CH₂C(═S)R, —CH₂CF₃, —CH₂NO₂, 1-alkenyl, 1-alkynyl, 2-alkenyl, 2-alkynyl or any combination thereof;
R₆ and R₆′ are each independently absent, methyl, CF₃, perhaloalkyl, 2,2-disubstituted C₃-C₂₀ alkyl, 2,2,2-trisubstituted ethyl, —CH₂C(═)OR, —CH₂C(═O)OC(═O)R, —CH₂C(═S)OR, —CH₂C(═O)SR, —C(═O)OR, —C(═O)OC(═O)R, —C(═S)OR, —C(═O)SR, —C(═O)—R, —C(═S)—R, —CH₂C(═O)R, —CH₂C(═S)R, —CH₂CF₃, —CH₂NO₂, terpenoid moiety, cycloalkyl, aryl, phenyl, benzyl, heterocycle, a conjugated alkyl, 1-alkenyl, 1-alkynyl, 2-alkenyl, 2-alkynyl or any combination thereof;
R₇ and R₇′ are each independently methyl, CF₃, perhaloalkyl, aryl, benzyl, 2,2-disubstituted C₃-C₂₀alkyl, 2,2,2-trisubstituted ethyl, —CH₂C(═O)OR, —CH₂C(═O)OC(═O)R, —CH₂C(═S)OR, —CH₂C(═O)SR, —C(═O)OR, —C(═O)OC(═O)R, —C(═S)OR, —C(═O)SR, —C(═O)—R, —C(═S)—R, —CH₂C(═O)R, —CH₂C(═S)R, —CH₂CF₃, —CH₂NO₂, 1-alkenyl, 1-alkynyl, 2-alkenyl, 2-alkynyl or any combination thereof;
R₈ and R₈′ are each independently H, alkyl, terpenoid moiety, cycloalkyl, aryl, heterocycle, a conjugated alkyl, alkenyl, alkynyl or any combination thereof;
R₉ and R₉′ are each independently H, alkyl, terpenoid moiety, cycloalkyl, aryl, heterocycle, a conjugated alkyl, alkenyl, alkynyl or any combination thereof;
R₁₀ and R₁₀′ are each independently H, alkyl, terpenoid moiety, cycloalkyl, aryl, heterocycle, a conjugated alkyl, alkenyl, alkynyl or any combination thereof;
R₁₁ and R₁₁′ are each independently H, alkyl, terpenoid moiety, cycloalkyl, aryl, heterocycle, a conjugated alkyl, alkenyl, alkynyl or any combination thereof;
X₃ and X₄ are each independently a bond, alkylene, arylene, alkenylene, alkynylene or any combination thereof;
X₅ and X₆ are each independently a bond, —O—C(═O)—, methylene, —O—C(═O)—CH₂—, 2,2-disubstituted C₂-C₂₀ alkylene, arylene, phenylene, benzylene, cycloalkylene, a heterocycle, a conjugated alkylene, a terpenoid moiety, 1-alkenylene, 1-alkynylene, 2-alkenylene, 2-alkynylene or any combination thereof;
R is alkyl, aryl, cycloalkyl, heterocycle or any combination thereof;
p defines the number of anti-viral active unit per one sq nm (nm²) of the core surface, wherein said density is of between 0.01-30 anti-viral units per one sq nm (nm²) of the core surface of the particle;
n₁ is each independently an integer between 0 to 200;
n₂ is each independently an integer between 0 to 200;
wherein n₁+n₂≥1; and
m is an integer between 1 to 200 and the repeating unit is the same or different.

In another embodiment, provided that Z₁ or Z₂ comprises an ammonium nitrogen (not pyridinium)—in each of the anti-viral active units only one moiety on the ammonium may have beta hydrogens available for hofmann elimination. In another embodiment, provided that Z₁ or Z2 comprises an ammonium nitrogen (not pyridinium)—in each of the anti-viral active units two moieties on the ammonium may have beta hydrogens available for hofmann elimination. In another embodiment, beta hydrogens available for hofmann elimination are those which are found on beta (compared to the ammonium nitrogen) aliphatic carbon and can be eliminated to release an olefin and a tertiary amine.

In another embodiment, the anti-viral particle is represented by structure (IE):

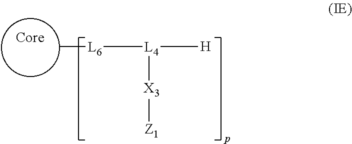

wherein
the core is an organic polymer or an inorganic material;
L₄ is a first linker or a bond;
L₆ is a third linker or a bond;

### Z₁ is

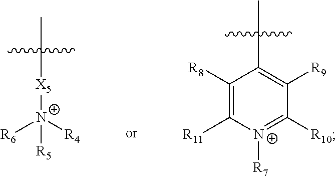

R₄ is methyl, CF₃, perhaloalkyl, aryl, benzyl, 2,2-disubstituted C₃-C₂₀ alkyl, 2,2,2-trisubstituted ethyl, —CH₂C(═O)OR, —CH₂C(═O)OC(═O)R, —CH₂C(═S)OR, —CH₂C(═O)SR, —C(═O)OR, —C(═O)OC(═O)R, —C(═S)OR, —C(═O)SR, —CH₂C(═O)R, —CH₂C(═S)R, —CH₂CF₃, —CH₂NO₂, 1-alkenyl, 1-alkynyl, 2-alkenyl, 2-alkynyl or any combination thereof;
R₅ is methyl, CF₃, perhaloalkyl, aryl, benzyl, 2,2-disubstituted C₃-C₂₀ alkyl, 2,2,2-trisubstituted ethyl, —CH₂C(═O)OR, —CH₂C(═O)OC(═O)R, —CH₂C(═S)OR, —CH₂C(═O)SR, —C(═O)OR, —C(═O)OC(═O)R, —C(═S)OR, —C(═O)SR, —C(═O)—R, —C(═S)—R, —CH₂C(═O)R, —CH₂C(═S)R, —CH₂CF₃, —CH₂NO₂, 1-alkenyl, 1-alkynyl, 2-alkenyl, 2-alkynyl or any combination thereof;
R₆ is methyl, CF₃, perhaloalkyl, 2,2-disubstituted C₃-C₂₀ alkyl, 2,2,2-trisubstituted ethyl, —CH₂C(═O)OR, —CH₂C(═O)OC(═O)R, —CH₂C(═S)OR, —CH₂C(═O)SR, —C(═O)OR, —C(═O)OC(═O)R, —C(═S)OR, —C(═O)SR, —C(═O)—R, —C(═S)—R, —CH₂C(═O)R, —CH₂C(═S)R, —CH₂CF₃, —CH₂NO₂, terpenoid moiety, cycloalkyl, aryl, phenyl, benzyl, heterocycle, a conjugated alkyl, 1-alkenyl, 1-alkynyl, 2-alkenyl, 2-alkynyl or any combination thereof;
R₇ is methyl, CF₃, perhaloalkyl, aryl, benzyl, 2,2-disubstituted C₃-C₂₀ alkyl, 2,2,2-trisubstituted ethyl, —CH₂C(═O)OR, —CH₂C(═O)OC(═O)R, —CH₂C(═S)OR, —CH₂C(═O)SR, —C(═O)OR, —C(═O)OC(═O)R, —C(═S)OR, —C(═O)SR, —C(═O)—R, —C(═S)—R, —CH₂C(═O)R, —CH₂C(═S)R, —CH₂CF₃,-CH₂NO₂, 1-alkenyl, 1-alkynyl, 2-alkenyl, 2-alkynyl or any combination thereof;
R₈ is H, alkyl, terpenoid moiety, cycloalkyl, aryl, heterocycle, a conjugated alkyl, alkenyl, alkynyl or any combination thereof;
R₉ is H, alkyl, terpenoid moiety, cycloalkyl, aryl, heterocycle, a conjugated alkyl, alkenyl, alkynyl or any combination thereof;
R₁₀ is H, alkyl, terpenoid moiety, cycloalkyl, aryl, heterocycle, a conjugated alkyl, alkenyl, alkynyl or any combination thereof;
R₁₁ is H, alkyl, terpenoid moiety, cycloalkyl, aryl, heterocycle, a conjugated alkyl, alkenyl, alkynyl or any combination thereof;
X₃ is a bond, alkylene, arylene, alkenylene, alkynylene or any combination thereof;
X₅ is a bond, —O—C(═O)—, methylene, —O—C(═O)—CH₂—, 2,2-disubstituted C₂-C₂₀ alkylene, arylene, phenylene, benzylene, cycloalkylene, a heterocycle, a conjugated alkylene, a terpenoid moiety, 1-alkenylene, 1-alkynylene, 2-alkenylene, 2-alkynylene or any combination thereof;
R is alkyl, aryl, cycloalkyl, heterocycle or any combination thereof; and
p defines the number of anti-viral active unit per one sq nm (nm²) of the core surface, wherein said density is of between 0.01-30 anti-viral units per one sq nm (nm²) of the core surface of the particle.

In another embodiment, provided that Z₁ comprises an ammonium nitrogen (not pyridinium)—in each of the anti-viral active units only one moiety on the ammonium may have beta hydrogens available for hofmann elimination. In another embodiment, provided that Z₁ or Z₂ comprises an ammonium nitrogen (not pyridinium)—in each of the anti-viral active units two moieties on the ammonium may have beta hydrogens available for hofmann elimination.

In another embodiment, the anti-viral particle is represented by structure (II):

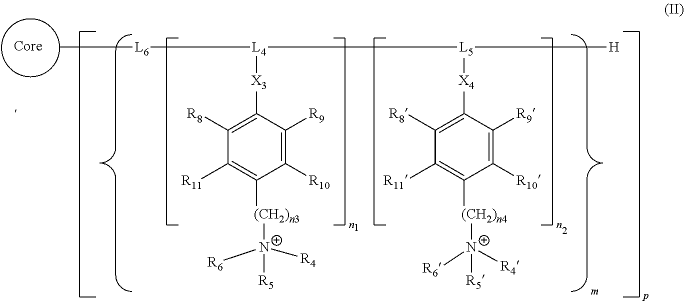

wherein
the core is an organic polymer or an inorganic material;
L₄ is a first linker or a bond;
L₅ is a second linker;
L₆ is a third linker or a bond;
R₄ and R₄′ are each independently methyl, CF₃, perhaloalkyl, aryl, benzyl, 2,2-disubstituted C₃-C₂₀alkyl, 2,2,2-trisubstituted ethyl, —CH₂C(═O)OR, —CH₂C(═O)OC(═O)R, —CH₂C(═S)OR, —CH₂C(═O)SR, —C(═O)OR, —C(═O)OC(═O)R, —C(═S)OR, —C(═O)SR, —C(═O)—R, —C(═S)—R, —CH₂C(═O)R, —CH₂C(═S)R, —CH₂CF₃,-CH₂NO₂, 1-alkenyl, 1-alkynyl, 2-alkenyl, 2-alkynyl or any combination thereof;
R₅ and R₅′ are each independently methyl, CF₃, perhaloalkyl, aryl, benzyl, 2,2-disubstituted C₃-C₂₀alkyl, 2,2,2-trisubstituted ethyl, —CH₂C(═O)OR, —CH₂C(═O)OC(═O)R, —CH₂C(═S)OR, —CH₂C(═O)SR, —C(═O)OR, —C(═O)OC(═O)R, —C(═S)OR, —C(═O)SR, —C(═O)—R, —C(═S)—R, —CH₂C(═O)R, —CH₂C(═S)R, —CH₂CF₃, —CH₂NO₂, 1-alkenyl, 1-alkynyl, 2-alkenyl, 2-alkynyl or any combination thereof;
R₆ and R₆′ are each independently methyl, CF₃, perhaloalkyl, 2,2-disubstituted C₃-C₂₀ alkyl, 2,2,2-trisubstituted ethyl, —CH₂C(═O)OR, —CH₂C(═O)OC(═O)R, —CH₂C(═S)OR, —CH₂C(═O)SR, —C(═O)OR, —C(═O)OC(═O)R, —C(═S)OR, —C(═O)SR, —C(═O)—R, —C(═S)—R, —CH₂C(═O)R, —CH₂C(═S)R, —CH₂CF₃, —CH₂NO₂, terpenoid moiety, cycloalkyl, aryl, phenyl, benzyl, heterocycle, a conjugated alkyl, 1-alkenyl, 1-alkynyl, 2-alkenyl, 2-alkynyl or any combination thereof;
R₇ and R₇′ are each independently methyl, CF₃, perhaloalkyl, aryl, benzyl, 2,2-disubstituted C₃-C₂₀alkyl, 2,2,2-trisubstituted ethyl, —CH₂C(═O)OR, —CH₂C(═O)OC(═O)R, —CH₂C(═S)OR, —CH₂C(═O)SR, —C(═O)OR, —C(═O)OC(═O)R, —C(═S)OR, —C(═O)SR, —C(═O)—R, —C(═S)—R, —CH₂C(═O)R, —CH₂C(═S)R, —CH₂CF₃,-CH₂NO₂, 1-alkenyl, 1-alkynyl, 2-alkenyl, 2-alkynyl or any combination thereof;
R₈ and R₈′ are each independently H, alkyl, terpenoid moiety, cycloalkyl, aryl, heterocycle, a conjugated alkyl, alkenyl, alkynyl or any combination thereof;
R₉ and R₉′ are each independently H, alkyl, terpenoid moiety, cycloalkyl, aryl, heterocycle, a conjugated alkyl, alkenyl, alkynyl or any combination thereof;
R₁₀ and R₁₀′ are each independently H, alkyl, terpenoid moiety, cycloalkyl, aryl, heterocycle, a conjugated alkyl, alkenyl, alkynyl or any combination thereof;
R₁₁ and R₁₁′ are each independently H, alkyl, terpenoid moiety, cycloalkyl, aryl, heterocycle, a conjugated alkyl, alkenyl, alkynyl or any combination thereof;
X₃ and X₄ are each independently a bond, alkylene, arylene, alkenylene, alkynylene or any combination thereof;
R is alkyl, aryl, cycloalkyl, heterocycle or any combination thereof;
p defines the number of anti-viral active unit per one sq nm (nm²) of the core surface, wherein said density is of between 0.01-30 anti-viral units per one sq nm (nm²) of the core surface of the particle;
n₁ is each independently an integer between 0 to 200;
n₂ is each independently an integer between 0 to 200;
n₃ and n₄ are each independently 0 or 1;
wherein n₁+n₂≥1; and
m is an integer between 1 to 200 and the repeating unit is the same or different.
In another embodiment, in each of the anti-viral active units only one moiety on the ammonium may have beta hydrogens available for hofmann elimination.

In another embodiment, the anti-viral particle is represented by structure (II):

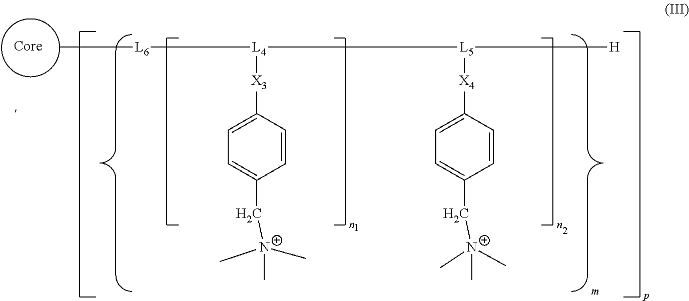

wherein
the core is an organic polymer or an inorganic material;
L₄ is a first linker or a bond;
L₅ is a second linker;
L₆ is a third linker or a bond;
X₃ and X₄ are each independently a bond, alkylene, arylene, alkenylene, alkynylene or any combination thereof;
p defines the number of anti-viral active unit per one sq nm (nm²) of the core surface, wherein said density is of between 0.01-30 anti-viral units per one sq nm (nm²) of the core surface of the particle;
n₁ is each independently an integer between 0 to 200;
n₂ is each independently an integer between 0 to 200;
wherein n₁+n₂≥1; and
m is an integer between 1 to 200 and the repeating unit is the same or different.

In another embodiment, the anti-viral particle is represented by structure (IV):

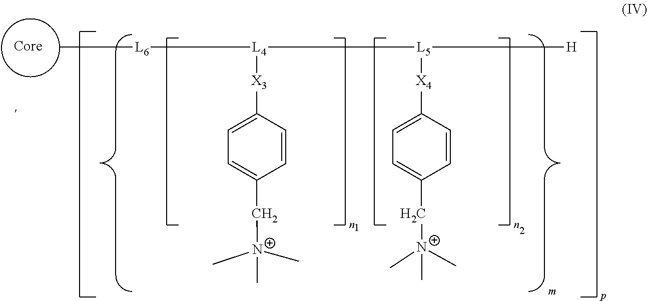

wherein
the core is an organic polymer or an inorganic material;
L₄ is a first linker or a bond;
L₅ is a second linker;
L₆ is a third linker or a bond;
X₃ and X₄ are each independently a bond, alkylene, arylene, alkenylene, alkynylene or any combination thereof;
p defines the number of anti-viral active unit per one sq nm (nm²) of the core surface, wherein said density is of between 0.01-30 anti-viral units per one sq nm (nm²) of the core surface of the particle;
n₁ is each independently an integer between 0 to 200;
n₂ is each independently an integer between 0 to 200;
wherein n₁+n₂≥1; and
m is an integer between 1 to 200 and the repeating unit is the same or different.

In another embodiment, the anti-viral particle is represented by structure (V):

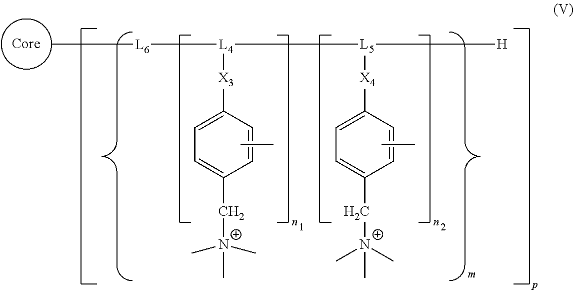

wherein
the core is an organic polymer or an inorganic material;
L₄ is a first linker or a bond;
L₅ is a second linker;
L₆ is a third linker or a bond;
X₃ and X₄ are each independently a bond, alkylene, arylene, alkenylene, alkynylene or any combination thereof;
p defines the number of anti-viral active unit per one sq nm (nm²) of the core surface, wherein said density is of between 0.01-30 anti-viral units per one sq nm (nm²) of the core surface of the particle;
n₁ is each independently an integer between 0 to 200;
n₂ is each independently an integer between 0 to 200;
wherein n₁+n₂≥1; and
m is an integer between 1 to 200 and the repeating unit is the same or different.

In another embodiment, the anti-viral particle is represented by structure (VI):

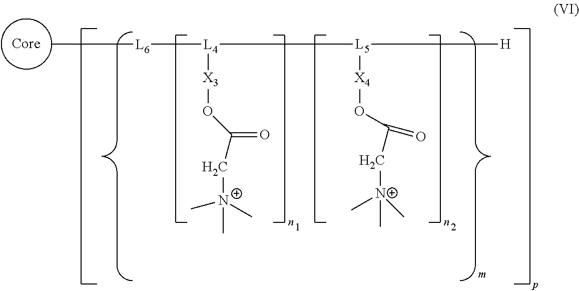

wherein
the core is an organic polymer or an inorganic material;
L₄ is a first linker or a bond;
L₅ is a second linker;
L₆ is a third linker or a bond;
X₃ and X₄ are each independently a bond, alkylene, arylene, alkenylene, alkynylene or any combination thereof;
p defines the number of anti-viral active unit per one sq nm (nm²) of the core surface, wherein said density is of between 0.01-30 anti-viral units per one sq nm (nm²) of the core surface of the particle;
n₁ is each independently an integer between 0 to 200;
n₂ is each independently an integer between 0 to 200;
wherein n₁+n₂≥1; and
m is an integer between 1 to 200 and the repeating unit is the same or different.

In another embodiment, the anti-viral particle is represented by structure (VII):

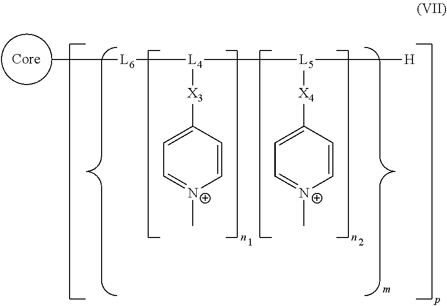

wherein
the core is an organic polymer or an inorganic material;
L4 is a first linker or a bond;
L₅ is a second linker;
L₆ is a third linker or a bond;
X₃ and X₄ are each independently a bond, alkylene, arylene, alkenylene, alkynylene or any combination thereof;
p defines the number of anti-viral active unit per one sq nm (nm²) of the core surface, wherein said density is of between 0.01-30 anti-viral units per one sq nm (nm²) of the core surface of the particle;
n₁ is each independently an integer between 0 to 200;
n₂ is each independently an integer between 0 to 200;
wherein n₁+n₂≥1; and
m is an integer between 1 to 200 and the repeating unit is the same or different.

In some embodiments, the anti-viral particles of structures (I), (IE) and (II)-(VII) have high thermal stability. Without being bound by any mechanism or theory, it is suggested that the high stability stems from lack of available beta (β) hydrogens on the ammonium or a low number thereof, thus reducing the possibility of having a hofmann elimination which in turn gives rise to reduced thermal stability.

In some embodiments, the term “anti-viral active group” and the term “monomeric anti-viral active group” refer to the same and comprise a quaternary ammonium and/or a pyridinium, as represented by the following formulas:

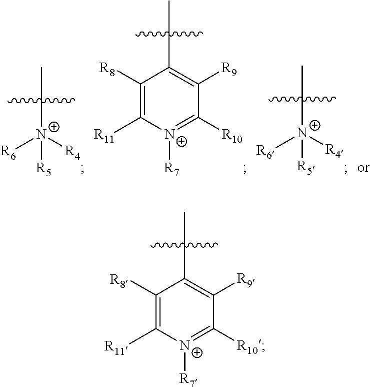

wherein:
R₄-R₁₁ and R₄′-R₁₁′ are as described hereinabove.

In another embodiment, the number of the anti-viral active groups per each anti-viral active unit is at least two, i.e. n₁+n₂≥2 and m≥1. In another embodiment, the number of the anti-viral active groups per each anti-viral active unit is one, i.e. n₁+n₂=1 and m=1.

In another embodiment, the particles of structure (IE) comprise one monomeric unit per one anti-viral active unit. In another embodiment, the particles of structures (I) and (II) to (VII) comprise one or more than one anti-viral active group per one anti-viral active unit.

The anti-viral active groups of this invention are chemically bound to the core at a surface density of at least one anti-viral active group per 10 sq. nm of the core surface. In another embodiment at least 1 anti-viral group per 1 sq nm of the core surface. In another embodiment at least 0.1 anti-viral active group per 1 sq nm of the core surface. In another embodiment between 0.001-300 anti-viral groups per sq nm of the core surface. In another embodiment between 0.001-250 anti-viral groups per sq nm of the core surface. In another embodiment between 0.001-200 anti-viral groups per sq nm of the core surface. In another embodiment between 0.001-150 anti-viral groups per sq nm of the core surface. In another embodiment between 0.001-100 anti-viral groups per sq nm of the core surface. In another embodiment between 0.001-50 anti-viral groups per sq nm of the core surface. In another embodiment between 0.001-20 anti-viral groups per sq nm of the core surface. In another embodiment between 0.001-17 anti-viral groups per sq nm of the core surface. In another embodiment between 0.001-15 anti-viral groups per sq nm of the core surface. In another embodiment between 0.001-10 anti-viral groups per sq nm of the core surface. In another embodiment between 0.001-4 anti-viral groups per sq nm of the core surface. In another embodiment between 0.001-1 anti-viral groups per sq nm of the core surface. In another embodiment between 50-100 anti-viral groups per sq nm of the core surface. In another embodiment between 0.1-200 anti-viral groups per sq nm of the core surface. In another embodiment between 100-150 anti-viral groups per sq nm of the core surface. In another embodiment between 150-200 anti-viral groups per sq nm of the core surface. In another embodiment between 200-250 anti-viral groups per sq nm of the core surface. In another embodiment between 250-300 anti-viral groups per sq nm of the core surface. In another embodiment between 1-4 anti-viral groups per sq nm of the core surface. In another embodiment between 1-6 anti-viral groups per sq nm of the core surface. In another embodiment between 1-20 anti-viral groups per sq nm of the core surface. In another embodiment between 1-10 anti-viral groups per sq nm of the core surface. In another embodiment between 1-15 anti-viral groups per sq nm of the core surface.

In some embodiments, the number of the anti-viral active groups [(n₁+n₂)×m] per each anti-viral active unit is between 1-200. In another embodiment, the number of the anti-viral active groups per each anti-viral active unit is between 1-150. In another embodiment, the number of the anti-viral active groups per each anti-viral active unit is between 1-100. In another embodiment, the number of the anti-viral active groups per each anti-viral active unit is between 1-50. In another embodiment, the number of the anti-viral active groups per each anti-viral active unit is between 1-30. In another embodiment, the number of the anti-viral active groups per each anti-viral active unit is between 1-20. In another embodiment, the number of the anti-viral active groups per each anti-viral active unit is between 1-10. In another embodiment, the number of the anti-viral active groups per each anti-viral active unit is between 50-100. In another embodiment, the number of the anti-viral active groups per each anti-viral active unit is between 100-150. In another embodiment, the number of the anti-viral active unit per each anti-viral active unit is between 150-200.

In some embodiments, the number of the monomeric units per each anti-viral active unit is between 1-200. In another embodiment, the number of the monomeric units per each anti-viral active unit is between 1-150. In another embodiment, the number of the monomeric units per each anti-viral active unit is between 1-100. In another embodiment, the number of the monomeric units per each anti-viral active unit is between 1-50. In another embodiment, the number of the monomeric units per each anti-viral active unit is between 1-30. In another embodiment, the number of monomeric units per each anti-viral active unit is between 1-20. In another embodiment, the number of the monomeric units per each anti-viral active unit is between 1-10. In another embodiment, the number of the monomeric units per each anti-viral active unit is between 50-100. In another embodiment, the number of the monomeric units per each anti-viral active unit is between 100-150. In another embodiment, the number of the monomeric units per each anti-viral active unit is between 150-200.

In another embodiment, the particle of structures (I), (IE) and (II)-(VII) has an inorganic core. In another embodiment, the particle of structure (I), (IE) and (II)-(VII) has an organic core. In another embodiment, the organic core is a polymeric organic core. In another embodiment, the core is inert.

In one embodiment, Z₁ is

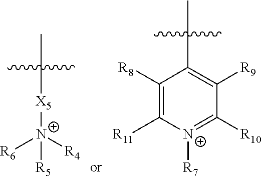

wherein X₅ and R₄-R₁₁ are as described hereinbelow. Each possibility represents a separate embodiment of this invention.
In one embodiment, Z₂ is

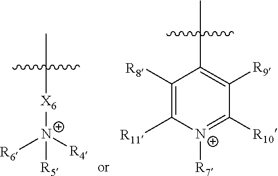

wherein X₆ and R₄′-R₁₁′ are as described hereinbelow. Each possibility represents a separate embodiment of this invention.

In one embodiment, R₄ and/or R₄′, R₅ and/or R₅′ and R₇ and/or R₇′ are the same or different and are independently methyl, CF₃, perhaloalkyl, aryl, benzyl, 2,2-disubstituted C₃-C₂₀ alkyl, 2,2,2-trisubstituted ethyl, —CH₂C(═)OR, —CH₂C(═O)OC(═O)R, —CH₂C(═S)OR, —CH₂C(═O)SR, —C(═O)OR, —C(═O)OC(═O)R, —C(═S)OR, —C(═O)SR, —C(═O)—R, —C(═S)—R, —CH₂C(═O)R, —CH₂C(═S)R, —CH₂CF₃, —CH₂NO₂, 1-alkenyl, 1-alkynyl, 2-alkenyl, 2-alkynyl or any combination thereof, wherein R is described hereinbelow. Each possibility represents a separate embodiment of this invention.

In one embodiment, R₆ and R₆′ are each independently absent, methyl, CF₃, perhaloalkyl, 2,2-disubstituted C₃-C₂₀ alkyl, 2,2,2-trisubstituted ethyl, —CH₂C(═O)OR, —CH₂C(═O)OC(═O)R, —CH₂C(═S)OR, —CH₂C(═O)SR, —C(═O)OR, —C(═O)OC(═O)R, —C(═S)OR, —C(═O)SR, —C(═O)—R, —C(═S)—R, —CH₂C(═O)R, —CH₂C(═S)R, —CH₂CF₃, —CH₂NO₂, terpenoid moiety, cycloalkyl, aryl, phenyl, benzyl, heterocycle, a conjugated alkyl, 1-alkenyl, 1-alkynyl, 2-alkenyl, 2-alkynyl or any combination thereof;

Each possibility represents a separate embodiment of this invention.

In one embodiment, R₈ and/or R₈′, R₉ and/or R₉′, R₁₀ and/or R₁₀′ and R₁₁ and/or R₁₁′ are the same or different and are independently H, alkyl, terpenoid moiety, cycloalkyl, aryl, heterocycle, a conjugated alkyl, alkenyl, alkynyl or any combination thereof. Each possibility represents a separate embodiment of this invention.

In one embodiment, X₃ and/or X₄ are the same or different and are independently a bond, alkylene, arylene, alkenylene, alkynylene or any combination thereof. Each possibility represents a separate embodiment of this invention.

In one embodiment, X₅ and X₆ are each independently a bond, —O—C(═O)—, methylene, —O—C(═O)—CH₂—, 2,2-disubstituted C₂-C₂₀ alkylene, arylene, phenylene, benzylene, cycloalkylene, a heterocycle, a conjugated alkylene, a terpenoid moiety, 1-alkenylene, 1-alkynylene, 2-alkenylene, 2-alkynylene or any combination thereof. Each possibility represents a separate embodiment of this invention.

In one embodiment, R is alkyl, aryl, cycloalkyl, heterocycle or any combination thereof. Each possibility represents a separate embodiment of this invention.

In another embodiment R₄ and R₄′ are the same. In another embodiment R₅ and R₅′ are the same. In another embodiment R₆ and R₆′ are the same. In another embodiment R₇ and R₇′ are the same. In another embodiment R₈ and R₈′ are the same. In another embodiment R₉ and R₉′ are the same. In another embodiment R₁₀ and R₁₀′ are the same. In another embodiment R₁₁ and R₁₁′ are the same. In another embodiment X₃ and X₄ are the same. In another embodiment X₅ and X₆ are the same. In another embodiment R₄ and R₄′ are different. In another embodiment R₅ and R₅′ are different. In another embodiment R₆ and R₆′ are different. In another embodiment R₇ and R₇′ are different. In another embodiment R₈ and R₈′ are different. In another embodiment R₉ and R₉′ are different. In another embodiment R₁₀ and R₁₀′ are different. In another embodiment R₁₁ and R₁₁′ are different. In another embodiment X₃ and X₄ are different. In another embodiment X₅ and X₆ are different.

As used herein, the term “alkyl” or “alkylene” refer to any linear- or branched-chain alkyl group containing up to about 24 carbons unless otherwise specified. In one embodiment, an alkyl includes C₁-C₃ carbons. In one embodiment, an alkyl includes C₁-C₄ carbons. In one embodiment, an alkyl includes C₁-C₅ carbons. In another embodiment, an alkyl includes C₁-C₆ carbons. In another embodiment, an alkyl includes C₁-C₈ carbons. In another embodiment, an alkyl includes C₁-C₁₀ carbons. In another embodiment, an alkyl includes C₁-C₁₂ carbons. In another embodiment, an alkyl includes C₄-C₈ carbons. In another embodiment, an alkyl includes C₄-C₁₀ carbons. In another embodiment, an alkyl include C₄-C₁₈ carbons. In another embodiment, an alkyl include C₄-C₂₄ carbons. In another embodiment, an alkyl includes C₁-C₁₈ carbons. In another embodiment, an alkyl includes C₂-C₁₈ carbons. In another embodiment, branched alkyl is an alkyl substituted by alkyl side chains of 1 to 5 carbons. In one embodiment, the alkyl group may be unsubstituted. In another embodiment, the alkyl group may be substituted by a halogen, haloalkyl, hydroxyl, alkoxy, carbonyl, amido, alkylamido, dialkylamido, cyano, nitro, CO₂H, amino, alkylamino, dialkylamino, carboxyl, thio and/or thioalkyl. In another embodiment, the alkyl is a 2,2-disubstituted C₃-C₂₀ alkyl. The term “2,2-disubstituted C₃-C₂₀ alkyl” refers to alkyl as described herein, having between 3 and 20 carbons and is substituted thrice at the second carbon (from the connection point) with halogen, haloalkyl, alkyl, alkoxy, carbonyl, amido, alkylamido, dialkylamido, cyano, nitro, CO₂H, amino, alkylamino, dialkylamino, carboxyl, thio and/or thioalkyl, where such substitutions can be the same or different; or alternatively it is substituted once at the second carbon with oxo (═O) or with other double bond to an element (e.g. S) or a moiety (e.g. vinylic carbon or NH) and it's further substituted with a substitutent selected from the above list of the first possibility; in all cases—no hydrogen is available for abstraction at this second carbon position (i.e. no hydrogens are found at this position, only non-hydrogen substituents). Non-limiting examples of 2,2-disubstituted C₃-C₂₀ alkyl include neopentyl (—CH₂—C(CH₃)₃, —CH₂—C(CH₃)₂—CH₂CH₃, CH₂—CF₂CH₃ and —CH₂C(═O)CH₃. In another embodiment, the alkyl is a 2,2-disubstituted C₃-C₈ alkyl. In another embodiment, the alkyl is a 2,2-disubstituted C₃-C₁₀ alkyl. In another embodiment, the alkyl is a 2,2-disubstituted C₃-C₁₂ alkyl. In another embodiment, the alkyl is a 2,2-disubstituted C₃-C₁₈ alkyl. The terms “2,2-disubstituted C₃-C₈ alkyl”, “2,2-disubstituted C₃-C₁₀ alkyl”, “2,2-disubstituted C₃-C₁₂ alkyl” and “2,2-disubstituted C₃-C₁₈ alkyl” refer to similar moiety as “2,2-disubstituted C₃-C₂₀ alkyl” but with C₃-C₈, C₃-C₁₀, C₃-C₁₂ and C₃-C₁₈ alkyl, respectively. In another embodiment, alkylene is a 2,2-disubstituted C₂-C₂₀ alkylene. The term “2,2-disubstituted C₂-C₂₀ alkylene” refers to similar moiety as “2,2-disubstituted C₃-C₂₀ alkyl” but with alkylene as described herein which has between 2 and 20 carbons. Non-limiting examples of 2,2-disubstituted C₂-C₂₀ alkylene include neopentylene (—CH₂—C(CH₃)₂—CH₂—, —CH₂—C(CH₃)₂—CH₂CH₂—, —CH₂—CF₂CH₂— and —CH₂C(═O)CH₂—. In another embodiment, the alkylene is a 2,2-disubstituted C₂-C₈ alkylene. In another embodiment, the alkylene is a 2,2-disubstituted C₂-C₁₀ alkylene. In another embodiment, the alkylene is a 2,2-disubstituted C₂-C₁₂ alkylene. In another embodiment, the alkylene is a 2,2-disubstituted C₂-C₁₈ alkylene. The terms “2,2-disubstituted C₂-C₈ alkylene”, “2,2-disubstituted C₂-C₁₀ alkylene”, “2,2-disubstituted C₂-C₁₂ alkylene” and “2,2-disubstituted C₂-C₁₈ alkylene” refer to similar moiety as “2,2-disubstituted C₂-C₂₀ alkylene” but with C₂-C₈, C₂-C₁₀, C₂-C₁₂ and C₂-C₁₈ alkylene, respectively.

In another embodiment, the alkyl is a 2,2,2-trisubstituted ethyl. The term “2,2,2-trisubstituted ethyl” refers to ethyl substituted thrice at the second carbon (from the connection point) with halogen, haloalkyl, alkoxy, carbonyl, amido, alkylamido, dialkylamido, cyano, nitro, CO₂H, amino, alkylamino, dialkylamino, carboxyl, thio and/or thioalkyl, where such substitutions can be the same or different; or alternatively it is substituted once at the second carbon with oxo (═O) or with other double bond to an element (e.g. S) or a moiety (e.g. vinylic carbon or NH) and it's further substituted with a substituent selected from the above list of the first possibility; in all cases—no hydrogen is available for abstraction at this second carbon position (i.e. no hydrogens are found at this position, only non-hydrogen substituents). Non-limiting examples of 2,2,2-trisubstituted ethyl include 2,2,2 trihaloethyl and —CH₂C(═O)—NH₂. In another embodiment hydrophobic alkyl refers to an alkyl having at least four carbons. In another embodiment hydrophobic alkyl refers to a C₄-C₂₄ alkyl. In another embodiment hydrophobic alkyl refers to a C₄-C₈ alkyl. In another embodiment hydrophobic alkyl refers to a C₄ alkyl. In another embodiment hydrophobic alkyl refers to a C₅ alkyl. In another embodiment hydrophobic alkyl refers to a C₆ alkyl. In another embodiment hydrophobic alkyl refers to a C₇ alkyl. In another embodiment hydrophobic alkyl refers to a C₈ alkyl.

As used herein, the term “aryl” refers to any aromatic ring that is directly bonded to another group and can be either substituted or unsubstituted. As used herein, the term “Arylene” refers to the same where it is directly bonded to two groups (i.e. arylene is e.g. phenylene, —C₆H₄—). In another embodiment, it can be directly bonded to more than two groups. The aryl or arylene group can be a sole substituent, or it can be a component of a larger substituent, such as in an arylalkyl, arylamino, arylamido, etc. Exemplary aryl (and similarly, arylene) groups include, without limitation, phenyl, tolyl, xylyl, furanyl, naphthyl, pyridinyl, pyrimidinyl, pyridazinyl, pyrazinyl, triazinyl, thiazolyl, oxazolyl, isooxazolyl, pyrazolyl, imidazolyl, thiophene-yl, pyrrolyl, phenylmethyl, phenylethyl, phenylamino, phenylamido, etc. Substitutions include but are not limited to: F, Cl, Br, I, C₁-C₅ linear or branched alkyl, C₁-C₅ linear or branched haloalkyl, C₁-C₅ linear or branched alkyl or alkoxy, C₁-C₅ linear or branched haloalkyl or haloalkoxy, CF₃, CN, NO₂, —CH₂CN, NH₂, NH-alkyl, N(alkyl)₂, hydroxyl, —OC(O)CF₃, —OCH₂Ph, —NHCO-alkyl, COOH, —C(O)Ph, C(O)O-alkyl, C(O)H, or —C(O)NH₂. In another embodiment, hydrophobic aryl or arylene refers to aryl or arylene having at least six carbons.

As used herein, the term “benzyl” refers to the —CH₂—C₆H₅ moiety and can be unsubstituted or substituted with the following non-limiting list of substituents: F, Cl, Br, I, C₁-C₅ linear or branched alkyl, C₁-C₅ linear or branched haloalkyl, C₁-C₅ linear or branched alkyl or alkoxy, C₁-C₅ linear or branched haloalkyl or haloalkoxy, CF₃, CN, NO₂, —CH₂CN, NH₂, NH-alkyl, N(alkyl)z, hydroxyl, —OC(O)CF₃, —OCH₂Ph, —NHCO-alkyl, COOH, —C(O)Ph, C(O)O-alkyl, C(O)H, or —C(O)NH₂. Similarly, “benzylene” refers to the —CH₂—C₆H₄— moiety and can be unsubstituted or substituted with the substituents described above for the benzyl moiety.

As used herein, the term “haloalkyl” refers to alkyl as described hereinabove and substituted at least once by halide (i.e. F, Cl, Br or I). In one embodiment, all of the alkyl is substituted by halides, i.e. no hydrogens are found in the haloalkyl, and is termed “perhaloalkyl” (e.g. CF₃: perfluoromethyl or CCl₃: perchloromethyl). In one embodiment, only part of the alkyl is substituted by halides (e.g. CH₂CF₃). In another embodiment, non limiting examples of haloalkyls include: CF₃, CCl₃, CH₂CF₃, CF₂CF₃, CCl₂CCl₃ and Cl₃.

The term “alkenyl” or “alkenylene” refer to a substance that includes at least two carbon atoms and at least one double bond. The term “1-alkenyl” or “1-alkenylene” refers to the same, where the double bond is on the first carbon (from the connection point). The term “2-alkenyl” or “2-alkenylene” refers to the same, where the double bond is on the second carbon (from the connection point). The term “3-alkenyl” or “3-alkenylene” refers to the same, where the double bond is on the third carbon (from the connection point). In one embodiment, the alkenyl has 2-7 carbon atoms. In another embodiment, the alkenyl has 2-12 carbon atoms. In another embodiment, the alkenyl has 2-10 carbon atoms. In another embodiment, the alkenyl has 3-6 carbon atoms. In another embodiment, the alkenyl has 2-4 carbon atoms. In another embodiment, the alkenyl has 4-8 carbon atoms. In another embodiment hydrophobic alkenyl refers to alkenyl having at least four carbons. In another embodiment hydrophobic alkenyl refers to a C₄-C₈ alkenyl.

The term “alkynyl” or “alkynylene” refers to a substance that includes at least two carbon atoms and at least one triple bond. The term “1-alkynyl” or “1-alkynylene” refers to the same, where the triple bond is on the first carbon (from the connection point). The term “2-alkynyl” or “2-alkynylene” refers to the same, where the triple bond is on the second carbon (from the connection point). The term “3-alkynyl” or “3-alkynylene” refers to the same, where the triple bond is on the third carbon (from the connection point). In one embodiment, the alkynyl has 2-7 carbon atoms. In another embodiment, the alkynyl has 2-12 carbon atoms. In another embodiment, the alkynyl has 2-10 carbon atoms. In another embodiment, the alkynyl has 3-6 carbon atoms. In another embodiment, the alkynyl has 2-4 carbon atoms. In another embodiment, the alkynyl has 3-6 carbon atoms. In another embodiment, the alkynyl has 4-8 carbon atoms. In another embodiment hydrophobic alkynyl refers to alkynyl having at least four carbons. In another embodiment hydrophobic alkynyl refers to a C₄-C₈ alkenyl.

The term “alkoxy” refers in one embodiment to an alky as defined above bonded to an oxygen. Non limiting examples of alkoxy groups include: methoxy, ethoxy and isopropoxy.

A “cycloalkyl” group refers, in one embodiment, to a ring structure comprising carbon atoms as ring atoms, which may be either saturated or unsaturated, substituted or unsubstituted; and is directly bonded to one group (e.g. cyclohexyl-, C₆H₁₁—). In another embodiment the cycloalkyl is a 3-12 membered ring. In another embodiment the cycloalkyl is a 6 membered ring. In another embodiment the cycloalkyl is a 5-7 membered ring. In another embodiment the cycloalkyl is a 3-8 membered ring. In another embodiment, the cycloalkyl group may be unsubstituted or substituted by a halogen, alkyl, haloalkyl, hydroxyl, alkoxy, carbonyl, amido, alkylamido, dialkylamido, cyano, nitro, CO₂H, amino, alkylamino, dialkylamino, carboxyl, thio and/or thioalkyl. In another embodiment, the cycloalkyl ring may be fused to another saturated or unsaturated cycloalkyl or heterocyclic 3-8 membered ring. In another embodiment, the cycloalkyl ring is a saturated ring. In another embodiment, the cycloalkyl ring is an unsaturated ring. Non-limiting examples of a cycloalkyl group comprise cyclohexyl, cyclohexenyl, cyclopropyl, cyclopropenyl, cyclopentyl, cyclopentenyl, cyclobutyl, cyclobutenyl, cycloctyl, cycloctadienyl (COD), cycloctaene (COE) etc. In another embodiment hydrophobic cycloalkyl refers to a cycloalkyl having at least six carbons. A “cycloalkylene” group refers, in one embodiment, to the same definitions above of “cycloalkyl”, however the cycloalkylene is directly bonded to two groups (e.g. -cyclohexylene-, —C₆H₁₀—). In another embodiment, it is directly bonded to more than two groups.

A “heterocycle” group refers, in one embodiment, to a ring structure comprising in addition to carbon atoms, sulfur, oxygen, nitrogen or any combination thereof, as part of the ring. In another embodiment the heterocycle is a 3-12 membered ring. In another embodiment the heterocycle is a 6 membered ring. In another embodiment the heterocycle is a 5-7 membered ring. In another embodiment the heterocycle is a 3-8 membered ring. In another embodiment, the heterocycle group may be unsubstituted or substituted by a halogen, alkyl, haloalkyl, hydroxyl, alkoxy, carbonyl, amido, alkylamido, dialkylamido, cyano, nitro, CO₂H, amino, alkylamino, dialkylamino, carboxyl, thio and/or thioalkyl. In another embodiment, the heterocycle ring may be fused to another saturated or unsaturated cycloalkyl or heterocyclic 3-8 membered ring. In another embodiment, the heterocyclic ring is a saturated ring. In another embodiment, the heterocyclic ring is an unsaturated ring. Non limiting examples of a heterocyclic rings comprise pyridine, piperidine, morpholine, piperazine, thiophene, pyrrole, benzodioxole, or indole. In another embodiment hydrophobic heterocyclic group refers to a heterocycle having at least six carbons. In one embodiment, the heterocycle is directly bonded to one group (e.g. pyridinyl,

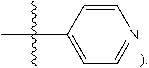 [SMILES: *c1ccncc1]

In one embodiment, the heterocycle is directly bonded to two groups (e.g. pyridinylene,

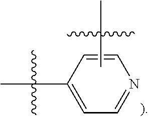

In one embodiment, the heterocycle is directly bonded to more than two groups.

In another embodiment, at least one of R₄, R₅ and R₆ and/or at least one of R₄′, R₅′ and R₆′ of structure (I) is/are hydrophobic.

The term “hydrophobic” refers to an alkyl, alkenyl or alkynyl having at least four carbons, or the term hydrophobic refers to terpenoid, to cycloalkyl, aryl or heterocycle having at least six carbons. Each possibility represents a separate embodiment of this invention.

In another embodiment, at least one of R₆, R₈-R₁₁ and X₅ and/or at least one of R₆′, R_{8′}- R_{11′} and X₆ of structure (I) is a terpenoid. Each possibility represents a separate embodiment of this invention.

In one embodiment, “p” defines the surface density of the anti-viral active units per 1 sq nm of the core surface. In another embodiment “p” is, between 0.01-30 anti-viral active units per 1 sq nm of the core surface. In another embodiment “p” is, between 0.01-20 anti-viral active units per 1 sq nm of the core surface. In another embodiment “p” is, between 0.01-10 anti-viral active units per 1 sq nm of the core surface. In another embodiment “p” is, between 0.01-15 anti-viral active units per 1 sq nm of the core surface. In another embodiment “p” is, between 0.01-5 anti-viral active units per 1 sq nm of the core surface. In another embodiment “p” is, between 0.1-30 anti-viral active units per 1 sq nm of the core surface. Each possibility represents a separate embodiment of this invention.

In one embodiment, n₁ is between 0-200. In another embodiment, n₁ is between 0-10. In another embodiment, n₁ is between 10-20. In another embodiment, n₁ is between 20-30. In another embodiment, n₁ is between 30-40. In another embodiment, n₁ is between 40-50. In another embodiment, n₁ is between 50-60. In another embodiment, n₁ is between 60-70. In another embodiment, n₁ is between 70-80. In another embodiment, n₁ is between 80-90. In another embodiment, n₁ is between 90-100. In another embodiment, n₁ is between 100-110. In another embodiment, n₁ is between 110-120. In another embodiment, n₁ is between 120-130. In another embodiment, n₁ is between 130-140. In another embodiment, n₁ is between 140-150. In another embodiment, n₁ is between 150-160. In another embodiment, n₁ is between 160-170. In another embodiment, n₁ is between 170-180. In another embodiment, n₁ is between 180-190. In another embodiment, n₁ is between 190-200. Each possibility represents a separate embodiment of this invention.

In one embodiment, n₂ is between 0-200. In another embodiment, n₂ is between 0-10. In another embodiment, n₂ is between 10-20. In another embodiment, n₂ is between 20-30. In another embodiment, n₂ is between 30-40. In another embodiment, n₂ is between 40-50. In another embodiment, n₂ is between 50-60. In another embodiment, n₂ is between 60-70. In another embodiment, n₂ is between 70-80. In another embodiment, n₂ is between 80-90. In another embodiment, n₂ is between 90-100. In another embodiment, n₂ is between 100-110. In another embodiment, n₂ is between 110-120. In another embodiment, n₂ is between 120-130. In another embodiment, n₂ is between 130-140. In another embodiment, n₂ is between 140-150. In another embodiment, n₂ is between 150-160. In another embodiment, n₂ is between 160-170. In another embodiment, n₂ is between 170-180. In another embodiment, n₂ is between 180-190. In another embodiment, n₂ is between 190-200. Each possibility represents a separate embodiment of this invention.

In one embodiment, n₃ and n₄ of structure (II) are each independently 0 or 1. Each possibility represents a separate embodiment of this invention.

In one embodiment, m is between 1-200. In another embodiment, m is between 1-10. In another embodiment, m is between 10-20. In another embodiment, m is between 20-30. In another embodiment, m is between 30-40. In another embodiment, m is between 40-50. In another embodiment, m is between 50-60. In another embodiment, m is between 60-70. In another embodiment, m is between 70-80. In another embodiment, m is between 80-90. In another embodiment, m is between 90-100. In another embodiment, m is between 100-110. In another embodiment, m is between 110-120. In another embodiment, m is between 120-130. In another embodiment, m is between 130-140. In another embodiment, m is between 140-150. In another embodiment, m is between 150-160. In another embodiment, m is between 160-170. In another embodiment, m is between 170-180. In another embodiment, m is between 180-190. In another embodiment, m is between 190-200. Each possibility represents a separate embodiment of this invention.

In another embodiment, the anti-viral active group of this invention may be selected from: (a) a quaternary ammonium group comprising at least one terpenoid moiety or one hydrophobic group; and (b) a pyridinium group. Each possibility represents a separate embodiment of this invention.

In one embodiment, the particles of this invention represented by structures (I)-(VII) comprise an anti-viral active unit and an inert core, wherein the anti-viral active unit and the core are linked directly or indirectly.

In some embodiments L₄, L₅ or L₆ is each independently the same or a different linker. In some embodiments, L₄, L₅ and L₆ are connected to each other, in any possible way. In some embodiment, L₆ is nothing and L₄ or L₅ is connected to the core covalently. In another embodiment, L₆ is connected to the core covalently and L₄ or L₅ is connected to L₆. In another embodiment, L₄ is connected to X₃, L₅ and L₆ or core. In another embodiment, a “linker” comprises any possible chemical moiety capable of connecting at least two other chemical moieties which are adjacent to such linker. In another embodiment, the monomeric unit of the anti-viral active unit comprises a first and/or second linker/s (L₄ or L₅) and an anti-viral group. In another embodiment, L₄ and/or L₅ are/is the backbone (they are e.g. alkylene, polypeptide or oligosiloxane (—Si(OH)₂—O— or —Si(CH₃)₂—O—) moieties) of the anti-viral active unit. In some embodiments, the linker comprises a functional group. In another embodiment, the linker comprises two (same or different) functional groups. In another embodiment, the functional group comprises phosphate, phosphonate, siloxane, silane, ether, acetal, hydroxyl, amide, amine, anhydride, ester, ketone, or aromatic ring or rings functionalized with any of the preceding moieties. Each possibility represents a separate embodiment of this invention.

In another embodiment, L₄, L₅, L₆, X₃, X₄, X₅, X₆ or any combination thereof is a C1 to C18 alkylene, alkenylene, alkynylene or aryl substituted with at least one carboxyl moiety, wherein the carboxyl end is attached to the core. It may be derived from a C1 to C18 alkylene substituted with at least one carboxyl moiety and having an amino end which is modified to anti-viral active group [—⁺N(R₄)(R₅)(R₆), —⁺N(R₄′)(R₅′)(R₆′),

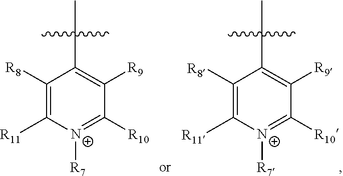

defined in structures (I) and (IE)]. This linker may be derived from an amino acid of natural or synthetic source having a chain length of between 2 and 18 carbon atoms (polypeptide), or an acyl halide of said amino acid. Non-limiting examples for such amino acids are 18-amino octadecanoic acid and 18-amino stearic acid. In another embodiment, L₄, L₅, L₆, X₃, X₄, X₅, X₆ or any combination thereof is a C1 to C18 alkylene substituted with at least one amine, amide or pyridinium

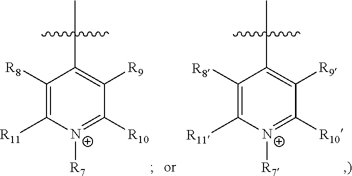

R₇; or R₇′, moiety.

In another embodiment, L₄, L₅, L₆, X₃, X₄, X₅, X₆ or any combination thereof is a C1 to C18 alkylene, alkenylene, alkynylene, arylene or aryl. This linker may be derived from a di-halo alkylene or di-haloarylene, which is functionalized at each end with the core and anti-viral active group, respectively, by replacement of the halogen moiety to a functional group that binds to the core and replacement of the halogen moiety to obtain —⁺N(R₄)(R₅)(R₆) or —⁺N(R₄′)(R₅′)(R₆′), which are defined in structures (I) to (II).

In another embodiment, L₄, L₅, L₆, X₃, X₄, X₅, X₆ or any combination thereof is an aromatic group derived from non-limiting examples of 4,4-biphenol, dibenzoic acid, dibenzoic halides, dibenzoic sulphonates, terephthalic acid, tetrphthalic halides, and terephthalic sulphonates. This linker is functionalized with the core and anti-viral active group, respectively, through the functional group thereof (i.e., hydroxyl, carboxy or sulfonate). In another embodiment, this linker is directly attached to the core at one end or indirectly, via a third linker (L₆) and is modified at the other end to anti-viral active group [—⁺N(R₄)(R₅)(R₆), —⁺N(R₄′)(R₅′)(R₆′),

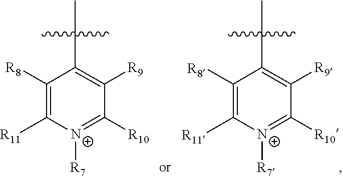

defined in structures (I) and (IE)].

In another embodiment, L₄, L₅, L₆, X₃, X₄, X₅, X₆ or any combination thereof, is a siloxane or silane group derived and/or selected from non-limiting examples of trialkoxyalkylsilane, trialkoxyarylsilane, trihaloalkylsilane, trihaloarylsilane, 3-aminopropyltriethoxysilane (APTES), (3-glycidyloxypropyl)trimethoxysilane and N-2-aminoethyl-3-aminopropyl trimethoxysilane. This linker is functionalized with the core and anti-viral active group, respectively, through the functional group thereof (i.e., hydroxyl, siloxane, carboxy, amide or sulfonate). In another embodiment, this linker is directly attached to the core at one end directly or indirectly, via a third linker (L₆) and is modified at the other end to anti-viral active group [—⁺N(R₄)(R₅)(R₆), [—⁺N(R₄′)(R₅′)(R₆′),

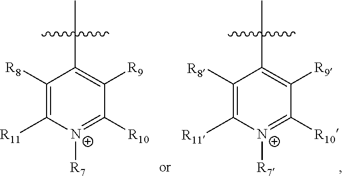

defined in structures (I) and (IE)].

This linker is functionalized with the core and anti-viral active group, respectively, through the functional group thereof (i.e., hydroxyl, siloxane, carboxy, amide or sulfonate). In another embodiment, this linker is directly attached to the core at one end or indirectly, via a third linker (L₆) and is modified at the other end to anti-viral active —⁺N(R₄)(R₅)(R₆), —[—⁺N(R₄′)(R₅′)(R₆′),

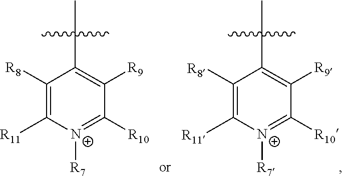

defined in structures (I) and (IE)].

In another embodiment, a monomeric unit (as described in e.g. FIGS. 1B-1C and formulas IE and I-VII) within the anti-viral active unit of this invention is represented by the structure of formula IF1 or IF2:

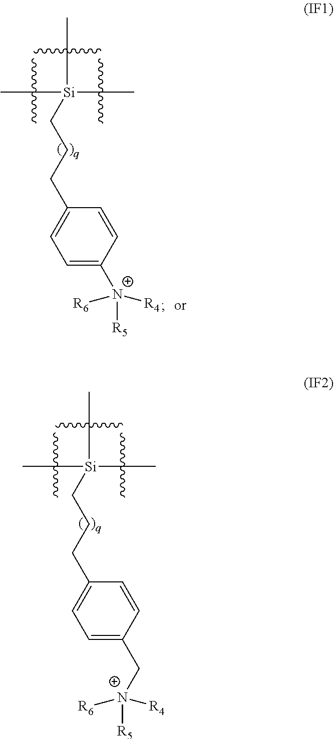

wherein
R₄ and R₅ are independently methyl, CF₃, perhaloalkyl, aryl, benzyl, 2,2-disubstituted C₃-C₂₀ alkyl, 2,2,2-trisubstituted ethyl, —CH₂C(═)OR, —CH₂C(═O)OC(═O)R, —CH₂C(═S)OR, —CH₂C(═O)SR, —C(═O)OR, —C(═O)OC(═O)R, —C(═S)OR, —C(═O)SR, —C(═O)—R, —C(═S)—R, —CH₂C(═O)R, —CH₂C(═S)R, —CH₂CF₃, —CH₂NO₂, 1-alkenyl, 1-alkynyl, 2-alkenyl, 2-alkynyl or any combination thereof;
R₆ is methyl, CF₃, perhaloalkyl, 2,2-disubstituted C₃-C₂₀ alkyl, 2,2,2-trisubstituted ethyl, —CH₂C(═O)OR, —CH₂C(═O)OC(═O)R, —CH₂C(═S)OR, —CH₂C(═O)SR, —C(═O)OR, —C(═O)OC(═O)R, —C(═S)OR, —C(═O)SR, —C(═O)—R, —C(═S)—R, —CH₂C(═O)R, —CH₂C(═S)R, —CH₂CF₃, —CH₂NO₂, terpenoid moiety, cycloalkyl, aryl, phenyl, benzyl, heterocycle, a conjugated alkyl, 1-alkenyl, 1-alkynyl, 2-alkenyl, 2-alkynyl or any combination thereof;
R is alkyl, aryl, cycloalkyl, heterocycle or any combination thereof;
q is an integer between 0 and 16; and
wherein said monomeric unit is chemically bound to the surface of an inorganic core directly or via a third linker (L6).

In another embodiment, a monomeric unit (as described in e.g. FIGS. 1B-1C and formulas IE and I-VII) within the anti-viral active unit of this invention is represented by the structure of formula IG1 or IG2:

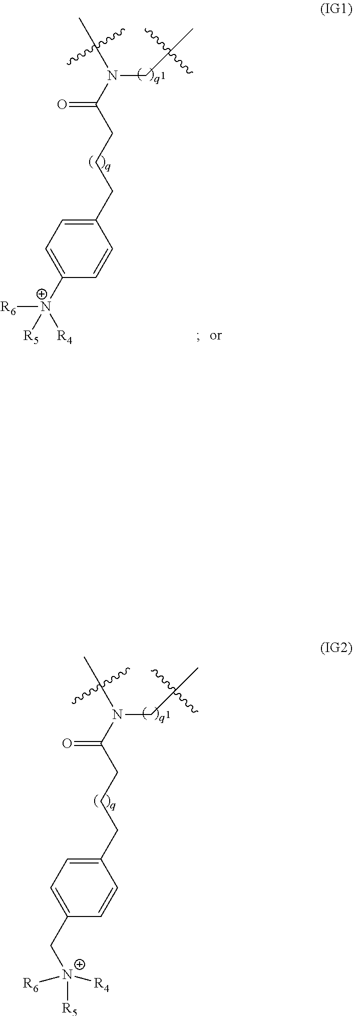

wherein
R₄-R₆ are as described hereinabove;
q and q¹ are independently an integer between 0 and 16; and
wherein said monomeric unit is chemically bound to the surface of an inorganic core directly or via a third linker (L6).

In another embodiment, a linker molecule which may be used in the processes of preparing the anti-viral particles of this invention is represented by the structure of formula IH1 or IH2:

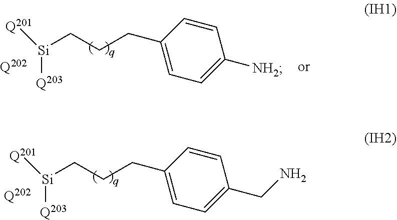

wherein
Q²⁰¹, Q²⁰² and Q²⁰³ are independently selected from the group consisting of alkoxy, methyl, ethyl, hydrogen, sulfonate and halide, wherein at least one of Q²⁰¹, Q²⁰² and Q²⁰³ is selected from ethoxy, methoxy, sulfonate (e.g., mesyl, tosyl) and halide;
q is an integer between 0 and 16;
the linker molecule is capable of being chemically bound to the surface of the inorganic core through the silicon atom; and
the anti-viral active group is introduced by functionalizing the primary amine to obtain an anti-viral active quaternary ammonium group as described above.

In another embodiment, a linker molecule which may be used in the processes of preparing the anti-viral particles of this invention is represented by the structure of formula IJ:

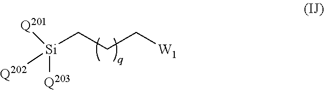

wherein
Q²⁰¹, Q²⁰² and Q²⁰³ are independently selected from the group consisting of alkoxy, methyl, ethyl, hydrogen, sulfonate and halide, wherein at least one of Q²⁰¹, Q²⁰² and Q²⁰³ is selected from ethoxy, methoxy, sulfonate (e.g., mesyl, tosyl) and halide;
W₁ is selected from the group consisting of arylene-NH₂, benzylene-NH₂, halide, sulfonate and hydroxyl;
q is an integer between 0 and 16;
said linker is capable of being chemically bound to the surface of said inorganic core through the silicon atom; and
the anti-viral active group is introduced by substituting the group W with an anti-viral active group, or converting the group W to an anti-viral active group.

The particles of this invention demonstrate an enhanced anti-viral activity. Without being bound by any theory or mechanism, it can be postulated that such activity originates from the presence of closely packed anti-viral groups on a given core's surface, as well as high density of particles packed on the surface of a host material. This density increases as each anti-viral active unit in the particles of this invention comprise increasing number of anti-viral active groups and it yields a high local concentration of active functional groups, which results in high effective concentration of the anti-viral active groups and enables the use of a relatively small amount of particles to achieve effective viral annihilation. The close packing of the anti-viral groups is due to, inter alia, numerous anti-viral active units protruding from each particle surface. Accordingly, the anti-viral groups cover large fraction of the particle's available surface area (width dimension covering the surface). The surface density of the anti-viral group results in high effective concentration promoting anti-viral inhibitory effect. According to the principles of this invention, high surface density dictates high anti-viral efficiency.

The term “nanoparticle” as used herein refers to a particle having a diameter of less than about 1,000 nm. The term “microparticle” as used herein refers to a particle having a diameter of about 1,000 nm or larger.

The anti-viral particles of this invention are characterized by having a diameter between about 5 to about 100,000 nm, and thus encompass both nanoparticulate and microparticulate compositions. Preferred are particles between about 10 to about 50,000 nm. In other embodiments, the particles are more than 1,000 nm in diameter. In other embodiments, the particles are more than 10,000 nm in diameter. In other embodiment, the particles are between 1,000 and 50,000 nm in diameter. In other embodiment, the particles are between 5 and 250 nm in diameter. In other embodiment, the particles are between 5 and 500 nm in diameter. In another embodiment, the particles are between 5 and 1000 nm in diameter. It is apparent to a person of skill in the art that other particles size ranges are applicable and are encompassed within the scope of this invention.

### Anti-Viral Active Groups Comprising Terpenoid Groups

In one embodiment, the anti-viral active group of this invention contains at least one terpenoid group. In another embodiment, the anti-viral active group is selected from: (a) a tertiary amine (R₃ and/or R₃′ is nothing) or tertiary ammonium (R₃ and/or R₃′ is H) comprising at least one terpenoid moiety; and (b) a quaternary ammonium group comprising at least one terpenoid moiety. In another embodiment, when the anti-viral active group of this invention contains at least one terpenoid group and/or R₁, R₂, R₃ and/or R₁′, R₂′, R₃′ of the anti-viral active groups as defined hereinabove are terpenoid moieties—the core of the particles of this invention is a polyhedral oligomeric silsesquioxane (POSS).

In some embodiments, the anti-viral active group of formula (1) to (6) is selected from: (a) a tertiary amine (R₃ and/or R₃′ is nothing) or tertiary ammonium (R₃ and/or R₃′ is H), wherein the nitrogen atom of each tertiary amine/ammonium having at least one bond to X₁ or X₂ and one bond to a terpenoid moiety; (b) a tertiary amine (R₃ and/or R₃′ is nothing), or tertiary ammonium (R₃ and/or R₃′ is H), the nitrogen atom of each tertiary amine/ammonium having one bond to X₁ or X₂ and two bonds to terpenoid moieties which may be the same or different from each other, or a salt of said tertiary amine; (c) a quaternary ammonium group the nitrogen atom of each quaternary ammonium group having at least one bond to X₁ or X₂ and one or two bonds to terpenoid moieties which may be the same or different from each other; Each possibility represents a separate embodiment of this invention.

In one embodiment, R₆, R₈-R₁₁, R₆′ and/or R_{8′}-R_{11′} of the anti-viral active groups [—⁺N(R₄(R₅)(R₆), —⁺N(R₄′)(R₅′)(R₆′),

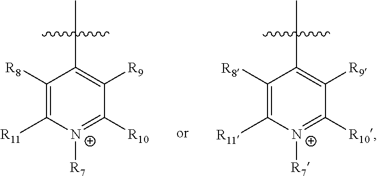

defined in structures (I) and (IE)] are the terpenoid moieties.

In another embodiment, when the anti-viral active group of this invention contains at least one terpenoid group and/or R₆, R₈-R₁₁, R₆′ and/or R₈′-R₁₁′ of the anti-viral active groups as defined hereinabove are terpenoid moieties—the core of the particles of this invention is a polyhedral oligomeric silsesquioxane (POSS).

The term “terpenoid”, also known as “isoprenoid” refers to a large class of naturally occurring compounds that are derived from five-carbon isoprene units. A “terpenoid moiety” is derived from a terpenoid.

In some embodiments, the terpenoid moiety is a “terpenoidyl”, i.e. directly bonded to one group (e.g. cinnamyl:

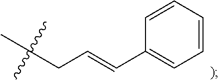 [SMILES: *C/C=C/c1ccccc1]

or a “terpenoidylene”, i.e. directly bonded to two groups (e.g. cinnamylene, e.g.

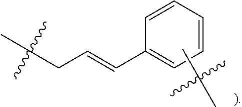

In one embodiment, the terpenoid moiety is directly bonded to more than two groups. In one embodiment, the terpenoid moiety is a cinammyl or cinnamylene group derived from cinnamaldehyde, cinnamic acid, curcumin, viscidone or cinnamyl alcohol. In another embodiment, the terpenoid moiety is a bornyl or a bornylene group derived from camphor, bornyl halide or bornyl alcohol. In another embodiment, the terpenoid moiety is derived from citral. In another embodiment, the terpenoid moiety is derived from perilaldehyde. Each possibility represents a separate embodiment of this invention.

Cinnamaldehyde is a natural aldehyde extracted from the genus Cinnamomum. It is known for its low toxicity and its effectiveness against various virus, bacteria and fungi.

Camphor is found in the wood of the camphor laurel (Cinnamomum camphora), and also of the kapur tree. It also occurs in some other related trees in the laurel family, for example Ocotea usambarensis, as well as other natural sources. Camphor can also be synthetically produced from oil of turpentine. Camphor can be found as an R or S enantiomer, a mixture of enantiomers and a racemic mixture. Each possibility represents a separate embodiment of this invention.

Citral, or 3,7-dimethyl-2,6-octadienal or lemonal, is a mixture of two diastereomeric terpenoids. The two compounds are double bond isomers. The E-isomer is known as geranial or citral A. The Z-isomer is known as neral or citral B. Citral is known to have anti-viral activity.

Perillaldehyde, also known as perilla aldehyde, is a natural terpenoid found most in the annual herb perilla, as well as in a wide variety of other plants and essential oils.

Other examples of terpenoids include, but are not limited to: curcuminoids found in turmeric and mustard seed, citronellal found in Cymbopogon (lemon grass) and carvacrol, found in Origanum vulgare (oregano), thyme, pepperwort, wild bergamot and Lippia graveolens. Each possibility represents a separate embodiment of this invention.

In accordance with the above embodiment, the anti-viral active terpenoid moieties are selected from the group consisting of:

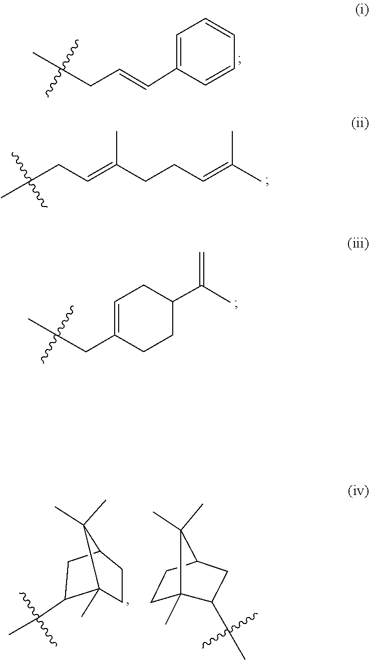

or any combination thereof;

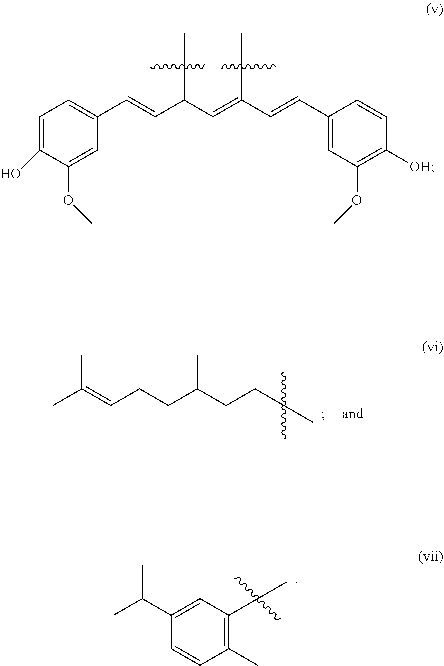 [SMILES: *C(/C=C/c1ccc(O)c(OC)c1)=C\C(*)/C=C/c1ccc(O)c(OC)c1 ; *CCC(C)CCC=C(C)C ; *c1cc(C(C)C)ccc1C]

Each possibility represents a separate embodiment of this invention.

Non-limiting examples of anti-viral active quaternary ammonium groups in accordance with the principles of this invention are:

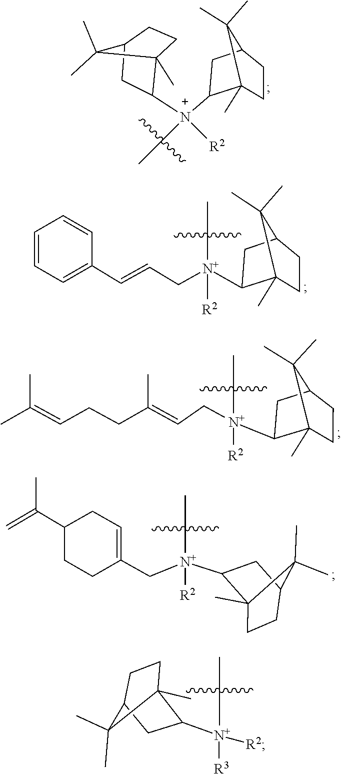

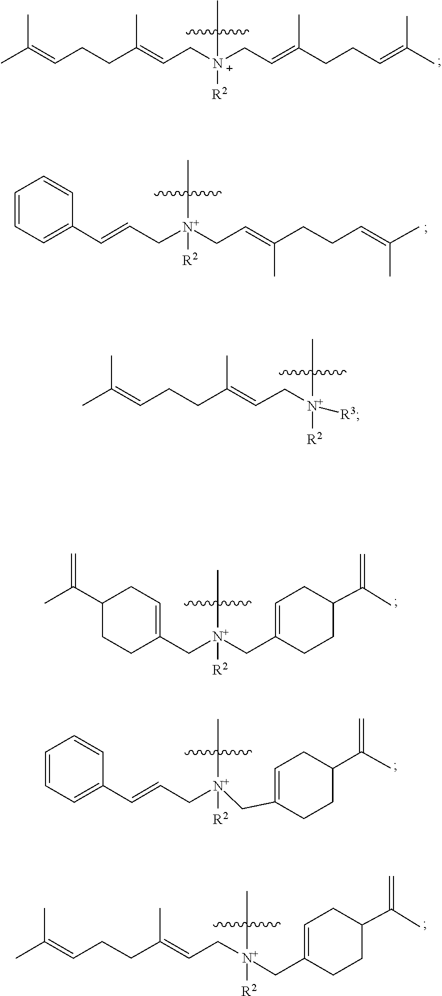

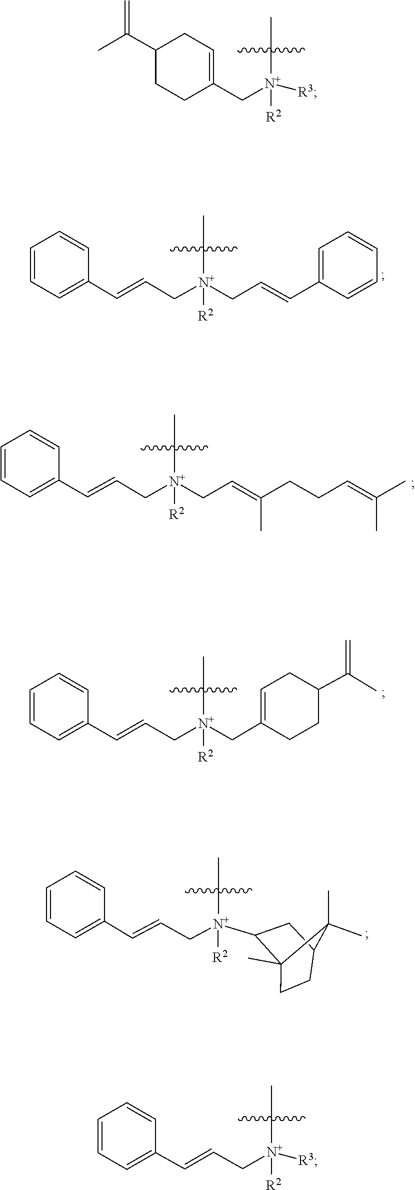

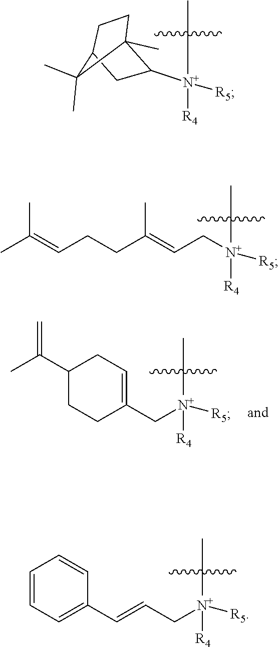

wherein
R² is alkyl, terpenoid, cycloalkyl, aryl, heterocycle, alkenyl, alkynyl or any combination thereof;
R³ is alkyl, terpenoid moiety, cycloalkyl, aryl, heterocycle, alkenyl, alkynyl or any combination thereof;
R₄ and R₅ are independently methyl, CF₃, perhaloalkyl, aryl, benzyl, 2,2-disubstituted C₃-C₂₀ alkyl, 2,2,2-trisubstituted ethyl, —CH₂C(═O)OR, —CH₂C(═O)OC(═O)R, —CH₂C(═S)OR, —CH₂C(═O)SR, —C(═O)OR, —C(═O)OC(═O)R, —C(═S)OR, —C(═O)SR, —C(═O)—R, —C(═S)—R, —CH₂C(═O)R, —CH₂C(═S)R, —CH₂CF₃, —CH₂NO₂, 1-alkenyl, 1-alkynyl, 2-alkenyl, 2-alkynyl or any combination thereof; and
R is alkyl, aryl, cycloalkyl, heterocycle or any combination thereof.

Non-limiting examples of functional anti-viral active tertiary amine groups or its protonated form in accordance with the principles of this invention are:

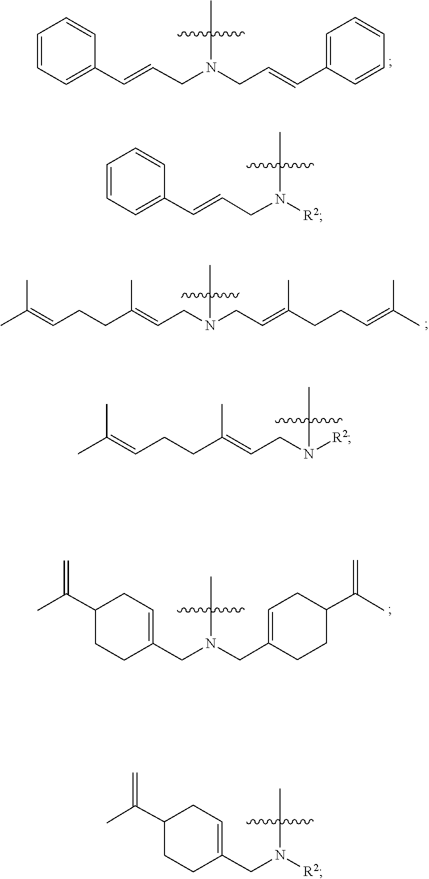

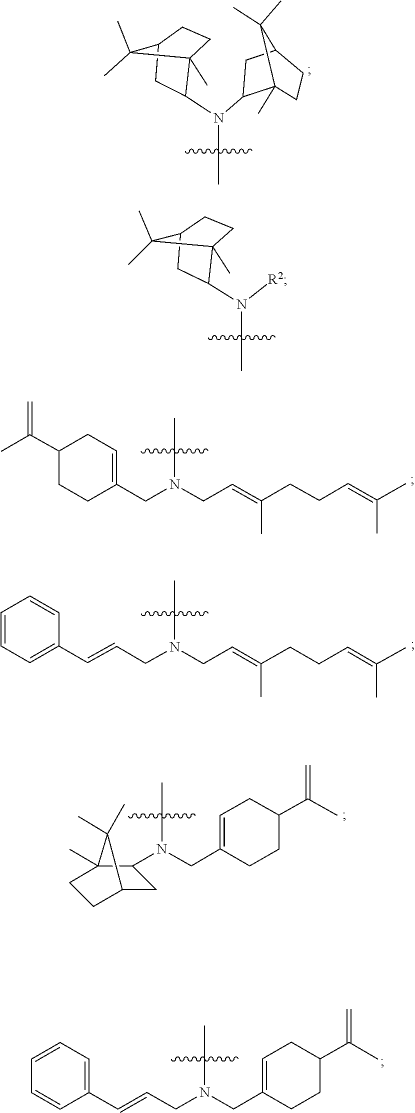

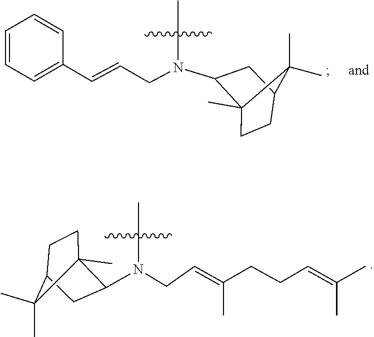

wherein R² is alkyl, terpenoid, cycloalkyl, aryl, heterocycle, alkenyl, alkynyl or any combination thereof.

The anti-viral active group of this invention may be in the form of a quaternary ammonium or pyridinium salt, as described hereinabove. Since an such groups are positively charged, their charge is balanced with an anion. Non-limiting examples of anions include: a halide, e.g. fluoride, chloride, bromide or iodide and fluoride, bicarbonate, nitrate, phosphate, acetate, fumarate, succinate, mesylate, triflate, tosylate, tetrafluoroborate, hexafluorophosphate and sulfate. Each possibility represents a separate embodiment of this invention.

### Anti-Viral Active Groups Comprising One Long Alkyl Group.

In one embodiment, the anti-viral active group of this invention contains one alkyl group which have from 4 to 24 carbon atoms as R₈-R₁₁ and/or R_{8′}-R_{11′} of the anti-viral active groups

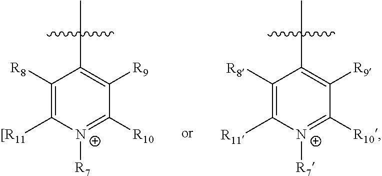

defined in structures (I) and (IE)].

The term “quaternary ammonium group” refers to a group of atoms consisting of a nitrogen atom with four substituents (different than hydrogen) attached thereto. In another embodiment, a “quaternary ammonium group” refers to a group of atoms consisting of a nitrogen atom with four groups wherein each of the group is attached to the nitrogen through a carbon atom. The term “long alkyl group” or chain refers to such an alkyl group or chain which is substituted on the nitrogen atom of the quaternary ammonium group or found as substituent to the pyridinium and which has between 4 and 24 carbon atoms. In some currently preferred embodiments, the alkyl group is an alkyl group having 4 to 18 carbon atoms. In some currently preferred embodiments, the alkyl group is an alkyl group having 4 to 8 carbon atoms. In some currently preferred embodiments, the alkyl group is an alkyl group having 4 to 10 carbon atoms. In other currently preferred embodiments, the alkyl group is an alkyl group having 6, 7, or 8 carbon atoms, with each possibility representing a separate embodiment of this invention.

### Organic Polymeric Cores

In some embodiments, the core of the anti-viral particles is an organic polymeric core. In one embodiment, the organic core comprises at least one aliphatic polymer. An “aliphatic polymer” as used within the scope of this invention refers to a polymer made of aliphatic monomers that may be substituted with various side groups, including (but not restricted to) aromatic side groups. Aliphatic polymers that may be included in particles according to this invention comprise nitrogen atoms (as well as other heteroatoms) as part of the polymeric backbone. In one embodiment, the core of the particles is an organic polymeric core including an amine which can be substituted with R₁, R₂ and/or R₃ as defined for structure 1; or including an imine which is chemically modified to amine and then substituted with R₁, R₂ and/or R₃ as defined for structure 1. In one embodiment, the core of the particles is an organic polymeric core including amines which can be substituted with R₄, R₅, R₆, R₄, R₅ and/or R₆ as defined for structure I; or including an imine which is chemically modified to amine and then substituted with R₄, R₅, R₆, R₄, R₅ and/or R₆ as defined for structure I. Non-limiting examples of aliphatic polymers are polystyrene (PS), polyvinylchloride (PVC), polyethylene imine (PEI), polyvinyl amine (PVA), poly(allyl amine) (PAA), poly(aminoethyl acrylate), polypeptides with pending alkyl-amino groups, and chitosan. Each possibility represents a separate embodiment of this invention. In one currently preferred embodiment, the polymer is polyethylene imine (PEI).

In another embodiment, the organic core comprises at least one aromatic polymer selected from the following group: polystyrene, aminomethylated styrene polymers, aromatic polyesters, preferably polyethylene terephthalate, and polyvinyl pyridine.

In another embodiment, the polymeric core may be linked to anti-viral active part directly (i.e. in structures (1)-(3): L₃ is a bond) or via a linker. In another embodiment, the polymeric core may be linked to anti-viral active part directly (i.e. in structures (I), (IE) and (II)-(VII): IA is a bond) or via a linker. Each possibility represents a separate embodiment of this invention.

In one embodiment, the organic polymeric core includes a combination of two or more different organic polymers. In another embodiment, the organic polymeric core includes a copolymer.

In some embodiments, anti-viral active unit is linked to the organic polymeric core directly (L₃ or L₆ is a bond) or via a linker (L₃ or L₆). In these embodiments, the linker may be selected from:

(a) a C1 to C18 alkylene substituted with at least one carboxyl moiety. This linker may be derived from an alkylene substituted with at least one carboxyl moiety and at least one amino moiety, wherein the carboxyl end is attached to the core and the amino end is modified to anti-viral active group [—⁺N(R₁)(R₂)(R₃), —⁺NH(R₁)(R₂), —N(R₁)(R₂)—⁺N(R₁′)(R₂′)(R₃′), —⁺NH(R₁′)(R₂′) or —N(R₁′)(R₂′) (defined in structures (1) to (6); or —⁺N(R₄)(R₅)(R₆), —⁺N(R₄′)(R₅′)(R₆′),

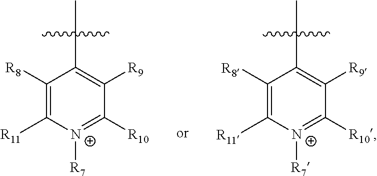

defined in structures (I) and (IE)]. This linker may be derived from an amino acid of natural or synthetic source having a chain length of between 2 and 18 carbon atoms, or an acyl halide of said amino acid. Non-limiting examples for such amino acids are 18-amino octadecanoic acid and 18-amino stearic acid;
(b) a C1 to C18 alkylene. This linker may be derived from a di-halo alkylene, which is functionalized at each end with the core and anti-viral active group, respectively, by replacement of the halogen moiety to a functional group that will bind to the core and replacement of the halogen moiety to obtain [—⁺N(R₁)(R₂)(R₃), —⁺NH(R₁)(R₂), —N(R₁)(R₂)—⁺N(R₁′)(R₂′)(R₃′), —⁺NH(R₁′)(R₂′) or —N(R₁′)(R₂′) (defined in structures (1) to (6); or —⁺N(R₄)(R₅)(R₆) or —⁺N(R₄′)(R₅′)(R₆′), defined in structures (I) and (IE)]; and
(c) aromatic molecules derived from 4,4-biphenol, dibenzoic acid, dibenzoic halides, dibenzoic sulphonates, terephthalic acid, tetrphthalic halides, and terephthalic sulphonates. This linker is functionalized with the core and anti-viral active group, respectively, through the functional group thereof (i.e., hydroxyl, carboxy or sulfonate). In another embodiment, this linker is attached to the core at one end and is modified at the other end to anti-viral active group [—⁺N(R₁)(R₂)(R₃), —⁺NH(R₁)(R₂), —N(R₁)(R₂)—⁺N(R₁′)(R₂′)(R₃′), —⁺NH(R₁′)(R₂′) or —N(R₁′)(R₂′) (defined in structures (1) to (6); or —⁺N(R₄)(R₅)(R₆), —⁺N(R₄′)(R₅′)(R₆′),

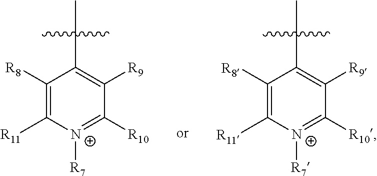

defined in structures (I) and (IE)]. In another embodiment, the linker comprises alkyl, alkenyl, alkyl phosphate, alkyl siloxanes, carboxylate, epoxy, acylhalides and anhydrides, or combination thereof, wherein the functional group is attached to the core. Each possibility represents a separate embodiment of this invention.

Various polymeric chains may provide a range of properties that themselves may be an accumulation of the various polymer properties, and may even provide unexpected synergistic properties. Examples of such mixed polyamine particles include: crosslinking of aliphatic and aromatic polyamines such as polyethyleneimine and poly(4-vinyl pyridine) via a dihaloalkane; mixture of linear short chain and branched high molecular weight polyethyleneimines; interpenetrating compositions of polyamine within a polyamine scaffold such as polyethyleneimine embedded within crosslinked polyvinyl pyridine particles, or even interpenetrating a polyamine into a low density non-amine scaffold such as polystyrene particles. In other words, the use of polyamine combinations for the purpose of forming particles, either by chemical crosslinking or physical crosslinking (interpenetrating networks) may afford structures of varying properties. Such properties may be additive or synergistic in nature.

In one specific embodiment, the organic polymeric core is cross-linked with a cross-linking agent. The preferred degree of cross-linking is from 1% to 20%, when crosslinking of from about 2% to about 5% is preferable. The crosslinking may prevent unfolding of the polymer and separation of the various polymeric chains that form the particle.

Crosslinking, as may be known to a person skilled in the art of organic synthesis and polymer science, may be affected by various agents and reactions that are per se known in the art. For example, crosslinking may be affected by alkylating the polymer chains with dihaloalkane such as dibromoethane, dibromocyclohexane, or bis-bromomethylbenzene. Alternatively, crosslinking by reductive amination may be used. In this method a polyamine with primary amines is reacted with a diketone or with an alkane dialdehyde to form an imine crosslinker which is then further hydrogenated to the corresponding amine. This amine is further reacted to form an antimicrobial effective quaternary ammonium group. In such a method, instead of dihaloalkanes or dialdehydes, tri or polyhaloalkanes or polyaldehydes or polyketones are used.

The preferred polymers useful for making the polymeric core according to this invention are those having chains made of 30 monomer units, preferably 100 monomer units that may be crosslinked using less than 10% of crosslinking agent. The longer the polymers are, the fewer crosslinking bonds are needed to afford an insoluble core. Branched polymers are preferred for crosslinking as small amount of crosslinking is required to form insoluble core.

In some embodiments, at least about 10% of the amine groups in the organic polymeric core are the anti-viral active tertiary amine/ammonium or quaternary ammonium groups or salts thereof, as described herein.

In one embodiment, the anti-viral particles according to this invention have functional groups that are capable of reacting with a host polymer or with monomers thereof. Such functional groups are designed to allow the particles to be bound chemically to a hosting material.

### Inorganic Cores

In some embodiments, the core of the anti-viral particles of this invention is an inorganic core comprising one or more inorganic materials. Inorganic cores have a few advantages over organic polymeric cores: 1) higher stability at elevated temperature; 2) higher chemical stability towards various solvent and reagents; 3) improved mechanical strength; 4) better handling qualities in composites due to their amphipathic nature; and 5) lower cost.

An additional advantage of inorganic cores relates to the insertion of the functionalized particles into a polymeric material within a polymeric matrix (host). In contrast to organic cores which are produced by radical polymerization (e.g. acrylate resins), inorganic cores do not interfere with the polymerization process and hence do not jeopardize the mechanical properties of the finalized substrate, as opposed to organic polymeric cores which tend to interfere with the polymerization reaction. silica dioxide, glass powder, ceramics or polymer material

In one embodiment, the inorganic core comprises silica, glass, glass powder, metal, metal oxide, ceramic material or a zeolite. Each possibility represents a separate embodiment of this invention.

In one embodiment, the core of the particles of this invention comprises silica (SiO₂). The silica may be in any form known in the art, non-limiting examples of which include polyhedral oligomeric silsesquioxane (POSS), amorphous silica, dense silica, aerogel silica, porous silica, mesoporous silica and fumed silica.

The surface density of active groups onto particle surface have proportional impact on its anti-viral activity. This is applicable both to organic and inorganic particles in same manner. In another embodiment, the core of the particles of this invention comprises glasses or ceramics of silicate (SiO₄⁻⁴). Non-limiting examples of silicates include aluminosilicate, borosilicate, barium silicate, barium borosilicate and strontium borosilicate.

In another embodiment, the core of the particles of this invention comprises surface activated metals selected from the group of: silver, gold, platinum, palladium, copper, zinc and iron.

In another embodiment, the core of the particles of this invention comprises metal oxides selected from the group of: zirconium dioxide, titanium dioxide, vanadium dioxide, zinc oxide, copper oxide and magnetite.

The inorganic core typically has a solid uniform morphology with low porosity or a porous morphology having pore size diameter of between about 1 to about 30 nm.

In another embodiment, the core of the particles of this invention comprises natural or artificial Zeolites.

In one embodiment, non-limiting examples of ceramic materials include: oxides (e.g. zinc oxide, boron oxide, zirconium oxide), carbides (e.g. silicon carbide, titanium carbide), nitrides (e.g. titanium nitride, boron nitride) and borides (e.g. magnesium diboride)

In one embodiment, the core may be attached to the anti-viral unit directly (i.e. in structures (1)-(3): L₃ is a bond or in structures (I), (IE) and (II)-(VII): L₆ is a bond), or via a linker (L₃ or L₆). Preferably a silica (SiO₂) based inorganic core may be attached to the anti-viral part through a linker (L₃ or L₆), while glasses or ceramics of silicate (SiO₄⁻⁴), metals or metal oxides may be attached to anti-viral unit directly (i.e. in structures (1)-(3): L₃ is a bond or in structures (I), (IE) and (II)-(VII): L₆ is a bond).

In some embodiments, the inorganic core is directly (i.e. in structures (1)-(3): L₃ is a bond or in structures (I), (IE) and (II)-(VII): L₆ is a bond) attached to the anti-viral unit. In other embodiments, the inorganic core is attached to the anti-viral unit through a linker. In some embodiments, the linker is selected from the following groups: a C1 to C18 alkylene; a C1 to C18 alkylene substituted with at least one silane or alkoxysliane moiety; a C1 to C18 alkylene substituted with at least one phosphate moiety; a C1 to C18 alkylene substituted with at least one anhydride moiety; a C1 to C18 alkylene substituted with at least one carboxylate moiety; and a C1 to C18 alkylene substituted with at least one glycidyl moiety. Each possibility represents a separate embodiment of this invention.

The inorganic core of the particle as described above may generally be in a form selected from a sphere, amorphous polygonal, shallow flake-like and a rod. In some representative embodiments, the inorganic core is spherical and has a diameter between about 5 to about 100,000 nm. In some representative embodiments, the inorganic core is spherical and has a diameter between about 1000-100,000 nm. In some representative embodiments, the inorganic core is spherical and has a diameter between about 100-1000 nm with pore diameter of about 1 to about 100 nm. In another embodiment, the inorganic spherical core has a pore diameter of about 1 to about 50 nm. In another embodiment, the inorganic spherical core has a pore diameter of about 1 to about 30 nm. In another embodiment, the inorganic particle is in a form of a rod, having a diameter of between about 5 to about 1,000 nm and length between about 10 to about 1,000,000 nm. In another embodiment, a length of between 50 to 100,000 nm. In another embodiment, a length of between 100 to 250,000 nm. In another embodiment, a length of between 200 to 500,000 and a pore diameter of about 1 to about 50 nm. Each possibility represents a separate embodiment of this invention.

### Processes of Preparing the Anti-Viral Particles

### Preparation of Anti-Viral Particles, Comprising One Monomeric Unit Per One Anti-Viral Active Part

The particles of this invention may be prepared in accordance to a variety of processes, depending on the nature of the core, the anti-viral active group, and the presence or absence of linkers. Some non-limiting examples of preparation methods are provided below.

In one embodiment, this invention provides processes for preparing anti-viral particles, wherein the particles comprise one monomeric unit per one anti-viral active unit. In the following, such processes will be presented in detail.

A representative method for preparing particles according to this invention wherein the anti-viral active group is a tertiary amine or a quaternary ammonium group comprising at least one terpenoid moiety is represented in FIG. 2, for standard particles. In accordance with FIG. 2, a core as defined herein is functionalized with a primary amine. The primary amine reacts with an aldehyde to yield initially an imine (Schiff base) intermediate of formula (A′), which is then reacted with a second aldehyde under reductive amination conditions to yield a tertiary amine of formula (B′). RC(═O)H and R′C(═O)H each represent an aldehyde which is a terpenoid or which is derived from a terpenoid. RC(═O)H and R′C(═O)H may be the same or different from each other. Conversion of the tertiary amine to the quaternary ammonium group is optional, and involves reaction of the tertiary amine with a group R¹—Y wherein R¹ is a C₁-C₄ alkyl and Y is a leaving group such as halogen or sulfonate.

It is understood that the group

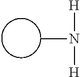

may represents any one or more of the following:
1. An organic core directly bound to NH₂.
2. An organic core bound to NH₂ through a linker as described herein.
3. An inorganic core directly bound to NH₂.
4. An inorganic core bound to NH₂ through a linker as described herein.

The exemplified reaction (FIG. 2) may be a “one pot synthesis”, or it may include two sequential reactions with isolation of an intermediate formed in the first step. The first step is the formation of intermediate (A′), which is an imine (Schiff base), by reacting an amine functionalized core with a terpenoid moiety in the presence of a reducing agent, in this case cinnamyl in the presence of NaBH₄. The imine functionalized core can be isolated at this stage if desired. Alternatively, further reacting intermediate (A′) with a terpenoid moiety in the presence of a reducing agent yields a tertiary amine comprising two terpenoid moieties (B′). In order to obtain the quaternary ammonium, additional alkylation step is performed as described in FIG. 2. Particles with enhanced thermal stability can be prepared in a similar fashion as described above and illustrated in FIG. 2 for standard particles, with a few notable differences: for standard particles R and R′ are terpenoid moieties, where for particles with enhanced thermal stability, R and R′ are each independently methyl, CF₃, perhaloalkyl, aryl, —C(═O)OR, —C(═O)OC(═O)R, —C(═S)OR, —C(═O)SR, —C(═O)—R, —C(═S)—R, 1-alkenyl or 1-alkynyl, where R is alkyl, aryl, cycloalkyl, heterocycle or any combination thereof; R¹ is a methyl, CF₃, perhaloalkyl, aryl, benzyl, 2,2-disubstituted C₃-C₂₀ alkyl, 2,2,2-trisubstituted ethyl, —CH₂C(═O)OR, —CH₂C(═O)OC(═O)R, —CH₂C(═S)OR, —CH₂C(═O)SR, —C(═O)OR, —C(═O)OC(═O)R, —C(═S)OR, —C(═O)SR, —C(═O)—R, —C(═S)—R, —CH₂C(═O)R, —CH₂C(═S)R, —CH₂CF₃, —CH₂NO₂, 1-alkenyl, 1-alkynyl, 2-alkenyl, 2-alkynyl or any combination thereof; where R is alkyl, aryl, cycloalkyl, heterocycle or any combination thereof. In this case of particles with enhanced thermal stability—the final reaction with R¹—Y is mandatory and not optional, in order to arrive at ammonium.

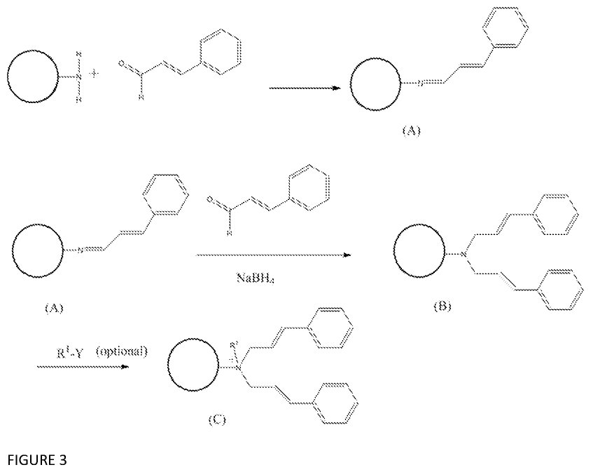

The process for the preparation of standard particles and presented in FIG. 3, uses cinnamaldehyde, but is applicable to other aldehydes. Thus, in some embodiments, this invention provides a particle comprising (i) an inorganic core or an organic polymeric core; and (ii) an imine moiety chemically bound to the core, preferably at a surface density of at least one imine group per 10 sq. nm, wherein the imine group comprises a terpenoid moiety. The imine moiety is generally represented by the structure of formula (B′) in FIG. 2. A more specific embodiment is the structure of formula (B) in FIG. 3. It is understood by a person of skill in the art that other imine intermediate compounds comprising other terpenoids groups as described herein, are also encompassed by this invention.

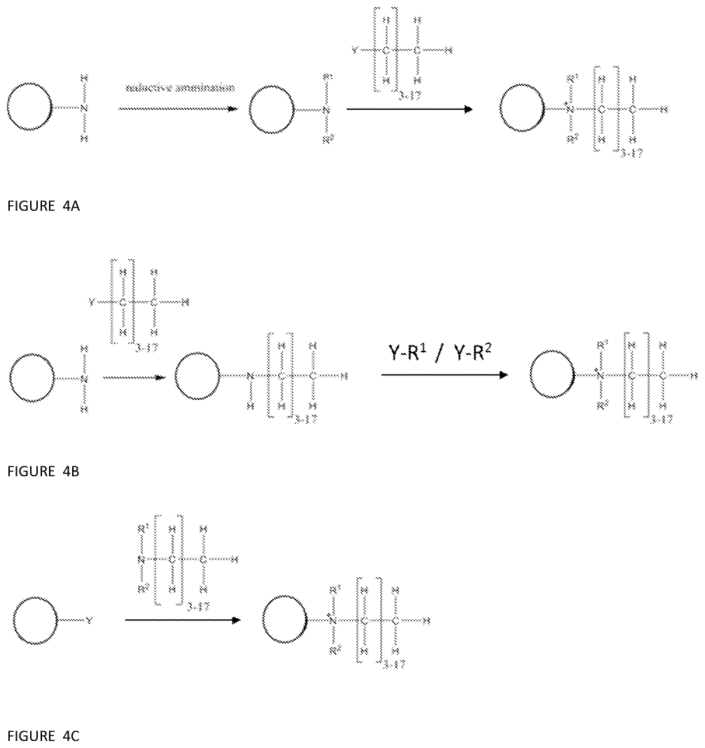

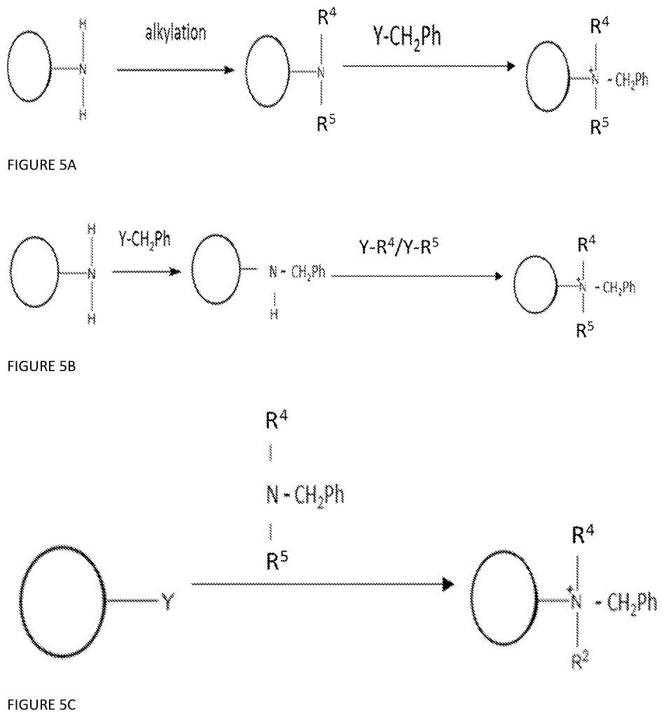

A representative method for preparing standard particles wherein the anti-viral active group is a quaternary ammonium group containing one alkyl group having 4 to 18 carbon atoms is presented in FIGS. 4A-4C. The method includes three pathways to prepare quaternary ammonium salts (QAS) functionalized particle. FIG. 4A) by first utilizing reductive amination to achieve tertiary amine, followed by an alkylation reaction, FIG. 4B) by stepwise alkylation reactions; and FIG. 4C) by reacting a linker functionalized with a leaving group (e.g., Cl or other halogen) with tertiary amine. R¹ and R² represent C₁-C₄ alkyls such as methyl, ethyl, propyl or isopropyl. R¹ and R² may be different or the same group. Y represents any leaving group, for example Cl, Br or I, or a sulfonate (e.g., mesyl, tosyl).

It is understood that that the group

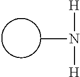

has any one of the meanings as described above for FIGS. 2 and 3.

It is understood that that the group

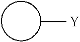

may represents any one or more of the following:
1. An organic core directly bound to Y.
2. An organic core bound to Y through a linker as described herein.
3. An inorganic core directly bound to Y.
4. An inorganic core bound to Y through a linker as described herein.
Similar method of preparing particles with enhanced thermal stability is represented in FIGS. 5A-5C. The method includes three pathways to prepare quaternary ammonium salts (QAS) functionalized particle. FIG. 5A) by reaction with R₁—Y/R₂—Y to achieve tertiary amine, followed by benzylation reaction; FIG. 5B) by a similar pathway as in FIG. 5A), done in the reversed order; and FIG. 5C): by reacting a linker functionalized with a leaving group (e.g., Cl or other halogen) with tertiary amine. R₄ and R₅ are independently methyl, CF₃, perhaloalkyl, aryl, benzyl, 2,2-disubstituted C₃-C₂₀ alkyl, 2,2,2-trisubstituted ethyl, —CH₂C(═O)OR, —CH₂C(═O)OC(═O)R, —CH₂C(═S)OR, —CH₂C(═O)SR, —C(═O)OR, —C(═O)OC(═O)R, —C(═S)OR, —C(═O)SR, —C(═O)—R, —C(═S)—R, —CH₂C(═O)R, —CH₂C(═S)R, —CH₂CF₃, —CH₂NO₂, 1-alkenyl, 1-alkynyl, 2-alkenyl, 2-alkynyl or any combination thereof. Y represents any leaving group, for example Cl, Br or I, or a sulfonate (e.g., mesyl, tosyl).

Core functionalization can occur by a solid support method, or a solution method

### Solid Support as Method of Preparation of Anti-Viral Particles Comprising One Monomeric Unit Per One Anti-Viral Active Part

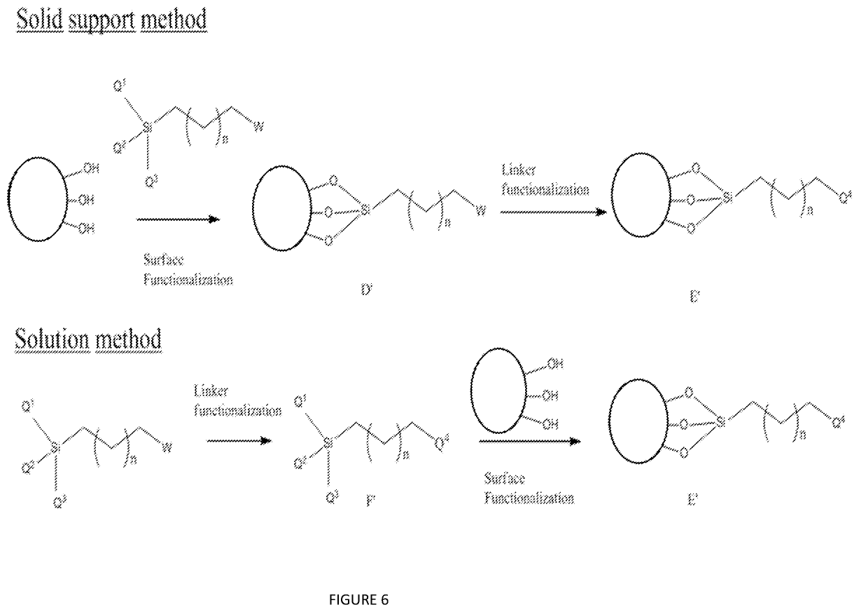

Preparation of functionalized standard particles is conducted in two general steps. First, the linker molecule is allowed to condense onto particles surface (surface functionalization) via hydrolysis of leaving groups to give an intermediate of formula (FIG. 6, D′). Second, functional sites of the linker molecule undergo further functionalization (linker functionalization) as mentioned in any ones of (FIGS. 2-5) to give a functionalized particle of formula E′ of FIG. 6. The circles in FIG. 6 represent an organic or inorganic core; Q¹, Q² and Q³ are independently selected from the group consisting of ethoxy, methoxy, methyl, ethyl, hydrogen, sulfonate and halide, wherein at least one of Q¹, Q² and Q³ is a leaving group selected from ethoxy, methoxy, sulfonate (e.g., mesyl, tosyl) and halide; W is selected from the group consisting of NH₂, halide, sulfonate and hydroxyl; and n is an integer between 1 and 16. For the sake of clarity the scheme presents a case where Q¹, Q² and Q³ represent leaving groups; Q⁴ represents an anti-viral group. Similar process is used for the preparation of functionalized particles with enhanced thermal stability with the difference that W accommodates the same substituents with the exception that the NH₂ moiety is replaced with an arylene-NH₂ or benzylene-NH₂ moiety.

### Solution Method as Method of Preparation of Anti-Viral Particles Comprising One Monomeric Unit Per One Anti-Viral Active Part

In this method, the linker molecule is first functionalized with antimicrobial active group to give an intermediate of formula (FIG. 6, F′). In the second stage intermediate (F′) is allowed to settle onto particle's solid surface (surface functionalization) to give a functionalized particle of formula (FIG. 6, E′).

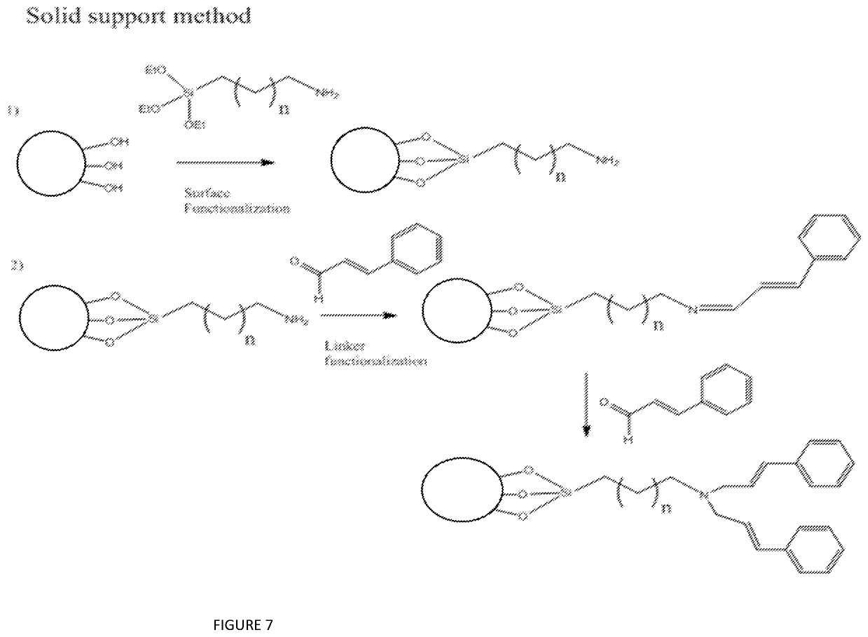

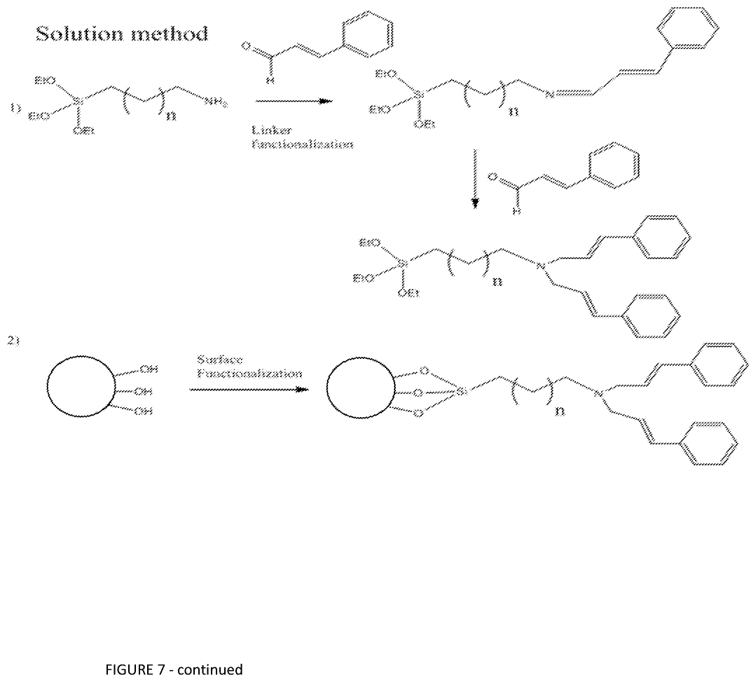

This process is exemplified in FIG. 7 for cinnamaldehyde standard particles, but is applicable to other aldehydes.

Preparation of Anti-Viral Particles, Comprising More than One Monomeric Unit Per One Anti-Viral Active Unit

In one embodiment, this invention provides processes for preparing particles of the composites of this invention, wherein the particles comprise more than one monomeric unit per one anti-viral active unit. In the following, such processes will be presented in detail.

Solid Support as Method of Preparation of Anti-Viral Particles Comprising More than One Monomeric Unit Per One Anti-Viral Active Unit

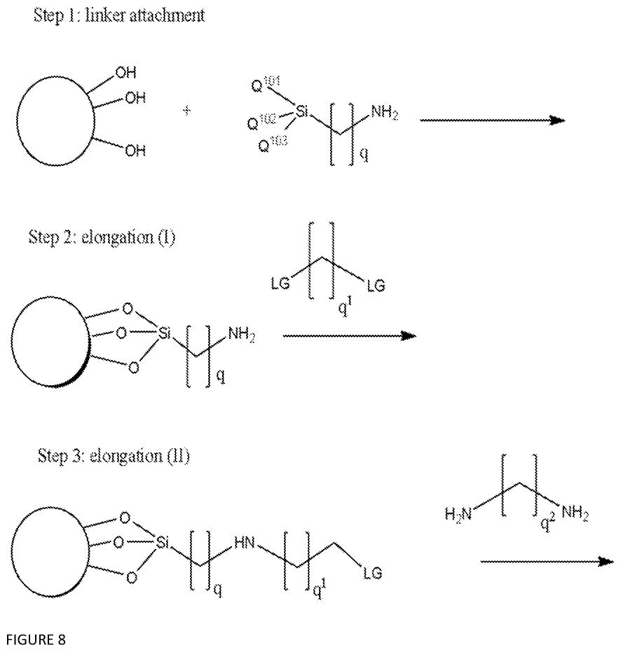

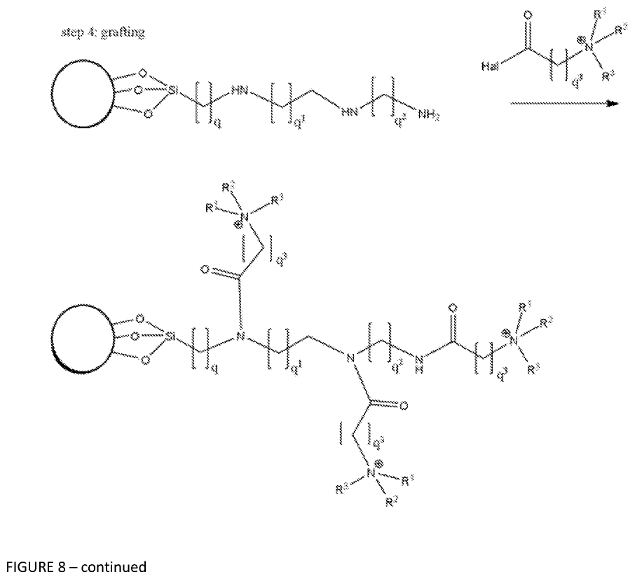

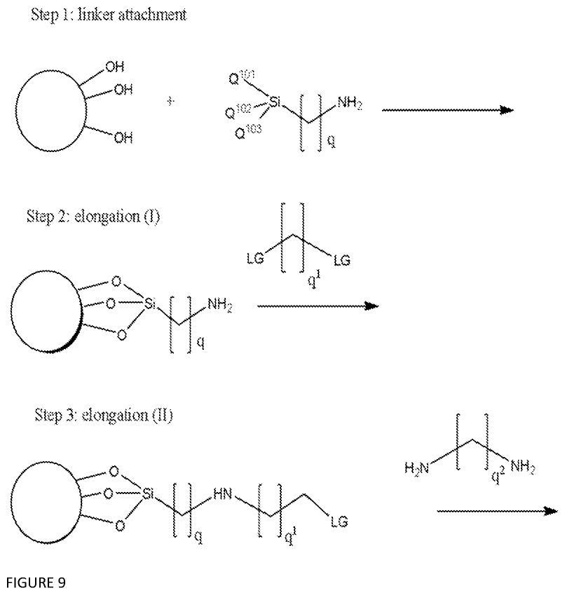

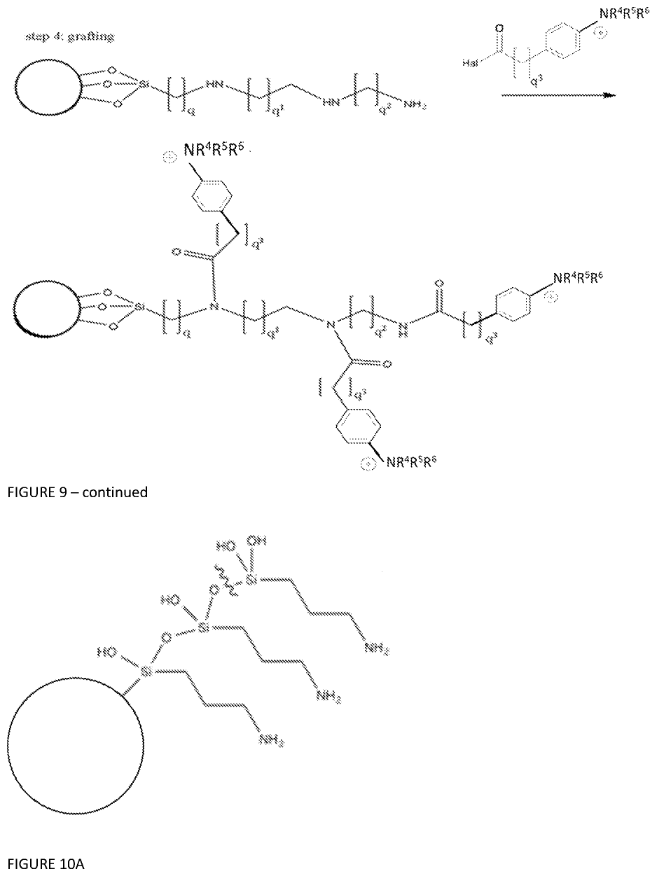

The solid support method comprises a few stages. First, for standard particle, the linker molecule (dilute solutions of a few percent) is allowed to condense onto particles surface (surface functionalization) via (acid catalyzed) hydrolysis of leaving groups, resulting in the attachment of the linker to the core (FIG. 8, step 1). Second, the attached linker is elongated. In another embodiment, this stage is achieved synthetically via one step or more. In another embodiment, elongation is achieved by consecutive addition of difunctionalized alkane and diaminoalkane, wherein amines (of attached linker and diaminoalkane) attack electrophilic centers of the difunctionalized alkane (FIG. 8, steps 2 and 3). In another embodiment, such consecutive addition is optionally repeated for 1-10 times. Finally, the anti-viral active group (usually attached to an alkylene chain) is grafted to resulting attached and elongated linker. In another embodiment, grafting is accomplished when amines on the attached and elongated linker attack acyl halide moiety of the molecule of the anti-viral active group which is grafted (FIG. 8, step 4). Similar process is presented for particles with enhanced thermal stability (FIG. 9), where the ammonium end of the anti microbial active group is replaced with an anilinium end and R¹-R³ are replaced with R⁴-R⁶. In FIG. 8, R¹ and R² are each independently alkyl, terpenoid, cycloalkyl, aryl, heterocycle, a conjugated alkyl, alkenyl or any combination thereof; and R³ is nothing, hydrogen, alkyl, terpenoid moiety, cycloalkyl, aryl, heterocycle, alkenyl, alkynyl or any combination thereof. In FIG. 9, R₄ and R₅ are each independently methyl, CF₃, perhaloalkyl, aryl, benzyl, 2,2-disubstituted C₃-C₂₀ alkyl, 2,2,2-trisubstituted ethyl, —CH₂C(═O)OR, —CH₂C(═O)OC(═O)R, —CH₂C(═S)OR, —CH₂C(═O)SR, —C(═O)OR, —C(═O)OC(═O)R, —C(═S)OR, —C(═O)SR, —C(═O)—R, —C(═S)—R, —CH₂C(═O)R, —CH₂C(═S)R, —CH₂CF₃, —CH₂NO₂, 1-alkenyl, 1-alkynyl, 2-alkenyl, 2-alkynyl or any combination thereof; and R₆ is methyl, CF₃, perhaloalkyl, 2,2-disubstituted C₃-C₂₀ alkyl, 2,2,2-trisubstituted ethyl, —CH₂C(═O)OR, —CH₂C(═O)OC(═O)R, —CH₂C(═S)OR, —CH₂C(═O)SR, —C(═O)OR, —C(═O)OC(═O)R, —C(═S)OR, —C(═O)SR, —C(═O)—R, —C(═S)—R, —CH₂C(═O)R, —CH₂C(═S)R, —CH₂CF₃, —CH₂NO₂, terpenoid moiety, cycloalkyl, aryl, phenyl, benzyl, heterocycle, a conjugated alkyl, 1-alkenyl, 1-alkynyl, 2-alkenyl, 2-alkynyl or any combination thereof

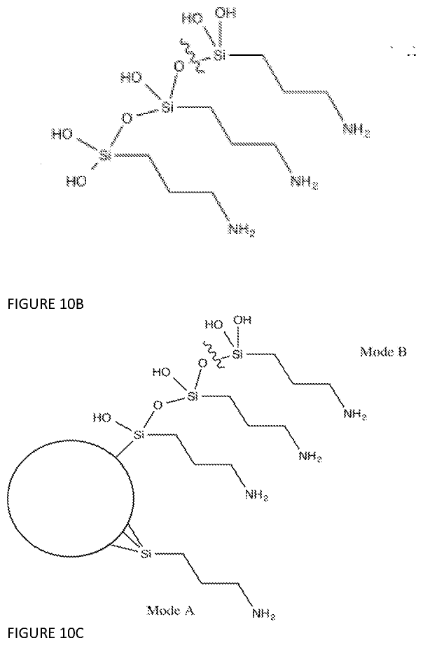

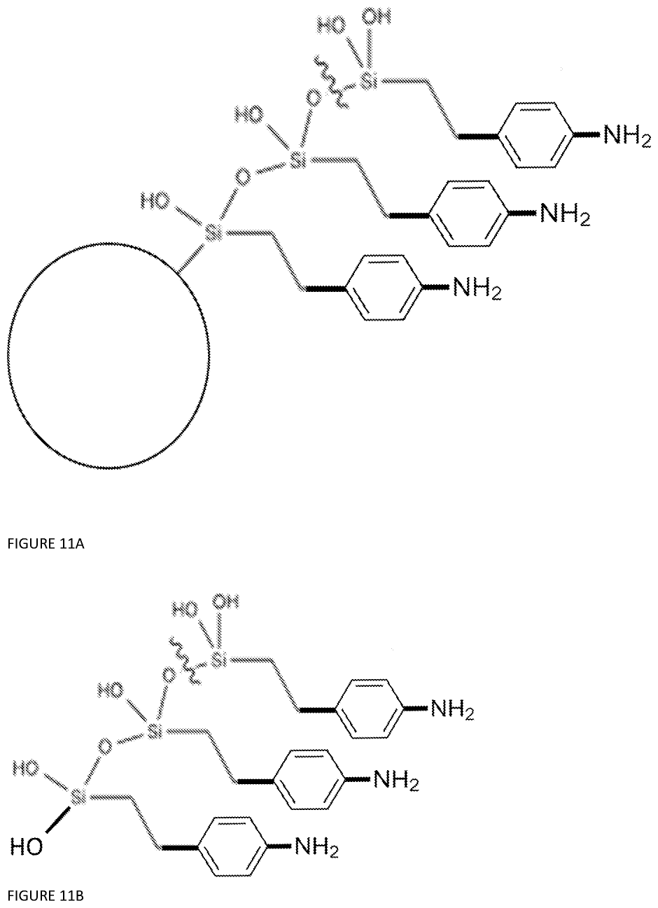

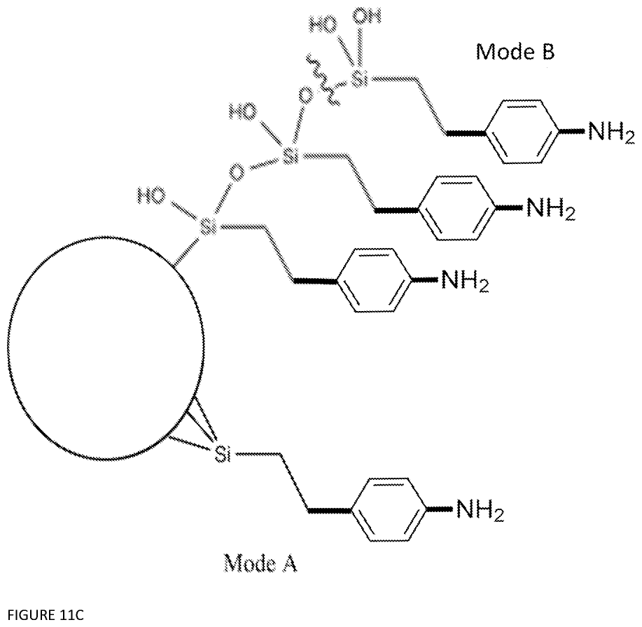

In another embodiment, the same trialkoxysilane linker molecule (of FIGS. 8-9) is used initially, however in a higher concentration (≥10% by wt) and it initially self-polymerizes (FIGS. 10A and 11A for standard and thermally stable enhanced particles, respectively) under basic catalysis. Functionalization of the solid supported linker progresses similarly as in the procedures described hereinabove for particles that comprise one monomeric unit per one anti-viral active unit (FIGS. 2-7).

Solution Method as Method of Preparation of Anti-Viral Particles Comprising More than One Monomeric Unit Per One Anti-Viral Active Unit

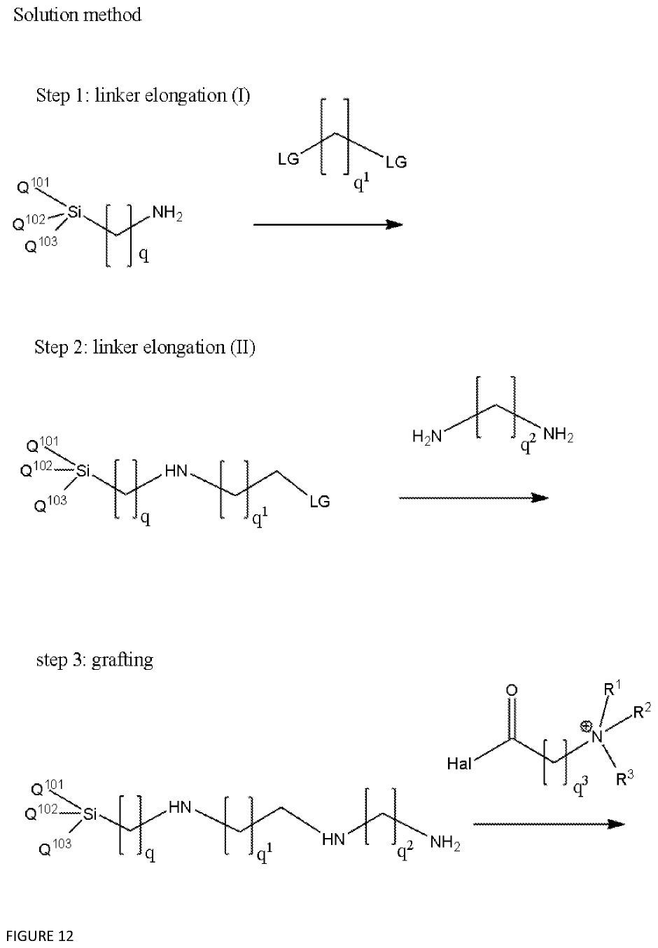

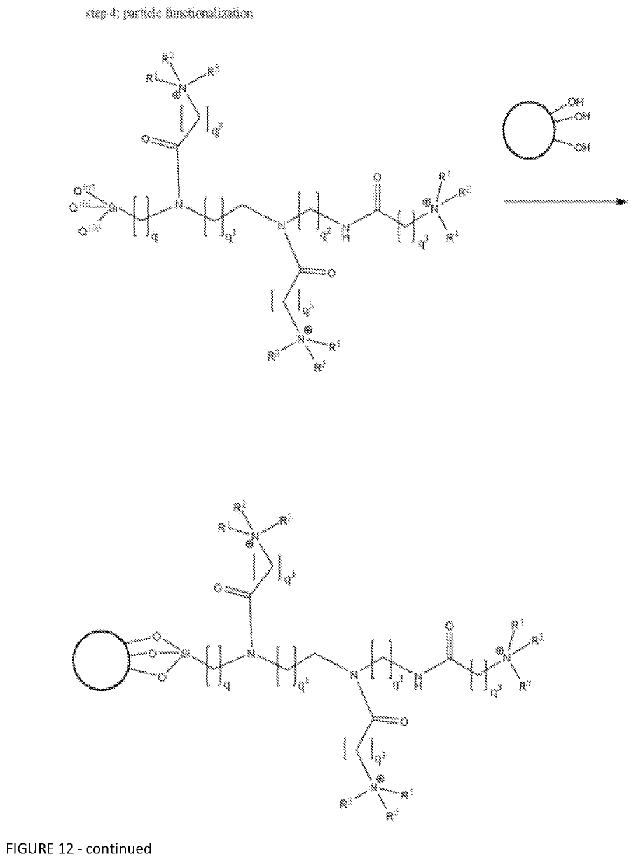

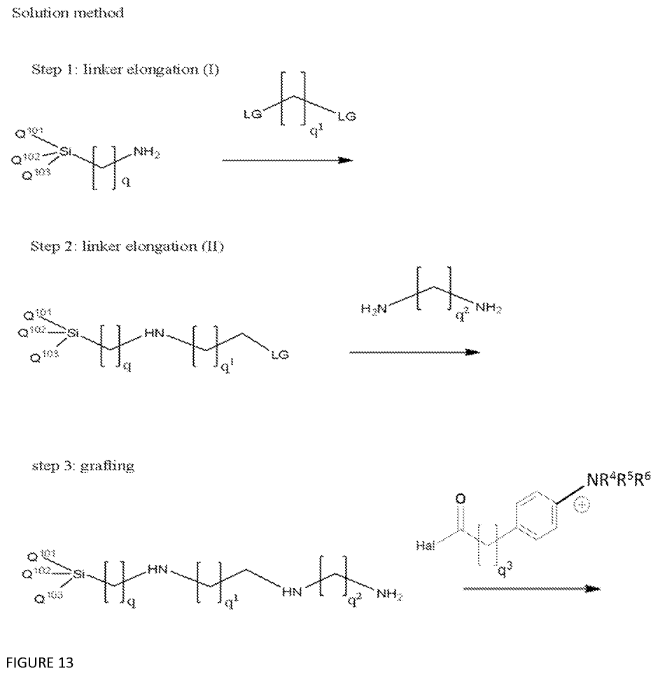

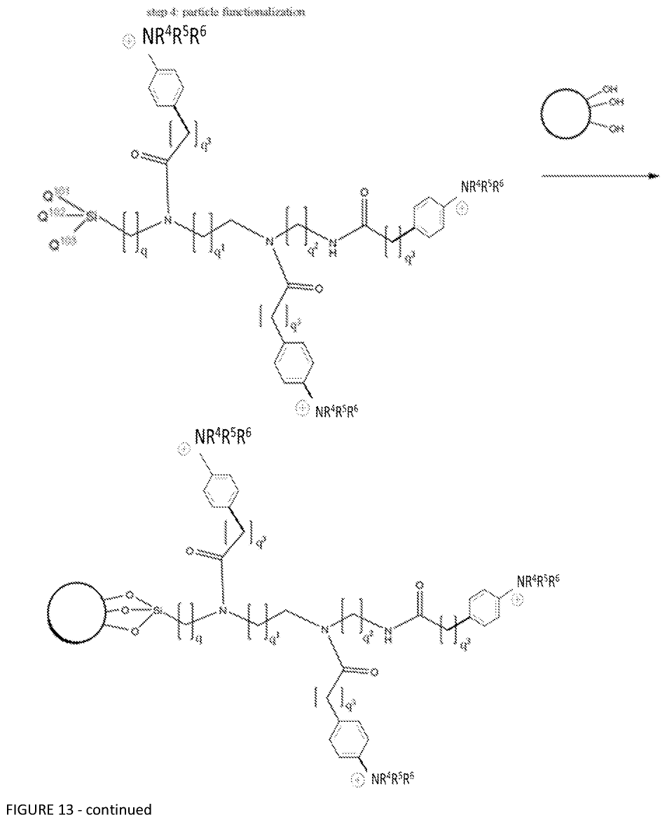

The solution method comprises a few stages. The first step involves elongation of the linker molecule. In another embodiment, this step is achieved synthetically via one step or more. In another embodiment, elongation is achieved by consecutive addition of difunctionalized alkane and diaminoalkane wherein amines (of linker and diaminoalkane) attack electrophilic centers of the difunctionalized alkane (FIGS. 12 and 13 for standard and thermally stable enhanced particles, respectively: steps 1 and 2). In another embodiment, such consecutive addition is optionally repeated for 1-10 times. In the second stage, the anti-viral active group (usually attached to an alkylene chain) is grafted to resulting elongated linker. In another embodiment, grafting is accomplished when amines on the elongated linker attack acyl halide moiety of the molecule of the anti-viral active group which is grafted (FIGS. 12 and 13, step 3). Finally, the elongated, anti-viral active linker is attached to the core via functionalization thereof. In this step, the linker molecule (dilute solutions of a few percent) is allowed to condense onto particles surface (surface functionalization) via (acid catalyzed) hydrolysis of leaving groups, resulting in the attachment of the linker to the core (FIGS. 12 and 13, step 4).

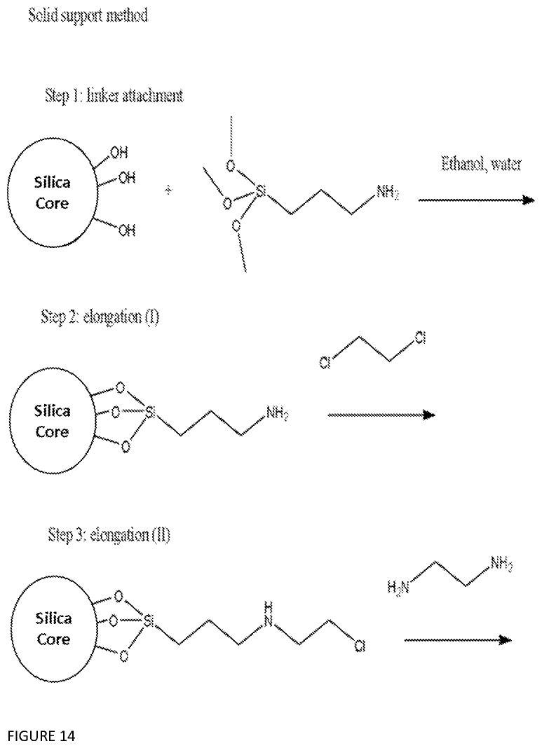

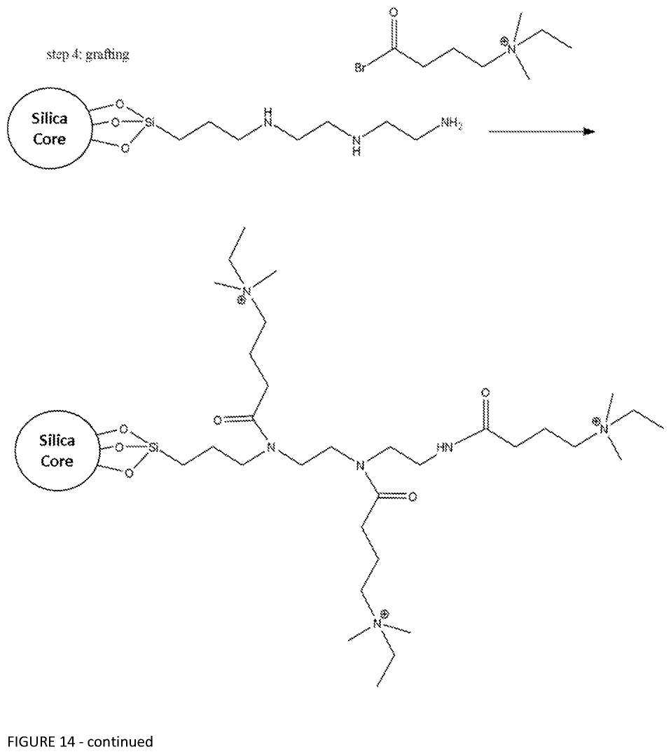

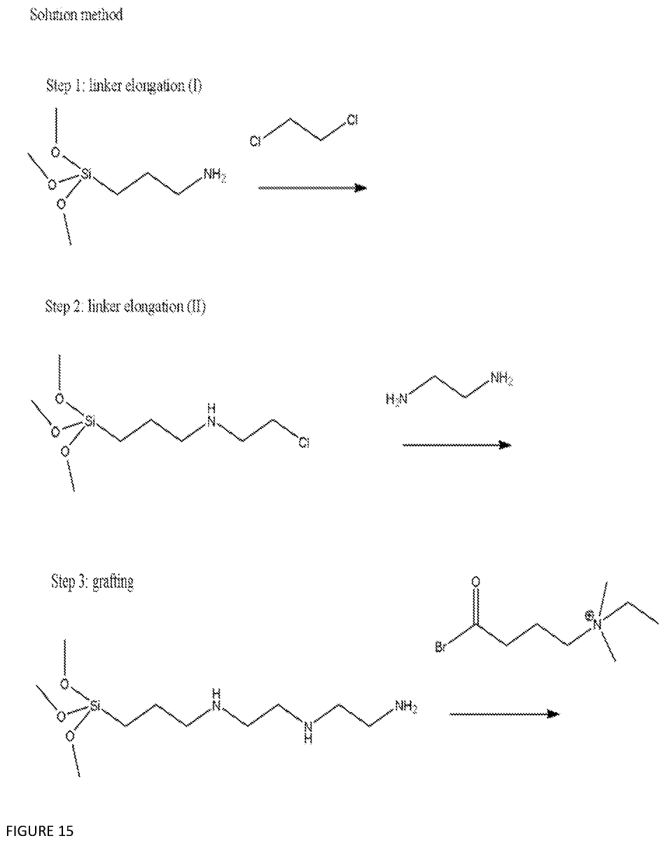

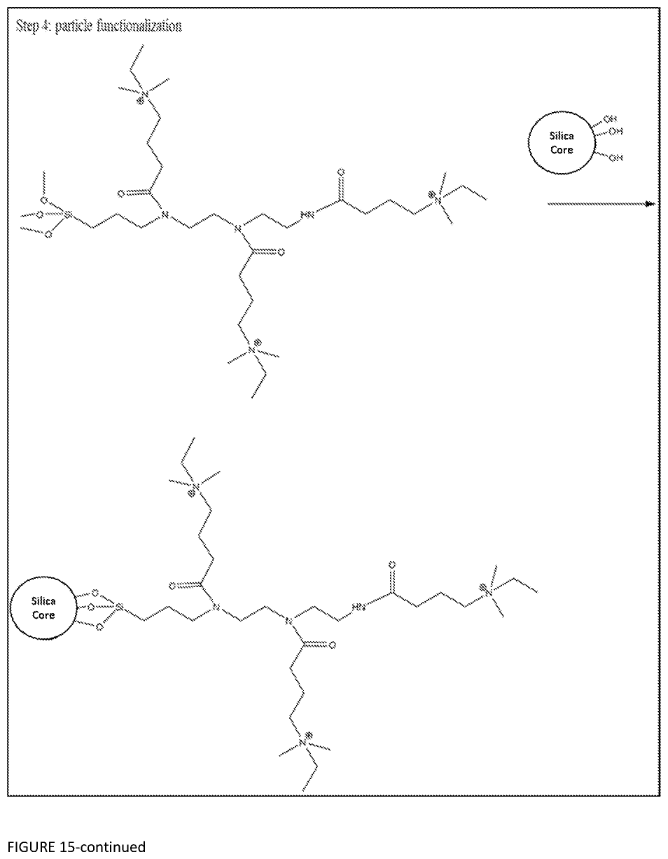

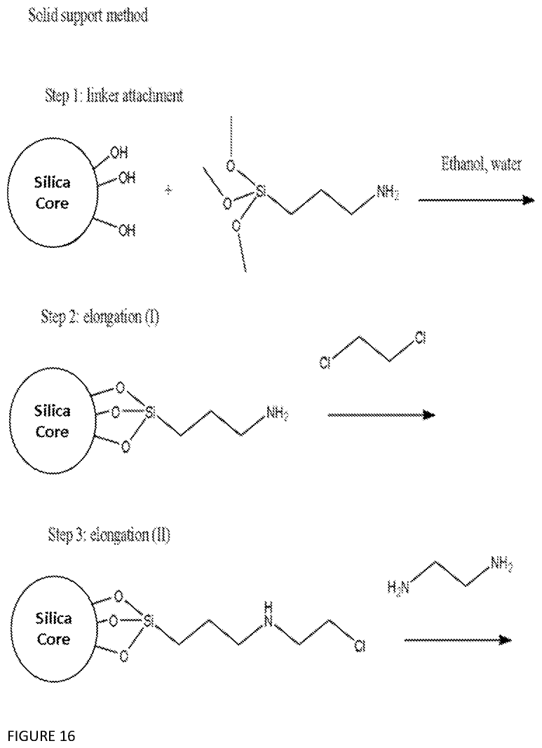

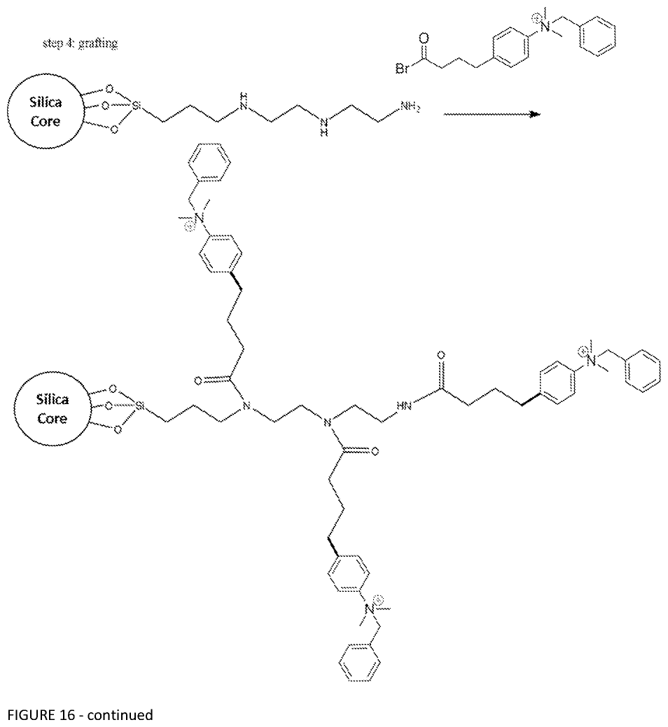

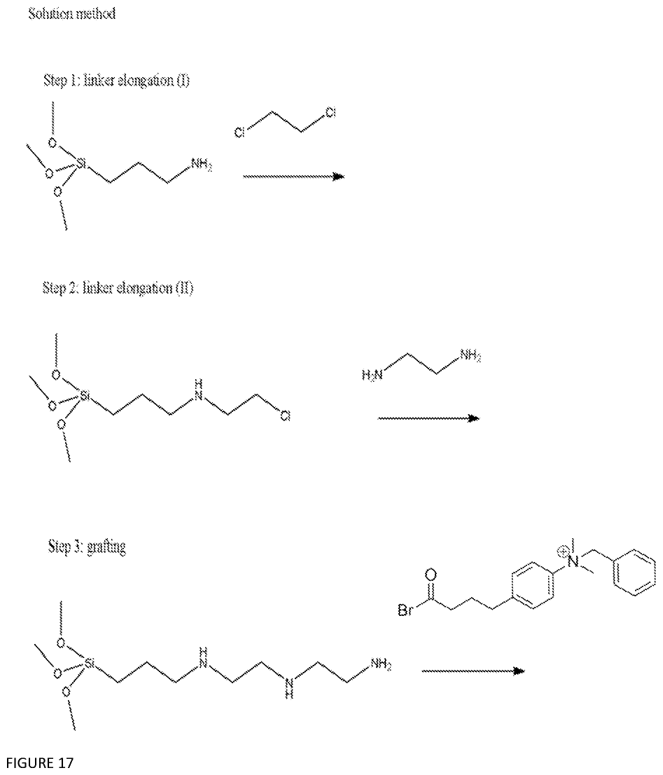

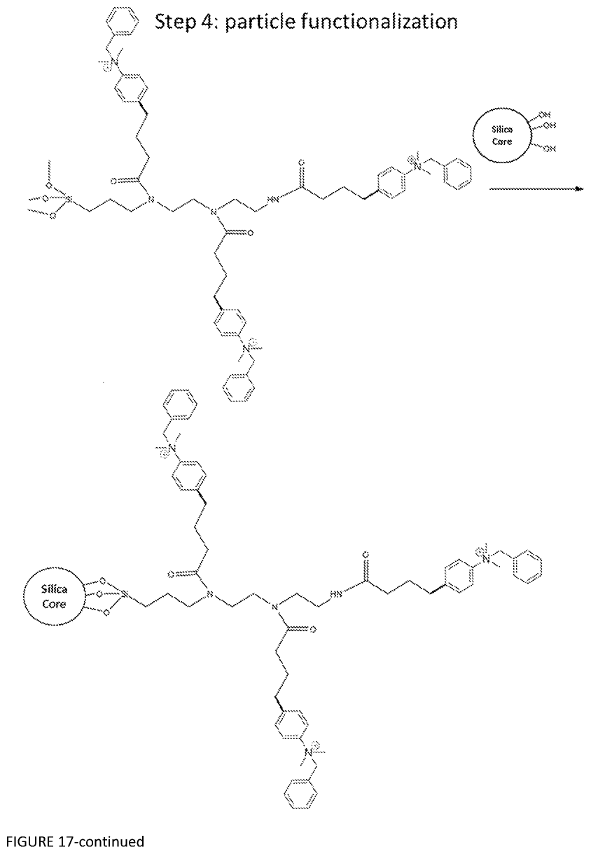

This process is exemplified in FIGS. 14-15 for silica standard particles functionalized with dimethylethylammonium, Similarly, the process is exemplified in FIGS. 16-17—for silica particles with enhanced thermal stability functionalized with dimethybenzylammonium, but is applicable to other hydroxyl-terminated cores and anti-viral active groups. The processes of FIGS. 14-17 are applicable to other hydroxyl-terminated cores and anti-viral active groups.

In another embodiment, the same trialkoxysilane linker molecule is used initially, however in a higher concentration (≥10% by weight) and it initially self-polymerizes (FIGS. 10B and 11B for standard and thermally stable enhanced particles, respectively) under basic catalysis. Functionalization of the linker progresses similarly as in the procedures described hereinabove for particles that comprise one monomeric unit per one anti-viral active part (FIGS. 2-7).

### Preparation of Core Particles

In some embodiments, the particles of the composites of this invention which comprise one or more monomeric units per one anti-viral active part, comprise cores which are prepared according to the following.

Porous silica materials can be prepared by reaction of SiCl₄ with alcohol or water, followed by drying using centrifugation and/or heating utilizing airflow or under vacuum conditions. Dense fumed silica particles (pyrogenic) were prepared by pyrolysis of SiCl₄.

An alternative preparation method of silica core material can be carried by the hydrolysis of tetraethylorthosilicate (TEOS) or tetramethyl orthosilicate (TMS) in the presence of alcohol or water solution and under basic (Stober) or acidic catalytic conditions.

Mesoporous silica particles can be prepared by hydrolysis of TEOS or TMS at low temperatures, preferably in a temperature not exceeding 60° C., followed by dehydration by centrifugation and/or evaporation under airflow or vacuum conditions.

Dense particles can be prepared utilizing intense heating in a process called calcination. Typically, such process takes place at high temperatures at about 250° C.

In some embodiments, the anti-viral coated product or fiber of this invention affect annihilation of at least about 99% of the contacted virus, preferably, at least about 99.99% of the contacted virus.

It was further surprisingly discovered that the particles within compositions/coated substrates/medical devices of this invention maintain high anti-viral properties over time without leaching out and with no alteration of the properties of the hosting matrix. Such particles demonstrate enhanced anti-viral activity originating from the presence of closely packed anti-viral groups on a given particle's surface.

The following examples are presented in order to more fully illustrate the preferred embodiments of this invention. They should in no way, however, be construed as limiting the broad scope of this invention.

While certain features of this invention have been illustrated and described herein, many modifications, substitutions, changes, and equivalents will now occur to those of ordinary skill in the art. It is, therefore, to be understood that the appended claims are intended to cover all such modifications and changes as fall within the true spirit of this invention.

What is claimed is:

1. An anti-viral fiber, fabric, or fabric based product comprising anti-viral particles for use in reducing and preventing viral infection wherein the anti-viral particles are represented by structure (1) or (I): 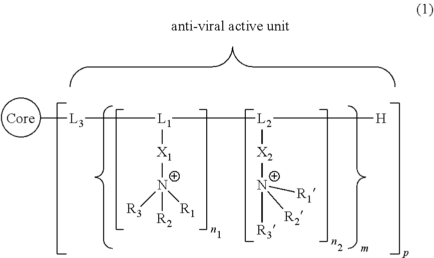
wherein
the core is an organic polymer or an inorganic material;
L₁ is a first linker or a bond;
L₂ is a second linker;
L₃ is a third linker or a bond;
R₁ and R₁′ are each independently alkyl, terpenoid, cycloalkyl, aryl, heterocycle, alkenyl, alkynyl or any combination thereof;
R₂ and R₂′ are each independently alkyl, terpenoid, cycloalkyl, aryl, heterocycle, alkenyl, alkynyl or any combination thereof;
R₃ and R₃′ are each independently nothing, hydrogen, alkyl, terpenoid moiety, cycloalkyl, aryl, heterocycle, a conjugated alkyl, alkenyl, alkynyl or any combination thereof; wherein if R₃ or R₃′ are nothing, the nitrogen is not charged;
X₁ and X₂ is each independently a bond, alkylene, alkenylene, or alkynylene;
p defines the number of anti-viral active units per one sq nm (nm²) of the core surface, wherein said density is of between 0.01-30 anti-viral units per one sq nm (nm²) of the core surface of the particle;
n₁ is each independently an integer between 0 to 200;
n₂ is each independently an integer between 0 to 200;
wherein n₁+n₂≥1; and
m is an integer between 1 to 200 and the repeating unit is the same or different; or 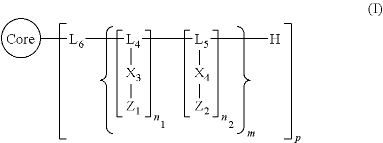
wherein
the core is an organic polymer or an inorganic material;
L₄ is a first linker or a bond;
L₅ is a second linker;
L₆ is a third linker or a bond;
Z₁ is 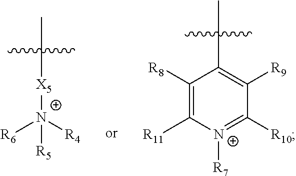
Z₂ is 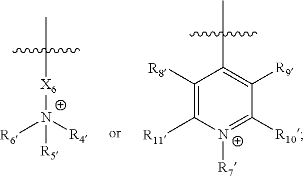
R₄ and R₄′ are each independently methyl, CF₃, perhaloalkyl, aryl, benzyl, 2,2-disubstituted C₃-C₂₀ alkyl, 2,2,2-trisubstituted ethyl, —CH₂C(═O)OR, —CH₂C(═O)OC(═O)R, —CH₂C(═S)OR, —CH₂C(═O)SR, —C(═O)OR, —C(═O)OC(═O)R, —C(═S)OR, —C(═O)SR, —C(═O)—R, —C(═S)—R, —CH₂C(═O)R, —CH₂C(═S)R, —CH₂CF₃, —CH₂NO₂, 1-alkenyl, 1-alkynyl, 2-alkenyl, 2-alkynyl or any combination thereof;
R₅ and R₅′ are each independently methyl, CF₃, perhaloalkyl, aryl, benzyl, 2,2-disubstituted C₃-C₂₀ alkyl, 2,2,2-trisubstituted ethyl, —CH₂C(═O)OR, —CH₂C(═O)OC(═O)R, —CH₂C(═S)OR, —CH₂C(═O)SR, —C(═O)OR, —C(═O)OC(═O)R, —C(═S)OR, —C(═O)SR, —C(═O)—R, —C(═S)—R, —CH₂C(═O)R, —CH₂C(═S)R, —CH₂CF₃, —CH₂NO₂, 1-alkenyl, 1-alkynyl, 2-alkenyl, 2-alkynyl or any combination thereof;
R₆ and R₆′ are each independently absent, methyl, CF₃, perhaloalkyl, 2,2-disubstituted C₃-C₂₀ alkyl, 2,2,2-trisubstituted ethyl, —CH₂C(═)OR, —CH₂C(═O)OC(═O)R, —CH₂C(═S)OR, —CH₂C(═O)SR, —C(═O)OR, —C(═O)OC(═O)R, —C(═S)OR, —C(═O)SR, —C(═O)—R, —C(═S)—R, —CH₂C(═O)R, —CH₂C(═S)R, —CH₂CF₃, —CH₂NO₂, terpenoid moiety, cycloalkyl, aryl, phenyl, benzyl, heterocycle, a conjugated alkyl, 1-alkenyl, 1-alkynyl, 2-alkenyl, 2-alkynyl or any combination thereof;
R₇ and R₇′ are each independently methyl, CF₃, perhaloalkyl, aryl, benzyl, 2,2-disubstituted C₃-C₂₀ alkyl, 2,2,2-trisubstituted ethyl, —CH₂C(═O)OR, —CH₂C(═O)OC(═O)R, —CH₂C(═S)OR, —CH₂C(═O)SR, —C(═O)OR, —C(═O)OC(═O)R, —C(═S)OR, —C(═O)SR, —C(═O)—R, —C(═S)—R, —CH₂C(═O)R, —CH₂C(═S)R, —CH₂CF₃, —CH₂NO₂, 1-alkenyl, 1-alkynyl, 2-alkenyl, 2-alkynyl or any combination thereof;
R₈ and R₈′ are each independently H, alkyl, terpenoid moiety, cycloalkyl, aryl, heterocycle, a conjugated alkyl, alkenyl, alkynyl or any combination thereof;
R₉ and R₉′ are each independently H, alkyl, terpenoid moiety, cycloalkyl, aryl, heterocycle, a conjugated alkyl, alkenyl, alkynyl or any combination thereof;
R₁₀ and R₁₀′ are each independently H, alkyl, terpenoid moiety, cycloalkyl, aryl, heterocycle, a conjugated alkyl, alkenyl, alkynyl or any combination thereof;
R₁₁ and R₁₁′ are each independently H, alkyl, terpenoid moiety, cycloalkyl, aryl, heterocycle, a conjugated alkyl, alkenyl, alkynyl or any combination thereof;
X₃ and X₄ are each independently a bond, alkylene, arylene, alkenylene, alkynylene or any combination thereof;
X₅ and X₆ are each independently a bond, —O—C(═O)—, methylene, —O—C(═O)—CH₂—, 2,2-disubstituted C₂-C₂₀ alkylene, arylene, phenylene, benzylene, cycloalkylene, a heterocycle, a conjugated alkylene, a terpenoid moiety, 1-alkenylene, 1-alkynylene, 2-alkenylene, 2-alkynylene or any combination thereof;
R is alkyl, aryl, cycloalkyl, heterocycle or any combination thereof;
p defines the number of anti-viral active unit per one sq nm (nm²) of the core surface, wherein said density is of between 0.01-30 anti-viral units per one sq nm (nm²) of the core surface of the particle;
n₁ is each independently an integer between 0 to 200;
n₂ is each independently an integer between 0 to 200;
wherein n₁+n₂≥1; and
m is an integer between 1 to 200 and the repeating unit is the same or different.

2. The anti-viral fiber, fabric, or fabric based product according to claim 1, wherein the anti-viral fiber is prepared by extrusion with anti-viral particles.

3. The anti-viral fiber, fabric, or fabric based product according to claim 1, wherein the anti-viral fiber is coated or extruded or co-extruded with the anti-viral particles.

4. The anti-viral fiber, fabric, or fabric based product according to claim 1, wherein the anti-viral fabric is coated by anti-viral particles.

5. The anti-viral fiber, fabric, or fabric based product according to claim 1, wherein the anti-viral fabric based product is coated by anti-viral particles.

6. The anti-viral fiber, fabric, or fabric based product according to claim 1, wherein the fabric based product is a protective face mask with a filter or without a filter.

7. The anti-viral fiber, fabric, or fabric based product according to claim 1, wherein the fabric based product is a protective clothing.

8. The anti-viral fiber, fabric, or fabric based product according to any one of claims 3-5, wherein the coating comprises a matrix and the anti-viral particles.

9. The anti-viral fiber, fabric, or fabric based product according to claim 8, wherein said matrix material is an organic or inorganic polymer.

10. The anti-viral fiber, fabric, or fabric based product according to any one of claims 3-5, 9, wherein said coating has a thickness of between 5 and 1000 nm.

11. The anti-viral fiber, fabric, or fabric based product according to claim 10, wherein the weight percentage of the particles to the whole coating which comprises said matrix and particles is between 1 and 10%.
